(19) United States
(12) Patent Application Publication
(10) Pub. No.: US 2024/0376323 A1
(43) Pub. Date: Nov. 14, 2024

(54) ADHESION LAYER-APPLIED SUBSTRATE, LAMINATE, AND COATING MATERIAL COMPOSITION

(71) Applicant: ASAHI KASEI KABUSHIKI KAISHA, Tokyo (JP)

(72) Inventors: Kazuya ISEDA, Tokyo (JP); Naoya TOCHISHITA, Tokyo (JP); Mifuyu NIWA, Tokyo (JP); Kentaro SHIRAISHI, Tokyo (JP)

(73) Assignee: ASAHI KASEI KABUSHIKI KAISHA, Tokyo (JP)

(21) Appl. No.: 18/690,651

(22) PCT Filed: Sep. 9, 2022
(86) PCT No.: PCT/JP2022/033928

§ 371 Date: Mar. 8, 2024

(30) Foreign Application Priority Data
Sep. 9, 2021 (JP) 2021-146657
Sep. 9, 2021 (JP) 2021-146683

(51) Int. Cl. C09D 5/00; C09D 5/02; C09D 7/40; C09D 7/61; C09D 133/06; C09D 175/04; C09D 183/10

(52) U.S. Cl. CPC C09D 5/002; C09D 5/022; C09D 5/028; C09D 7/61; C09D 7/70; C09D 133/066; C09D 175/04; C09D 183/10

(57) ABSTRACT

An adhesion layer-applied substrate containing
a substrate and
an adhesion layer disposed on the substrate, wherein
the adhesion layer contains a polymer particle (A), an inorganic oxide (B) and a light-shielding agent (D),
the light-shielding agent (D) contains an ultraviolet absorber, and
in elemental analysis by XPS on an adhesion layer surface in the adhesion layer-applied substrate, an M element concentration obtained from a spectrum of a metal (M) derived from the inorganic oxide is 6 atomic % or more.

### TECHNICAL FIELD

The present invention relates to an adhesion layer-applied substrate, a laminate, and a coating material composition.

### BACKGROUND ART

### First Background Art

Aqueous dispersions obtained by polymerization are used as water-based coating materials because films thereof formed by drying at ordinary temperature or under heating tend to exhibit barrier properties, contamination resistance, chemical resistance, flame retardance, heat resistance, weather resistance, scratch resistance, and abrasion resistance. Such water-based coating materials, when used in applications where transparency is demanded, are problematic in terms of optical properties such as transparency and clouding and the occurrence of discoloration, whitening and/or crazing, due to exposure to outdoors and/or ultraviolet light for a long period. Furthermore, when such coating materials are used in top coatings, such top coatings are demanded to have abrasion resistance. Solvent-based coating materials may also be used from the viewpoint of abrasion resistance. Such solvent-based coating materials relatively easily not only allow such coating materials and the resulting coating films to maintain properties, but also contain organic light-shielding agents. However, use of water-based coating materials is desired out of consideration to sanitary conditions in workplaces and global environmental burdens.

As a technique for improving optical properties of water-based coating materials, for example, Patent Literature 1 has described a method involving allowing an ultraviolet absorber to be contained during polymerization, for the purpose of imparting weather resistance. For example, Patent Literature 2 has also described a method involving allowing an ultraviolet absorber to be dissolved and contained in a film formation aid component. As a technique for allowing resin materials to have hard coatability, a method involving adding an inorganic oxide to a resin material has been described (see, for example, Patent Literature 3 and Patent Literature 4).

Resin materials, although are excellent in moldability and lightweight properties, are often inferior in hardness, barrier properties, contamination resistance, chemical resistance, flame retardance, heat resistance, weather resistance, and the like, as compared with inorganic materials such as metals and glass. Resin materials are, in particular, remarkably low in hardness as compared with inorganic glass, the surfaces thereof are easily scratched and thus often used with being covered with hard coatings, such hard coating films have a difficulty in keeping contamination resistance to soot and dust, performances at high temperature and high humidity, and outer appearance when exposed to ultraviolet light for a long period, and resin materials covered with hard coatings are not used in applications where high abrasion resistance, durability and weather resistance are required.

There have been proposed for the purpose of imparting abrasion resistance to resin materials, a method involving using an active energy ray-curing resin composition (see, for example, Patent Literature 5), a method involving adding an inorganic oxide to a resin material (see, for example, Patent Literature 3 and Patent Literature 4), and a method involving adding a polymer particle to a resin material (see, for example, Patent Literature 6 and Patent Literature 7). There has also been proposed for the purpose of imparting weather resistance to resin materials, combination use of an acrylic polymer and cerium oxide (see, for example, Patent Literature 8).

### Second Background Art

Coating materials have been desired to be water-based in recent years out of consideration to sanitary conditions in workplaces and global environmental burdens. Aqueous dispersions obtained by polymerizing predetermined components can form films by drying at ordinary temperature or under heating and are capable of imparting barrier properties, contamination resistance, chemical resistance, flame retardance, heat resistance, weather resistance, scratch resistance, and abrasion resistance to the coating films thus obtained. However, such coating materials, when used in applications where transparency is demanded, are problematic in terms of optical properties such as transparency and clouding and the occurrence of discoloration, whitening and/or crazing, due to exposure to outdoors and/or ultraviolet light for a long period. Although coating materials desirably contain an ultraviolet absorber for suppressing degradation caused by ultraviolet light, most of ultraviolet absorbers are insoluble in water and are therefore difficult to apply to water-based coating materials.

As a technique for improving optical properties of coating films, Patent Literature 9 has described a method involving allowing a silica to be contained in an emulsion particle. Patent Literature 10 has also described a method involving allowing an ultraviolet-absorptive group to be contained in an acrylic copolymer.

### CITATION LIST

### Patent Literature

Patent Literature 1: Japanese Patent Laid-Open No. 11-12505
Patent Literature 2: Japanese Patent Laid-Open No. 7-173404
Patent Literature 3: Japanese Patent Laid-Open No. 2006-63244
Patent Literature 4: Japanese Patent Laid-Open No. 8-238683
Patent Literature 5: Japanese Patent Laid-Open No. 2014-109712
Patent Literature 6: Japanese Patent Laid-Open No. 2017-114949
Patent Literature 7: International Publication No. WO 2020-045632
Patent Literature 8: Japanese Patent Laid-Open No. 5-339400
Patent Literature 9: Japanese Patent Laid-Open No. 2010-100742
Patent Literature 10: Japanese Patent Laid-Open No. 2005-97631

### SUMMARY OF INVENTION

### Technical Problem

### First Problem

While the methods of Patent Literature 1 and Patent Literature 2 are common methods for imparting weather resistance to water-based coating materials, the methods have a difficulty in imparting high weather resistance thereto because the amount of an ultraviolet absorber that can be contained in a coating film is small. In addition, a coating film, if disposed on a substrate, is insufficient in adhesiveness.

While the methods of Patent Literature 3 and Patent Literature 4 are common methods for imparting abrasion resistance to resin materials, solvent-based coating materials are used and are not easily applied to water-based coating materials. In addition, while the method of Patent Literature 3 is a common method for imparting abrasion resistance to resin materials, the method has a difficulty in imparting high abrasion resistance thereto. While the method of Patent Literature 4 is a common method using a soft silicone polymer and a hard inorganic oxide fine particle in a hard coating film, the silicone polymer corresponding to a matrix component does not have any sufficient hardness and thus abrasion resistance is not sufficient.

While the method of Patent Literature 5 is a common method for imparting abrasion resistance to resin materials, the method has a difficulty in imparting high abrasion resistance thereto.

While Patent Literature 6 describes a method using a polymer particle, a silicone polymer and an inorganic oxide fine particle in a hard coating film and describes physical properties of such a coating film, it does not describe any physical properties of each component, does not provide sufficient abrasion resistance, and does not describe any contamination resistance.

While Patent Literature 7 describes a method using a polymer particle, a silicone polymer and an inorganic oxide fine particle in a hard coating film and describes abrasion resistance, it describes only tape adhesiveness as to adhesiveness which is practically insufficient.

While weather resistance is improved at a certain level according to Patent Literature 8, it cannot be said to be at a sufficient level from the viewpoint of the balance between physical properties including abrasion resistance and durability.

As described above, water-based coating materials and hard coating films in conventional arts have still room for improvement from the viewpoints of high abrasion resistance, adhesiveness, durability and weather resistance.

The present invention has been made in view of the above problems, and a first object thereof is to provide an adhesion layer-applied substrate, a coating material composition and a laminate, each of which has high abrasion resistance, adhesiveness, durability and weather resistance.

### Second Problem

While a coating material composition prepared by the method of Patent Literature 9 is capable of forming a coating film excellent in transparency, the coating material composition has a difficulty in allowing a large amount of an ultraviolet absorber to be contained in a coating material and has room for improvement from the viewpoint of weather resistance.

While a coating material composition prepared by the method of Patent Literature 10 contains an ultraviolet absorber and can therefore form a coating film excellent in weather resistance, the coating material composition is supposed to be used as a solvent-based coating material and this technique is difficult to directly apply to water-based coating materials.

The present invention has been made in view of the above problems of the conventional techniques, and a second object thereof is to provide a coating material composition which is excellent in coating material stability and can form a coating film excellent in transparency, adhesiveness and weather resistance, an adhesion layer-applied substrate and a laminate.

### Solution to Problems

The present inventors have made intensive studies, and as a result, have found that the above problems can be solved by a predetermined adhesion layer-applied substrate, coating material composition and laminate, thereby leading to completion of the present invention. That is, the present invention encompasses the following aspects.

[1-1]

An adhesion layer-applied substrate comprising
a substrate and
an adhesion layer disposed on the substrate, wherein
the adhesion layer comprises a polymer particle (A), an inorganic oxide (B) and a light-shielding agent (D),
the light-shielding agent (D) comprises an ultraviolet absorber, and
in elemental analysis by XPS on an adhesion layer surface in the adhesion layer-applied substrate, an M element concentration obtained from a spectrum of a metal (M) derived from the inorganic oxide is 6 atomic % or more.
   [1-2]

The adhesion layer-applied substrate according to [1-1], wherein an arithmetic mean height Sa of the adhesion layer surface is 30 nm or more and 300 nm or less.

[1-3]

The adhesion layer-applied substrate according to [1-1] or [1-2], wherein the inorganic oxide (B) is colloidal silica.

[1-4]

The adhesion layer-applied substrate according to any of [1-1] to [1-3], wherein the M element concentration is 6 atomic % or more and 20 atomic % or less.

[1-5]

The adhesion layer-applied substrate according to any of [1-1] to [1-4], wherein the polymer particle (A) has a unit (a) derived from a vinyl monomer (a), and the unit (a) comprises a unit (a-1) derived from an ultraviolet-absorptive vinyl monomer (a-1).

[1-6]

The adhesion layer-applied substrate according to any of [1-1] to [1-5], wherein the adhesion layer further comprises a block polyisocyanate compound (C).

[1-7]

The adhesion layer-applied substrate according to any of [1-1] to [1-6], wherein the light-shielding agent (D) further comprises a hindered amine-based light stabilizer.

[1-8]

The adhesion layer-applied substrate according to any of [1-1] to [1-7], wherein a mass ratio of the polymer particle (A) and the inorganic oxide (B) (polymer particle (A):inorganic oxide (B)) is in a range of 1:0.5 to 1:2.0.

[1-9]

The adhesion layer-applied substrate according to any of [1-1] to [1-8], wherein the inorganic oxide (B) is a silica having a spherical shape and/or a linked structure.

[1-10]

The adhesion layer-applied substrate according to any of [1-1] to [1-9], wherein the adhesion layer comprises a composite (E) of the polymer particle (A) and the inorganic oxide (B).

[1-11]

The adhesion layer-applied substrate according to any of [1-1] to [1-10], wherein the polymer particle (A) comprises an emulsion particle.

[1-12]

A coating material composition comprising:
a mixture of a polymer particle (A) and an inorganic oxide (B), and/or a composite (E) of a polymer particle (A) and an inorganic oxide (B); and
a light-shielding agent (D), wherein
the inorganic oxide (B) is a silica having a linked structure, and/or a mixture of a silica having a linked structure and a silica having a spherical shape,
an average particle size of the mixture and/or the composite (E) of a polymer particle (A) and an inorganic oxide (B) is 2 nm or more and 2000 nm or less, and
a mass ratio of the polymer particle (A) and the inorganic oxide (B) (polymer particle (A):inorganic oxide (B)) is in a range of 1:0.5 to 1:2.0.
   [1-13]

The coating material composition according to [1-12], wherein the polymer particle (A) comprises an emulsion particle.

[1-14]

The coating material composition according to [1-12] or [1-13], wherein
the polymer particle (A) has a unit (a) derived from a vinyl monomer (a), and
the unit (a) comprises a unit (a-1) derived from an ultraviolet-absorptive vinyl monomer (a-1).
   [1-15]

The coating material composition according to any of [1-12] to [1-14], wherein the inorganic oxide (B) is a silica having a spherical shape and/or a linked structure.

[1-16]

The coating material composition according to any of [1-12] to [1-15], further comprising water.

[1-17]

An adhesion layer-applied substrate comprising
a substrate and
an adhesion layer disposed on the substrate, wherein
the adhesion layer comprises the coating material composition according to any of [1-12] to [1-16].
   [1-18]

A laminate comprising
the adhesion layer-applied substrate according to any of [1-1] to [1-10] and [1-17], and
a hard coating layer (K) disposed on the adhesion layer-applied substrate.
   [1-19]

The laminate according to [1-18], wherein
the hard coating layer (K) comprises a polymer particle (F) and a matrix component (H), and
the matrix component (H) comprises an inorganic oxide (G) and a hydrolyzable silicon compound (h).
   [1-20]

The laminate according to [1-19] wherein the hydrolyzable silicon compound (h) comprises one or more selected from the group consisting of a compound having an atomic group represented by the following formula (h-1) and a hydrolyzed product and a condensate thereof, and a compound represented by the following formula (h-2) and a hydrolyzed product and a condensate thereof:

—R²ₙ₂SiX³₃₋ₙ₂ (h-1)

wherein R² represents a hydrogen atom, an alkyl group, an alkenyl group or an alkynyl group having 1 to 10 carbon atoms, or an aryl group, R² optionally has a substituent having halogen, a hydroxy group, a mercapto group, an amino group, a (meth)acryloyl group or an epoxy group, X³ represents a hydrolyzable group, and n2 represents an integer of 0 to 2;

SiX⁴⁴ (h-2)

wherein X⁴ represents a hydrolyzable group.
[1-21]

The laminate according to [1-19] or [1-20], wherein a Martens hardness HMF of the polymer particle (F) and a Martens hardness HMG of the matrix component (H) satisfy a relationship of HMH/HMF>1.

[1-22]

The laminate according to any of [1-18] to [1-21], wherein a haze value H1 of the adhesion layer-applied substrate is larger than a haze value H2 of the laminate.

[1-23]

The laminate according to any of [1-18] to [1-22], wherein the laminate is an automobile member.

[1-24]

Use of the laminate according to any of [1-18] to [1-22] as an automobile member.

Furthermore, the present invention also encompasses the following aspects.

[2-1]

A coating material composition comprising a mixture of a polymer particle (A) having a unit (a) derived from a vinyl monomer (a) and an inorganic oxide (B), and/or a composite (C) of the polymer particle (A) and an inorganic oxide (B), wherein
a weight average molecular weight of the unit (a) is 10000 to 5000000, and
a pH of the coating material composition is 7 to 11.
   [2-2]

The coating material composition according to [2-1], wherein the unit (a) comprises a unit (a-1) derived from an ultraviolet-absorptive vinyl monomer (a-1).

[2-3]

The coating material composition according to [2-1] or [2-2], wherein
the unit (a) comprises a unit (a-2) derived from a hydroxyl group-containing vinyl monomer (a-2), and
a content of the unit (a-2) in the unit (a) is 10 to 40% by mass.
   [2-4]

The coating material composition according to any of [2-1] to [2-3], further comprising an organic ultraviolet absorber (D).

[2-5]

The coating material composition according to any of [2-1] to [2-4], further comprising a block polyisocyanate compound (E).

[2-6]

The coating material composition according to any of [2-1] to [2-5], wherein a weight average molecular weight of the unit (a) is 100000 to 1000000.

[2-7]

The coating material composition according to any of [2-1] to [2-6], wherein a mass ratio of the inorganic oxide (B) to a total solid content of the coating material composition is 25% to 60%.

[2-8]

The coating material composition according to any of [2-4] to [2-7], wherein a mass ratio of the unit (a-1) and the organic ultraviolet absorber (D) is 1:0.5 to 1:40.

[2-9]

The coating material composition according to any of [2-1] to [2-8], wherein the inorganic oxide (B) is a silica having a spherical shape and/or a linked structure.

[2-10]

The coating material composition according to any of [2-1] to [2-9], further comprising a chain transfer agent.

[2-11]

The coating material composition according to any of [2-1] to [2-10], wherein the polymer particle (A) comprises an emulsion particle having the unit (a).

[2-12]

An adhesion layer-applied substrate comprising
a substrate and
an adhesion layer disposed on the substrate, wherein
the adhesion layer comprises the coating material composition according to any of [2-1] to [2-11].
   [2-13]

A laminate comprising
the adhesion layer-applied substrate according to [2-12], and
a hard coating layer disposed on the adhesion layer-applied substrate, wherein
the hard coating layer comprises a matrix component (H) containing an inorganic oxide (F) and a polymer nanoparticle (G), and
a Martens hardness HMG of the polymer nanoparticle (G) and a Martens hardness HMH of the matrix component (H) satisfy a relationship of HMH/HMG>1.
   [2-14]

The laminate according to [2-13], wherein a haze value H1 of the adhesion layer-applied substrate is larger than a haze value H2 of the laminate.

### Advantageous Effects of Invention

### First Effect

The present invention can provide an adhesion layer-applied substrate, a coating material composition and a laminate, each of which has high abrasion resistance, adhesiveness, durability and weather resistance.

### Second Effect

The coating material composition of the present invention is excellent in coating material stability and can form a film excellent in transparency, adhesiveness and weather resistance.

### DESCRIPTION OF EMBODIMENTS

Hereinafter, an embodiment (hereinafter, simply referred to as “the present embodiment”.) for carrying out the present invention will be described in detail. The present invention is not here limited to the following present embodiment, and can be variously modified and carried out within the gist thereof. Herein, the “(meth)acryl” means “acryl” or “methacryl” corresponding thereto. Herein, “to” in a numerical range means that the numerical values on both sides are included as the upper limit value and lower limit value unless otherwise specified.

### First Embodiment

Herein, a first aspect (herein, also referred to as “first embodiment”.) according to the present embodiment is described in detail.

### <Adhesion Layer-Applied Substrate>

An adhesion layer-applied substrate of the present embodiment is an adhesion layer-applied substrate including a substrate and an adhesion layer disposed on the substrate, wherein
the adhesion layer includes a polymer particle (A), an inorganic oxide (B), and a light-shielding agent (D),
the light-shielding agent (D) includes an ultraviolet absorber, and
in elemental analysis by XPS on an adhesion layer surface in the adhesion layer-applied substrate, an M element concentration obtained from a spectrum of a metal (M) derived from the inorganic oxide is 6 atomic % or more.

The adhesion layer-applied substrate of the present embodiment is configured as described above, and is thus capable of forming a laminate having high abrasion resistance, adhesiveness, durability and weather resistance.

In the present embodiment, the arithmetic mean height Sa of the adhesion layer surface in the adhesion layer-applied substrate is preferably 30 nm or more, more preferably 40 nm or more, further preferably 50 nm or more from the viewpoints of initial adhesiveness and adhesiveness after a durability test. The arithmetic mean height Sa of the adhesion layer surface in the adhesion layer-applied substrate is preferably 300 nm or less, more preferably 250 nm or less, further preferably 200 nm or less from the viewpoints of transparency and abrasion resistance.

The method for controlling the arithmetic mean height Sa of the adhesion layer surface in the adhesion layer-applied substrate in the above range is not particularly limited, and examples thereof include a method involving adjusting the ratio of the polymer particle (A) and the inorganic oxide (B). By using an inorganic oxide (B) having a linked structure such as a beaded or chained shape, the arithmetic mean height Sa of the adhesion layer surface can be controlled to 30 nm or more even if the amount of the inorganic oxide (B) in the adhesion layer is small. By using an inorganic oxide (B) having no linked structure and having a spherical structure, the arithmetic mean height Sa of the adhesion layer surface can be controlled to 300 nm or less even if the amount of the inorganic oxide (B) in the adhesion layer is large.

In the present embodiment, the arithmetic mean height Sa of the adhesion layer surface in the adhesion layer-applied substrate can be measured by a method described in Examples below.

In the present embodiment, in elemental analysis by XPS on an adhesion layer surface in the adhesion layer-applied substrate, the M element concentration obtained from a spectrum of a metal (M) derived from the inorganic oxide is 6 atomic % or more, preferably 8 atomic % or more, more preferably 9 atomic % or more, further preferably 10 atomic % or more from the viewpoints of initial adhesiveness and adhesiveness after a durability test. In elemental analysis by XPS on an adhesion layer surface in the adhesion layer-applied substrate, the M element concentration obtained from a spectrum of a metal (M) derived from the inorganic oxide is preferably 20 atomic % or less, more preferably 19 atomic % or less, further preferably 18 atomic % or less from the viewpoints of film formability and optical properties.

The method for controlling the M element concentration of the adhesion layer surface in the adhesion layer-applied substrate in the above range is not particularly limited, and examples thereof include a method involving adjusting the ratio of the polymer particle (A) and the inorganic oxide (B). By using a polymer particle (A) having a functional group capable of interacting with the inorganic oxide (B), the polymer particle (A) can be prevented from being unevenly distributed in the adhesion layer surface, and the M element concentration can be controlled in the desired range, even if the ratio of the polymer particle (A) to the inorganic oxide (B) is relatively high.

In the present embodiment, specifically, the M element concentration of the adhesion layer surface in the adhesion layer-applied substrate can be measured by a method described in Examples below.

The adhesion layer-applied substrate of the present embodiment includes an ultraviolet absorber as the light-shielding agent (D). The adhesion layer-applied substrate thus configured is excellent in weather resistance.

The adhesion layer-applied substrate of the present embodiment is configured as described above, and is thus capable of forming a laminate having high abrasion resistance, initial adhesiveness, adhesiveness after a durability test, weather resistance and optical properties. Such a laminate exhibits abrasion resistance, adhesiveness and optical properties at high levels, thus is useful as, but not limited to the following, a hard coating for, for example, a building material, an automobile member, electronic equipment, and an electronic product, and is particularly preferably used in an automobile member.

As described above, the adhesion layer-applied substrate according to the present embodiment includes a substrate and an adhesion layer disposed on the substrate. The adhesion layer in the present embodiment is disposed on at least one surface and/or both surfaces of the substrate.

### [Substrate]

The substrate is not particularly limited, and examples thereof include a resin, a metal, and glass. Examples of the shape of the substrate include, but not limited to the following, a plate-like shape, a shape including irregularities, a shape having a curved surface, a hollow shape, a porous shape, and any combination thereof. The type of the substrate is not particularly limited, and examples thereof include a sheet, a film, and a fiber. In particular, a resin is preferable from the viewpoints of impartment of hard coatability, and moldability. Examples of the resin for use in the substrate include, but not limited to the following, a thermoplastic resin and a thermosetting resin. Examples of the thermoplastic resin for use in the substrate include, but not limited to the following, polyethylene, polypropylene, polystyrene, an ABS resin, a vinyl chloride resin, a methyl methacrylate resin, nylon, a fluororesin, polycarbonate, and a polyester resin. Examples of the thermosetting resin for use in the substrate include, but not limited to the following, a phenol resin, a urea resin, a melamine resin, an unsaturated polyester resin, an epoxy resin, a silicon resin, silicone rubber, SB rubber, natural rubber, and a thermosetting elastomer.

### [Adhesion Layer]

The adhesion layer includes a polymer particle (A), an inorganic oxide (B), and a light-shielding agent (D).

The content of the polymer particle (A) in the adhesion layer is preferably 10 to 50% by mass, more preferably 15 to 45% by mass, further preferably 20 to 40% by mass based on 100% by mass of the adhesion layer. The content of the polymer particle (A) is preferably 10 to 70% by mass, more preferably 20 to 60% by mass, further preferably 30 to 50% by mass based on 100% by mass in total of the polymer particle (A), the inorganic oxide (B), and the light-shielding agent (D).

The content of the inorganic oxide (B) in the adhesion layer is preferably 20 to 60% by mass, more preferably 25 to 55% by mass, further preferably 30 to 50% by mass based on 100% by mass of the adhesion layer. The content of the inorganic oxide (B) is preferably 20 to 80% by mass, more preferably 30 to 70% by mass, further preferably 40 to 60% by mass based on 100% by mass in total of the polymer particle (A), the inorganic oxide (B), and the light-shielding agent (D).

The content of the light-shielding agent (D) in the adhesion layer is preferably 1 to 35% by mass, more preferably 3 to 20% by mass, further preferably 5 to 20% by mass based on 100% by mass of the adhesion layer. The content of the light-shielding agent (D) is preferably 1 to 35% by mass, more preferably 3 to 30% by mass, further preferably 5 to 25% by mass based on 100% by mass in total of the polymer particle (A), the inorganic oxide (B), and the light-shielding agent (D).

When the adhesion layer in the present embodiment includes a composite (E) described below and the polymer particle (A) which is a separate component therefrom, the above content is calculated as the total amount of a polymer particle included in the composite (C) and the polymer particle (A) which is a separate component therefrom. Likewise, when the adhesion layer includes a composite (E) described below and the inorganic oxide (B) which is a separate component therefrom, the above content is calculated as the total amount of an inorganic oxide included in the composite (C) and the inorganic oxide (B) which is a separate component therefrom.

### [Polymer Particle (A)]

The polymer particle (A) serves to impart flexibility and enhance adhesiveness to the substrate, and is not particularly limited as long as it is a particulate polymer. The polymer particle (A) preferably includes an emulsion particle, and more preferably includes an adhesive emulsion particle (A1). The adhesive emulsion particle (A1) is not particularly limited, and is a particle formed from one or more of polyurethane-based, polyester-based, poly(meth)acrylate-based, polyvinyl acetate-based, polybutadiene-based, polyvinyl chloride-based, chlorinated polypropylene-based, polyethylene-based, polystyrene-based, and polystyrene-(meth)acrylate-based copolymers, a rosin-based derivative, an alcohol adduct of a styrene-maleic anhydride copolymer, a polycarbonyl compound such as a cellulose-based resin, and a silicone compound. In the present embodiment, the polymer particle (A) is preferably a poly(meth)acrylate-based particle.

The method for preparing the polymer particle (A) is not particularly limited, and various preparation methods, for example, emulsion polymerization or solution polymerization, can be selected. Such a particle is preferably prepared by emulsion polymerization of a vinyl monomer (a) in the presence of water and an emulsifier. That is, the polymer particle (A) is preferably a polymer particle (emulsion particle) obtained by a preparation method involving polymerizing a vinyl monomer (a) in the presence of water and an emulsifier. In other words, the polymer particle (A) is preferably a polymer particle (emulsion particle) derived from an emulsifier and a vinyl monomer (a). Such a polymer particle (A), when included in the adhesion layer, tends to better maintain adhesiveness to the substrate. Since the polymer particle (A) obtained as described above typically entrains water, a coating material composition for use in formation of the adhesion layer in the present embodiment is preferably a water-based coating material composition. Herein, “water-based” means that the most abundant component among components included in a solvent described below is water.

A polymerization initiator can be used in the preparation of the polymer particle (A). The polymerization initiator is not particularly limited, and examples thereof include organic polymerization initiators including hydrogen peroxide, hydroperoxides such as cumene hydroperoxide, diisopropylbenzene hydroperoxide, and p-menthane hydroperoxide, peroxides such as benzoyl peroxide and lauroyl peroxide, and azo compounds such as 2,2′-azobis{2-methyl-N-[2-(1-hydroxybutyl)propionamide]}, 2,2′-azobis[(2-methylpropionamidine) dihydrochloride], 2,2′-azobis[N-(2-carboxyethyl)-2-methyl-propionediamine] tetrahydrate, 2,2′-azobis(2,4-dimethylvaleronitrile), and azobisisobutyronitrile, and inorganic polymerization initiators including persulfates such as potassium persulfate, sodium persulfate, and ammonium persulfates. Alternatively, a so-called redox polymerization initiator may be used which employs a reducing agent such as sodium bisulfite, ascorbic acid or a salt thereof in combination with the polymerization initiator.

The vinyl monomer (a) is not particularly limited, and examples thereof can include not only a (meth)acrylic acid ester, an aromatic vinyl compound, and a vinyl cyanide compound, but also functional group-containing monomers such as an ultraviolet-absorptive vinyl monomer (a-1), a carboxyl group-containing vinyl monomer, a hydroxyl group-containing vinyl monomer (a-2), an epoxy group-containing vinyl monomer, a carbonyl group-containing vinyl monomer, and a vinyl monomer having secondary and/or tertiary amide group(s).

The (meth)acrylic acid ester is not particularly limited, and examples thereof include a (meth)acrylic acid alkyl ester having an alkyl moiety having 1 to 50 carbon atoms, and a (poly)oxyethylene di(meth)acrylate having 1 to 100 ethylene oxide groups.

The (meth)acrylic acid alkyl ester is not particularly limited, and examples thereof include methyl (meth)acrylate, ethyl (meth)acrylate, n-butyl (meth)acrylate, 2-ethylhexyl (meth)acrylate, methylcyclohexyl (meth)acrylate, cyclohexyl (meth)acrylate, lauryl (meth)acrylate, and dodecyl (meth)acrylate.

The (poly)oxyethylene di(meth)acrylate is not particularly limited, and examples thereof include ethylene glycol di(meth)acrylate, diethylene glycol di(meth)acrylate, diethylene glycol methoxy(meth)acrylate, and tetraethylene glycol di(meth)acrylate.

Examples of the aromatic vinyl compound is not particularly limited, and examples thereof include styrene and 4-vinyltoluene.

The vinyl cyanide compound is not particularly limited, and examples thereof include acrylonitrile and methacrylonitrile.

The polymer particle (A) has a unit (a) derived from a vinyl monomer (a), and the unit (a) preferably includes a unit (a-1) derived from an ultraviolet-absorptive vinyl monomer (a-1). The ultraviolet-absorptive vinyl monomer (a-1) means a vinyl monomer having an ultraviolet-absorptive group, and the ultraviolet-absorptive group means a functional group having absorption in an ultraviolet region (wavelength: 400 nm or less). That is, a specific example of the ultraviolet-absorptive vinyl monomer (a-1) is a (meth)acrylic monomer having an ultraviolet-absorptive group in its molecule, and examples thereof include, but not limited to the following, benzophenone-based compounds such as 2-hydroxy-4-acryloxybenzophenone, 2-hydroxy-4-methacryloxybenzophenone, 2-hydroxy-5-acryloxybenzophenone, 2-hydroxy-5-methacryloxybenzophenone, 2-hydroxy-4-(acryloxy-ethoxy)benzophenone, 2-hydroxy-4-(methacryloxy-ethoxy)benzophenone, 2-hydroxy-4-(methacryloxy-diethoxy)benzophenone, and 2-hydroxy-4-(acryloxy-triethoxy)benzophenone, and benzotriazole-based compounds such as 2-(2′-hydroxy-5′-methacryloxyethylphenyl)-2H-benzotriazole (trade name “RUVA-93” manufactured by Otsuka Chemical Co., Ltd.), 2-(2′-hydroxy-5′-methacryloxyethyl-3-tert-butylphenyl)-2H-benzotriazole, 2-(2′-hydroxy-5′-methacryloxypropyl-3-tert-butylphenyl)-5-chloro-2H-benzotriazole, and 3-methacryloyl-2-hydroxypropyl-3-[3′-(2″-benzotriazolyl)-4-hydroxy-5-tert-butyl]phenylpropionate (trade name “CGL-104” manufactured by Ciba-Geigy Japan Ltd.).

The carboxyl group-containing vinyl monomer is not particularly limited, and examples thereof include (meth)acrylic acid, crotonic acid, itaconic acid, maleic acid, fumaric acid, maleic anhydride, or a half ester of a dibasic acid such as itaconic acid, maleic acid, or fumaric acid. In the case of use of a carboxyl group-containing vinyl monomer, a carboxyl group can be introduced into the adhesive emulsion particle (A1), and electrostatic repulsion force between such particles tends to enhance stability of an emulsion, for example, enhance a resistive force to dispersion destruction action from the outside, for example, aggregation in stirring. The carboxyl group introduced can also be partially or fully neutralized with ammonia, an amine compound such as triethylamine or dimethylethanolamine, or a base such as NaOH or KOH from the viewpoint of a further enhancement in electrostatic repulsion force.

The hydroxyl group-containing vinyl monomer (a-2) is not particularly limited, and examples thereof include (meth)acrylic acid hydroxyalkyl esters such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate and 4-hydroxybutyl (meth)acrylate; hydroxyalkyl esters of fumaric acid, such as di-2-hydroxyethyl fumarate and mono-2-hydroxyethyl monobutyl fumarate; allyl alcohol and (poly)oxyethylene mono(meth)acrylate having 1 to 100 ethylene oxide groups; (poly)oxypropylene mono(meth)acrylate having 1 to 100 propylene oxide groups; and “Placcel FM, FA monomer” (trade name of a caprolactone-added monomer manufactured by Daicel Corporation) and other α,β-ethylenically unsaturated carboxylic acid hydroxyalkyl esters.

The (poly)oxyethylene (meth)acrylate is not particularly limited, and examples thereof include ethylene glycol (meth)acrylate, ethylene glycol methoxy(meth)acrylate, diethylene glycol (meth)acrylate, diethylene glycol methoxy(meth)acrylate, tetraethylene glycol (meth)acrylate, and tetraethylene glycol methoxy(meth)acrylate.

The (poly)oxypropylene (meth)acrylate is not particularly limited, and examples thereof include propylene glycol (meth)acrylate, propylene glycol methoxy(meth)acrylate, dipropylene glycol (meth)acrylate, dipropylene glycol methoxy(meth)acrylate, tetrapropylene glycol (meth)acrylate, and tetrapropylene glycol methoxy(meth)acrylate.

The epoxy group-containing vinyl monomer is not particularly limited, and examples thereof include a glycidyl group-containing vinyl monomer. The glycidyl group-containing vinyl monomer is not particularly limited, and examples thereof include glycidyl (meth)acrylate, allyl glycidyl ether, and allyl dimethyl glycidyl ether.

The carbonyl group-containing vinyl monomer is not particularly limited, and examples thereof include diacetone acrylamide.

Specific examples of any vinyl monomer other than the above are not particularly limited, and examples include not only olefins such as ethylene, propylene and isobutylene, dienes such as butadiene, haloolefins such as vinyl chloride, vinylidene chloride, vinyl fluoride, tetrafluoroethylene and chlorotrifluoroethylene, carboxylic acid vinyl esters such as vinyl acetate, vinyl propionate, vinyl n-butyrate, vinyl benzoate, vinyl p-t-butylbenzoate, vinyl pivalate, vinyl 2-ethylhexanoate, vinyl versatate and vinyl laurate, carboxylic acid isopropenyl esters such as isopropenyl acetate and isopropenyl propionate, vinyl ethers such as ethyl vinyl ether, isobutyl vinyl ether and cyclohexyl vinyl ether, allyl esters such as allyl acetate and allyl benzoate, and allyl ethers such as allyl ethyl ether and allyl phenyl ether, but also 4-(meth)acryloyloxy-2,2,6,6-tetramethylpiperidine, 4-(meth)acryloyloxy-1,2,2,6,6-pentamethylpiperidine, perfluoromethyl (meth)acrylate, perfluoropropyl (meth)acrylate, perfluoropropyl methyl (meth)acrylate, vinylpyrrolidone, trimethylolpropane tri(meth)acrylate and allyl (meth)acrylate, and any combination thereof.

The vinyl monomer having secondary and/or tertiary amide group(s) is not particularly limited, and examples thereof can include N-alkyl or N-alkylene-substituted (meth)acrylamide. Specific examples can include N-methylacrylamide, N-methylmethacrylamide, N-ethylacrylamide, N,N-dimethylacrylamide, N,N-dimethylmethacrylamide, N,N-diethylacrylamide, N-ethylmethacrylamide, N-methyl-N-ethylacrylamide, N-methyl-N-ethylmethacrylamide, N-isopropylacrylamide, N-n-propylacrylamide, N-isopropylmethacrylamide, N-n-propylmethacrylamide, N-methyl-N-n-propylacrylamide, N-methyl-N-isopropylacrylamide, N-acryloylpyrrolidine, N-methacryloylpyrrolidine, N-acryloylpiperidine, N-methacryloylpiperidine, N-acryloylhexahydroazepine, N-acryloylmorpholine, N-methacryloylmorpholine, N-vinylpyrrolidone, N-vinylcaprolactam, N,N′-methylenebisacrylamide, N,N′-methylenebismethacrylamide, N-vinylacetamide, diacetone acrylamide, diacetone methacrylamide, N-methylolacrylamide and N-methylolmethacrylamide.

The silicone compound is not particularly limited, and examples thereof include respective hydrolyzed condensates of trimethoxysilane, triethoxysilane, methyltrimethoxysilane, methyltriethoxysilane, cyclohexyltrimethoxysilane, cyclohexyltriethoxysilane, phenyltrimethoxysilane, phenyltriethoxysilane, dimethoxysilane, diethoxysilane, methyldimethoxysilane, methyldiethoxysilane, dimethyldimethoxysilane, dimethyldiethoxysilane, dimethoxydiphenylsilane, diethoxydiphenylsilane, 3-acryloxypropyltrimethoxysilane, 3-acryloxypropyltriethoxysilane, 3-methacryloxypropyltrimethoxysilane, 3-methacryloxypropyltriethoxysilane, 3-methacryloxypropylmethyldimethoxysilane, 3-methacryloxypropylmethyldimethoxysilane, vinyltrimethoxysilane, vinyltriethoxysilane, p-styryltrimethoxysilane, p-styryltriethoxysilane, tetramethoxysilane, and tetraethoxysilane.

The polymer particle (A) may have a structure derived from an emulsifier. The emulsifier is not particularly limited, and examples thereof include acidic emulsifiers such as alkylbenzene sulfonic acid, alkylsulfonic acid, alkylsulfosuccinic acid, polyoxyethylene alkyl sulfuric acid, polyoxyethylene alkyl aryl sulfuric acid and polyoxyethylene distyryl phenyl ether sulfonic acid; anionic surfactants such as alkali metal (Li, Na, K, and the like) salts of such acidic emulsifiers, ammonium salts of such acidic emulsifier, and fatty acid soap; quaternary ammonium salt, pyridinium salt, and imidazolinium salt type cationic surfactants such as alkyltrimethylammonium bromide, alkylpyridinium bromide and imidazolinium laurate; and nonionic surfactants and reactive emulsifiers having a radical polymerizable double bond, such as polyoxyethylene alkyl aryl ether, polyoxyethylene sorbitan fatty acid ester, a polyoxyethylene oxypropylene block copolymer and polyoxyethylene distyryl phenyl ether.

Examples of the reactive emulsifier having a radical polymerizable double bond include, but not limited to the following, Eleminol JS-2 (trade name, manufactured by Sanyo Chemical Industries, Ltd.), Latemul S-120, S-180A or S-180 (trade name, manufactured by Kao Corporation), Aqualon HS-10, KH-1025, RN-10, RN-20, RN30 or RN50 (trade name, manufactured by DKS Co., Ltd.), Adekariasoap SE1025, SR-1025, NE-20, NE-30 or NE-40 (trade name, manufactured by Adeka Corporation), an ammonium salt of p-styrene sulfonic acid, a sodium salt of p-styrene sulfonic acid, a potassium salt of p-styrene sulfonic acid, alkyl sulfonic acid (meth)acrylate such as 2-sulfoethyl acrylate, methylpropanesulfonic acid (meth)acrylamide, an ammonium salt of allyl sulfonic acid, a sodium salt of allyl sulfonic acid, or a potassium salt of allyl sulfonic acid.

### [Average Particle Size of Polymer Particle (A)]

The average particle size of the polymer particle (A) is determined from the size of such any particle observed according to a dynamic light scattering method. The average particle size of the polymer particle (A) is not particularly limited, and is preferably 200 nm or less. The average particle size of the polymer particle (A) is adjusted in the range, and thus an adhesion layer still higher in adhesiveness can be likely formed due to an enhancement in contact area with the substrate. The average particle size of the polymer particle (A) is more preferably 150 nm or less from the viewpoint of an enhancement in transparency of the adhesion layer, and is preferably 10 nm or more, more preferably 50 nm or more from the viewpoint of an improvement in storage stability of a raw material composition of the adhesion layer. The average particle size of the polymer particle (A) can be measured by a method described in Examples below.

### [Inorganic Oxide (B)]

The adhesion layer includes an inorganic oxide (B). The adhesion layer includes an inorganic oxide (B) and thus is considered to be increased in degree of surface roughness of the adhesion layer and therefore enhanced in interaction between the adhesion layer and the hard coating layer (K) and excellent in adhesiveness of the formed laminate.

Specific examples of the inorganic oxide (B) include, but not limited to the following, respective oxides of silicon, aluminum, titanium, zirconium, zinc, cerium, tin, indium, gallium, germanium, antimony, molybdenum, niobium, magnesium, bismuth, cobalt, and copper. Such an inorganic oxide may be in the form of a single substance or a mixture.

The inorganic oxide (B) is preferably a silica particle typified by dry silica or colloidal silica from the viewpoint of adhesiveness to the hard coating layer (K). Colloidal silica is preferable because it can also be used even in the form of an aqueous dispersion liquid.

### [Shape of Inorganic Oxide (B)]

Examples of the shape of the inorganic oxide (B) include, but not limited to the following, one of or a mixture of two or more of spherical, horned, polyhedron, elliptical, flattened, linear, beaded, and chained shapes. The inorganic oxide (B) in the present embodiment preferably has a spherical shape and/or a linked structure such as a beaded or chained shape from the viewpoints of transparency, abrasion resistance, and adhesiveness of the laminate. The inorganic oxide (B) more preferably has a linked structure such as a beaded or chained shape from the viewpoint of adhesiveness of the adhesion layer to the hard coating layer (K). The beaded shape is a structure where a spherical primary particle is linked in a beaded manner, and the chained shape is a structure where a spherical primary particle is linked in a chained shape. In the present embodiment, the inorganic oxide (B) is particularly preferably a silica having a spherical shape and/or a linked structure, extremely preferably a silica having a linked structure.

The primary average particle size of the inorganic oxide (B) is preferably 2 nm or more from the viewpoint of an improvement in storage stability of a raw material composition of the adhesion layer. The primary average particle size of the inorganic oxide (B) is preferably 150 nm or less, more preferably 100 nm or less, further preferably 50 nm or less from the viewpoint of an improvement in transparency of the entire laminate. Thus, the primary average particle size of the inorganic oxide (B) is preferably 2 nm or more and 100 nm or less, more preferably 2 nm or more and 50 nm or less, further preferably 4 nm or more and 50 nm or less. The primary average particle size of the inorganic oxide (B) can be obtained by, but not limited to the following, for example, observing the inorganic oxide (B) at a magnification of 50,000 to 100,000× with a transmission micrograph, taking an image so that 100 to 200 inorganic oxides (B) in the form of particles are photographed, and measuring a longer diameter and a shorter diameter of each of such inorganic oxide particles to thereby determine the average value as the primary average particle size of the inorganic oxide (B).

### [Colloidal Silica Suitably Used as Inorganic Oxide (B)]

In the present embodiment, colloidal silica is suitably used as the inorganic oxide (B). The colloidal silica is not particularly limited and is preferably, for example, acidic colloidal silica for which water is used as a dispersing solvent. Such colloidal silica is not particularly limited, and any one prepared according to a sol-gel method can also be used and a commercially available product can also be utilized. Such preparation according to a sol-gel method can be made with reference to Werner Stober et al; J. Colloid and Interface Scf-26, 62-69 (1968), Rickey D. Badley et al; Lang muir 6, 792-801 (1990), Journal of the Japan Society of Colour Material, 61 [9] 488-493 (1988), and the like.

Examples of such a commercially available product utilized include, but not particularly limited to, Snowtex-O, Snowtex-OS, Snowtex-OXS, Snowtex-O-40, Snowtex-OL, Snowtex-OYL, Snowtex-OUP, Snowtex-PS-SO, Snowtex-PS-MO, Snowtex-AK-XS, Snowtex-AK, Snowtex-AK-L, Snowtex-AK-YL and Snowtex-AK-PS-S (trade names, manufactured by Nissan Chemical Corporation), Adelite AT-20Q (trade name, manufactured by Adeka Corporation), and Klebosol 20H12 and Klebosol 30CAL25 (trade names, manufactured by Clariant Japan K.K.).

The basic colloidal silica is not particularly limited, and examples thereof include silica stabilized by addition of an alkali metal ion, an ammonium ion or an amine. Specific examples thereof include, but not particularly limited to, Snowtex-20, Snowtex-30, Snowtex-XS, Snowtex-50, Snowtex-30L, Snowtex-XL, Snowtex-YL, Snowtex ZL, Snowtex-UP, Snowtex-ST-PS-S, Snowtex ST-PS-M, Snowtex-C, Snowtex-CXS, Snowtex-CM, Snowtex-N, Snowtex-NXS, Snowtex-NS and Snowtex-N-40 (trade names, manufactured by Nissan Chemical Corporation), Adelite AT-20, Adelite AT-30, Adelite AT-20N, Adelite AT-30N, Adelite AT-20A, Adelite AT-30A, Adelite AT-40 and Adelite AT-50 (trade names, manufactured by Adeka Corporation), Klebosol 30R9, Klebosol 30R50 and Klebosol 50R50 (trade names, manufactured by Clariant Japan K.K.), and Ludox HS-40, Ludox HS-30, Ludox LS, Ludox AS-30, Ludox SM-AS, Ludox AM, Ludox HAS and Ludox SM (trade names, manufactured by DuPont).

The colloidal silica for which a water-soluble solvent is used as a dispersing medium is not particularly limited, and examples thereof include MA-ST-M (methanol dispersion type having a particle size of 20 to 25 nm), IPA-ST (isopropyl alcohol dispersion type having a particle size of 10 to 15 nm), EG-ST (ethylene glycol dispersion type having a particle size of 10 to 15 nm), EGST-ZL (ethylene glycol dispersion type having a particle size of 70 to 100 nm), NPC-ST (ethylene glycol monopropyl ether dispersion type having a particle size of 10 to 15 nm) and TOL-ST (toluene dispersion type having a particle size of 10 to 15 nm), manufactured by Nissan Chemical Corporation.

The dry silica particle is not particularly limited, and examples thereof include AEROSIL manufactured by Nippon Aerosil Co., Ltd., and Reolosil manufactured by Tokuyama Corporation.

The silica particle may include an inorganic base (for example, sodium hydroxide, potassium hydroxide, lithium hydroxide, and/or ammonia) and/or an organic base (for example, tetramethylammonium and/or triethylamine) as stabilizer(s).

### [Composite (E) of Polymer Particle (A) and Inorganic Oxide (B)]

The inorganic oxide (B) in the present embodiment is preferably a composite with the polymer particle (A), formed in advance, i.e., forms a composite (E) of the polymer particle (A) and the inorganic oxide (B), from the viewpoint of transparency of the adhesion layer or the laminate. The composite (E) of the polymer particle (A) and the inorganic oxide (B) is not particularly limited and is obtained by, for example, polymerization of a vinyl monomer constituting the above polymer particle (A), in the presence of the inorganic oxide (B). The vinyl monomer preferably includes at least one selected from the group consisting of the above hydroxyl group-containing vinyl monomer, vinyl monomer having a secondary amide group and vinyl monomer having a tertiary amide group from the viewpoint of interaction with the inorganic oxide (B). Such a vinyl monomer can preferably form the composite (E) from a hydrogen bond to a hydroxyl group of the inorganic oxide (B).

In the present embodiment, the average particle size of at least one selected from the group consisting of the polymer particle (A), the inorganic oxide (B), and the composite (E) is preferably 2 nm or more and 200 nm or less, more preferably 50 nm or more and 150 nm or less from the viewpoints of outer appearance and adhesiveness of the adhesion layer and the laminate.

In the present embodiment, the average particle size of the mixture and/or the composite (E) of the polymer particle (A) and the inorganic oxide (B) is preferably 2 nm or more and 2000 nm or less, more preferably 50 nm or more and 150 nm or less from the same viewpoints as above.

The average particle size is determined from the size of such any particle observed according to a dynamic light scattering method.

### [Mass Ratio of Polymer Particle (A) and Inorganic Oxide (B)]

In the present embodiment, the mass ratio of the polymer particle (A) and the inorganic oxide (B) (polymer particle (A):inorganic oxide (B)) is preferably 1:0.5 to 1:2.0. When the mass ratio of the polymer particle (A) and the inorganic oxide (B) is in the above range, the formed adhesion layer or laminate tends to be excellent in transparency and adhesiveness. The mass ratio (polymer particle (A):inorganic oxide (B)) is more preferably 1:1 to 1:1.5 from the viewpoint of a further enhancement in transparency, adhesiveness, and durability of the adhesion layer or the laminate.

When the adhesion layer in the present embodiment includes the composite (E) and the polymer particle (A) which is a separate component therefrom, the above content is calculated as the total amount of the polymer particle included in the composite (C) and the polymer particle (A) which is a separate component therefrom. Likewise, when the adhesion layer includes the composite (E) and the inorganic oxide (B) which is a separate component therefrom, the above content is calculated as the total amount of the inorganic oxide included in the composite (C) and the inorganic oxide (B) which is a separate component therefrom.

### [Light-Shielding Agent (D)]

The adhesion layer further includes a light-shielding agent (D), in addition to the polymer particle (A) and the inorganic oxide (B), from the viewpoint that weather resistance and optical properties are ensured. The light-shielding agent includes an ultraviolet absorber from the viewpoint of an enhancement in optical properties. Specific examples of the ultraviolet absorber include, but not limited to the following, benzophenone-based ultraviolet absorbers such as 2,4-dihydroxybenzophenone, 2-hydroxy-4-methoxybenzophenone, 2-hydroxy-4-methoxybenzophenone-5-sulfonic acid, 2-hydroxy-4-n-octoxybenzophenone, 2-hydroxy-4-n-dodecyloxybenzophenone, 2-hydroxy-4-benzyloxybenzophenone, bis(5-benzoyl-4-hydroxy-2-methoxyphenyl)methane, 2,2′-dihydroxy-4-methoxybenzophenone, 2,2′-dihydroxy-4,4′dimethoxybenzophenone (trade name “UVINUL3049” manufactured by BASF SE), 2,2′,4,4′-tetrahydroxybenzophenone (trade name “UVINUL3050” manufactured by BASF SE), 4-dodecyloxy-2-hydroxybenzophenone, 5-benzoyl-2,4-dihydroxybenzophenone, 2-hydroxy-4-methoxy-2′-carboxybenzophenone, 2-hydroxy-4-stearyloxybenzophenone and 4,6-dibenzoyl resorcinol; benzotriazole-based ultraviolet absorbers such as 2-(2′-hydroxy-5′-methylphenyl)benzotriazole, 2-(2′-hydroxy-5′-tert-butylphenyl)benzotriazole, 2-(2′-hydroxy-3′,5′-di-tert-butylphenyl)benzotriazole, 2-(2-hydroxy-5-tert-octylphenyl)benzotriazole, 2-(2-hydroxy-3,5-di-tert-octylphenyl)benzotriazole, 2-[2′-hydroxy-3′,5′-bis(α,α′-dimethylbenzyl)phenyl]benzotriazole), a condensate (trade name “TINUVIN1130” manufactured by BASF SE) of methyl-3-[3-tert-butyl-5-(2H-benzotriazol-2-yl)-4-hydroxyphenyl]propionate and polyethylene glycol (molecular weight: 300), isooctyl-3-[3-(2H-benzotriazol-2-yl)-5-tert-butyl-4-hydroxyphenyl]propionate (trade name “TINUVIN384” manufactured by BASF SE), 2-(3-dodecyl-5-methyl-2-hydroxyphenyl)benzotriazole (trade name “TINUVIN571” manufactured by BASF SE), 2-(2′-hydroxy-3′-tert-butyl-5′-methylphenyl)-5-chlorobenzotriazole, 2-(2′-hydroxy-3′,5′-di-tert-amylphenyl)benzotriazole, 2-(2′-hydroxy-4′-octoxyphenyl)benzotriazole, 2-[2′-hydroxy-3′-(3″,4″,5″,6″-tetrahydrophthalimidemethyl)-5′-methylphenyl]benzotriazole, 2,2-methylenebis[4-(1,1,3,3-tetramethylbutyl)-6-(2H-benzotriazol-2-yl)phenol], 2-(2H-benzotriazol-2-yl)-4,6-bis(1-methyl-1-phenylethyl)phenol (trade name “TINUVIN900” manufactured by BASF SE), and TINUVIN384-2, TINUVIN326, TINUVIN327, TINUVIN109, TINUVIN970, TINUVIN328, TINUVIN171, TINUVIN970, TINUVIN PS, TINUVIN P, TINUVIN99-2 and TINVIN928 (trade names, manufactured by BASF SE); triazine-based ultraviolet absorbers such as 2-[4-[(2-hydroxy-3-dodecyloxypropyl)oxy]-2-hydroxyphenyl]-4,6-bis(2,4-dimethylphenyl)-1,3,5-triazine, 2-[4-[(2-hydroxy-3-tridecyloxypropyl)oxy]-2-hydroxyphenyl]-4,6-bis(2,4-dimethylphenyl)-1,3,5-triazine, 2,4-bis (2-hydroxy-4-butyloxyphenyl)-6-(2,4-bisbutyloxyphenyl)-1,3,5-triazine (trade name “TINUVIN460” manufactured by BASF SE), 2-(2-hydroxy-4-[1-octyloxycarbonylethoxy]phenyl)-4,6-bis(4-phenylphenyl)-1,3,5-triazine (trade name “TINUVIN479” manufactured by BASF SE), and a mixture including 2-[4-[(2-hydroxy-3-dodecyloxypropyl)oxy]-2-hydroxyphenyl]-4,6-bis(2,4-dimethylphenyl)-1,3,5-triazine and 2-[4-[(2-hydroxy-3-tridecyloxypropyl)oxy]-2-hydroxyphenyl]-4,6-bis(2,4-dimethylphenyl)-1,3,5-triazine (trade name “TINUVIN400” manufactured by BASF SE), TINUVIN405, TINUVIN477 and TINUVIN1600 (trade names, manufactured by BASF SE); malonic acid ester-based ultraviolet absorbers such as HOSTAVIN PR25, HOSTAVIN B-CAP and HOSTAVIN VSU (trade names, manufactured by Clariant Japan K.K.); anilide-based ultraviolet absorbers such as HOSTAVIN 3206 LIQ, HOSTAVIN VSU P and HOSTAVIN 3212 LIQ (trade names, manufactured by Clariant Japan K.K.); salicylate-based ultraviolet absorbers such as amyl salicylate, menthyl salicylate, homomenthyl salicylate, octyl salicylate, phenyl salicylate, benzyl salicylate and p-isopropanolphenyl salicylate; cyanoacrylate-based ultraviolet absorbers such as ethyl-2-cyano-3,3-diphenyl acrylate (trade name “UVINUL3035” manufactured by BASF SE), (2-ethylhexyl)-2-cyano-3,3-diphenyl acrylate (trade name “UVINUL3039” manufactured by BASF SE) and 1,3-bis((2′-cyano-3′,3′-diphenylacryloyl)oxy)-2,2-bis-(((2′-cyano-3′,3′-diphenylacryloyl)oxy)methyl)propane (trade name “UVINUL3030” manufactured by BASF SE); radical polymerizable ultraviolet absorbers each having a radical polymerizable double bond in its molecule, such as 2-hydroxy-4-acryloxybenzophenone, 2-hydroxy-4-methacryloxybenzophenone, 2-hydroxy-5-acryloxybenzophenone, 2-hydroxy-5-methacryloxybenzophenone, 2-hydroxy-4-(acryloxy-ethoxy)benzophenone, 2-hydroxy-4-(methacryloxy-ethoxy)benzophenone, 2-hydroxy-4-(methacryloxy-diethoxy)benzophenone, 2-hydroxy-4-(acryloxy-triethoxy)benzophenone, 2-(2′-hydroxy-5′-methacryloxyethylphenyl)-2H-benzotriazole (trade name “RUVA-93” manufactured by Otsuka Chemical Co., Ltd.), 2-(2′-hydroxy-5′-methacryloxyethyl-3-tert-butylphenyl)-2H-benzotriazole, 2-(2′-hydroxy-5′-methacryloxypropyl-3-tert-butylphenyl)-5-chloro-2H-benzotriazole and 3-methacryloyl-2-hydroxypropyl-3-[3′-(2″-benzotriazolyl)-4-hydroxy-5-tert-butyl]phenylpropionate (trade name “CGL-104” manufactured by Ciba-Geigy Japan Ltd.); polymers each having ultraviolet absorptivity, such as UVf-101, UV-G301, UV-G137, UV-G12 and UVf-13 (trade names, manufactured by Nippon Shokubai Co., Ltd.); and ultraviolet absorbers each having reactivity with a silanol group, an isocyanate group, an epoxy group, a semicarbazide group or a hydrazide group, and these may be used singly or in combinations of two or more thereof. In particular, the ultraviolet absorber preferably includes at least one selected from the group consisting of a benzotriazole-based ultraviolet absorber, a benzophenone-based ultraviolet absorber, a triazine-based ultraviolet absorber, a malonic acid ester-based ultraviolet absorber, an anilide-based ultraviolet absorber, a salicylate-based ultraviolet absorber and a cyanoacrylate-based ultraviolet absorber, more preferably includes at least one selected from the group consisting of a benzotriazole-based ultraviolet absorber, a benzophenone-based ultraviolet absorber, a triazine-based ultraviolet absorber and a cyanoacrylate-based ultraviolet absorber. The ultraviolet absorber preferably includes a triazine-based ultraviolet absorber from the viewpoint of weather resistance, and more preferably includes 2-(2-hydroxy-4-[1-octyloxycarbonylethoxy]phenyl)-4,6-bis (4-phenylphenyl)-1,3,5-triazine, and/or a mixture including 2-[4-[(2-hydroxy-3-dodecyloxypropyl)oxy]-2-hydroxyphenyl]-4,6-bis(2,4-dimethylphenyl)-1,3,5-triazine and 2-[4-[(2-hydroxy-3-tridecyloxypropyl)oxy]-2-hydroxyphenyl]-4,6-bis(2,4-dimethylphenyl)-1,3,5-triazine.

The content of the light-shielding agent (D) based on 100 parts by mass (in terms of the solid content) of the polymer particle (A) is preferably 1 part by mass or more, more preferably 5 parts by mass or more, further preferably 15 parts by mass or more, still further preferably 20 parts by mass or more from the viewpoint of optical properties. The content is preferably 200 parts by mass or less, more preferably 150 parts by mass or less, further preferably 100 parts by mass or less, still further preferably 75 parts by mass or less from the viewpoint of solubility.

When the adhesion layer in the present embodiment includes the composite (E) and the polymer particle (A) which is a separate component therefrom, the above content is calculated as the total amount of the polymer particle included in the composite (C) and the polymer particle (A) which is a separate component therefrom.

The content of the ultraviolet absorber is preferably 1 part by mass or more, more preferably 5 parts by mass or more, further preferably 12 parts by mass or more, still further preferably 20 parts by mass or more based on 100 parts by mass (in terms of the solid content) of the polymer particle (A) from the viewpoint of optical properties. The content of the ultraviolet absorber is preferably 200 parts by mass or less, more preferably 100 parts by mass or less, further preferably 50 parts by mass or less based on 100 parts by mass of the solid content of the polymer particle (A) from the viewpoint of solubility.

When the adhesion layer in the present embodiment includes the composite (E) and the polymer particle (A) which is a separate component therefrom, the above content is calculated as the total amount of the polymer particle included in the composite (C) and the polymer particle (A) which is a separate component therefrom.

The light-shielding agent (D) preferably further includes a hindered amine-based light stabilizer.

Examples of the hindered amine-based light stabilizer include, but not limited to the following, hindered amine-based light stabilizers such as bis(2,2,6,6-tetramethyl-4-piperidyl)succinate, bis(2,2,6,6-tetramethylpiperidyl)sebacate, bis(1,2,2,6,6-pentamethyl-4-piperidyl)2-(3,5-di-tert-butyl-4-hydroxybenzyl)-2-butylmalonate, 1-[2-[3-(3,5-di-tert-butyl-4-hydroxyphenyl)propinyloxy]ethyl]-4-[3-(3,5-di-tert-butyl-4-hydroxyphenyl)propinyloxy]-2,2,6,6-tetramethylpiperidine, a mixture (trade name “TINUVIN292” manufactured by BASF SE) of bis(1,2,2,6,6-pentamethyl-4-piperidyl)sebacate and methyl-1,2,2,6,6-pentamethyl-4-piperidyl-sebacate, bis(1-octoxy-2,2,6,6-tetramethyl-4-piperidyl)sebacate, and TINUVIN123, TINUVIN144, TINUVIN152, TINUVIN249, TINUVIN292 and TINUVIN5100 (trade names, manufactured by BASF SE); and radical polymerizable hindered amine-based light stabilizers such as 1,2,2,6,6-pentamethyl-4-piperidyl methacrylate, 1,2,2,6,6-pentamethyl-4-piperidyl acrylate, 2,2,6,6-tetramethyl-4-piperidyl methacrylate, 2,2,6,6-tetramethyl-4-piperidyl acrylate, 1,2,2,6,6-pentamethyl-4-iminopiperidyl methacrylate, 2,2,6,6,-tetramethyl-4-iminopiperidyl methacrylate, 4-cyano-2,2,6,6-tetramethyl-4-piperidyl methacrylate and 4-cyano-1,2,2,6,6-pentamethyl-4-piperidyl methacrylate.

The above hindered amine-based light stabilizers may be used singly or in combinations of two or more thereof.

### [Component Optionally Included in Adhesion Layer]

The adhesion layer is not particularly limited as long as it includes the polymer particle (A), the inorganic oxide (B) and the light-shielding agent (D), and optionally includes any other component. Such any other component is not particularly limited, examples thereof include a thermoplastic resin, a thermosetting resin, and a rubber-elastomer, and in particular, an acrylic resin, an acrylic urethane-based resin, a urethane-based resin, and a silicone-based resin are preferable. The adhesion layer optionally includes, if necessary, any appropriate additive. Examples of the additive include, but not limited to the following, a crosslinking agent, a tackifier, a plasticizer, a pigment, a dye, a filler, an anti-aging agent, a conductive material, a light stabilizer other than the above hindered amine-based light stabilizer, a peel strength adjusting agent, a softener, a surfactant, a flame retardant, an antioxidant, and a catalyst, and a light stabilizer and/or an antioxidant are/is preferably included from the viewpoint of optical properties. The light stabilizer is not particularly limited from the same viewpoint, and examples thereof include a benzotriazole-based compound, a triazine-based compound, a benzophenone-based compound, and a benzoate-based compound. The antioxidant is not particularly limited, and examples thereof include a phenol-based compound, an amine-based compound, a phosphorus-based compound, and a sulfur-based compound.

Examples of the crosslinking agent include, but not limited to the following, an isocyanate-based crosslinking agent, an epoxy-based crosslinking agent, a carbodiimide-based crosslinking agent, an oxazoline-based crosslinking agent, an aziridine-based crosslinking agent, an amine-based crosslinking agent, a peroxide-based crosslinking agent, a melamine-based crosslinking agent, a urea-based crosslinking agent, a metal alkoxide-based crosslinking agent, a metal chelate-based crosslinking agent, and a metal salt-based crosslinking agent.

Examples of the light stabilizer other than the above hindered amine-based light stabilizer include, but not limited to the following, polymers each having photostability, such as U-Double E-133, U-Double E-135, U-Double S-2000, U-Double S-2834, U-Double S-2840, U-Double S-2818 and U-Double S-2860 (trade names, manufactured by Nippon Shokubai Co., Ltd.).

The above components may be each used singly or in combinations of two or more thereof.

The content of any other component in the adhesion layer is preferably 0 to 30% by mass, more preferably 5 to 30% by mass, further preferably 10 to 30% by mass.

The content of the light stabilizer is preferably 0.01 parts by mass or more, more preferably 0.05 parts by mass or more, further preferably 0.1 parts by mass or more, still further preferably 0.5 parts by mass or more based on 100 parts by mass (in terms of the solid content) of the polymer particle (A) from the viewpoint of optical properties. The content is preferably 100 parts by mass or less, more preferably 50 parts by mass or less, further preferably 20 parts by mass or less based on 100 parts by mass of the solid content of the polymer particle (A) from the viewpoint of coating material stability.

The content of the hindered amine-based light stabilizer is preferably 0.01 parts by mass or more, more preferably 0.05 parts by mass or more, further preferably 0.1 parts by mass or more, still further preferably 0.5 parts by mass or more based on 100 parts by mass (in terms of the solid content) of the polymer particle (A) from the viewpoint of optical properties. The content is preferably 100 parts by mass or less, more preferably 20 parts by mass or less, further preferably 10 parts by mass or less based on 100 parts by mass (in terms of the solid content) of the polymer particle (A) from the viewpoint of coating material stability.

The content of the antioxidant is preferably 0.01 parts by mass or more, more preferably 0.05 parts by mass or more, further preferably 0.1 parts by mass or more, still further preferably 0.5 parts by mass or more based on 100 parts by mass of the solid content of the polymer particle (A) from the viewpoint of optical properties. The content is preferably 100 parts by mass or less, more preferably 50 parts by mass or less, further preferably 20 parts by mass or less based on 100 parts by mass of the solid content of the polymer particle (A) from the viewpoint of coating material stability.

When the adhesion layer in the present embodiment includes the composite (E) and the polymer particle (A) which is a separate component therefrom, the above content is calculated as the total amount of the polymer particle included in the composite (C) and the polymer particle (A) which is a separate component therefrom.

### [Isocyanate Compound]

The adhesion layer preferably contains an isocyanate compound and/or a urethane compound as a curing agent from the viewpoint of an enhancement in adhesiveness and durability of the adhesion layer or the laminate. The isocyanate compound refers to a compound having at least one or more isocyanate groups in one molecule. The isocyanate compound may be a compound having two or more isocyanate groups in one molecule.

Examples of the isocyanate compound include, but not limited to the following, aliphatic diisocyanates such as 1,4-tetramethylene diisocyanate, ethyl(2,6-diisocyanate)hexanoate, 1,6-hexamethylene diisocyanate, 1,12-dodecamethylene diisocyanate and 2,2,4- or 2,4,4-trimethylhexamethylene diisocyanate; aliphatic triisocyanates such as 1,3,6-hexamethylene triisocyanate, 1,8-diisocyanato-4-isocyanatomethyloctane and 2-isocyanatoethyl(2,6-diisocyanato)hexanoate; alicyclic diisocyanates such as 1,3- or 1,4-bis(isocyanatomethylcyclohexane), 1,3- or 1,4-diisocyanate cyclohexane, 3,5,5-trimethyl(3-isocyanatomethyl)cyclohexylisocyanate, dicyclohexylmethane-4,4′-diisocyanate and 2,5- or 2,6-diisocyanatomethylnorbornane; alicyclic triisocyanates such as 2,5- or 2,6-diisocyanatomethyl-2-isocyanate propylnorbornane; aralkylene diisocyanates such as m-xylylene diisocyanate and α,α,α′α′-tetramethyl-m-xylylene diisocyanate; aromatic diisocyanates such as m- or p-phenylene diisocyanate, tolylene-2,4- or 2,6-diisocyanate, diphenylmethane-4,4′-diisocyanate, naphthalene-1,5-diisocyanate, diphenyl-4,4′-diisocyanate, 4,4′-diisocyanato-3,3′-dimethyldiphenyl, 3-methyl-diphenylmethane-4,4′-diisocyanate and diphenyl ether-4,4′-diisocyanate; and aromatic triisocyanates such as triphenylmethane triisocyanate and tris(isocyanatophenyl)thiophosphate, as well as diisocyanates or polyisocyanates each having a uretdione structure obtained by cyclization and dimerization of isocyanate groups of any of the above diisocyanates or triisocyanates; polyisocyanates each having an isocyanurate structure obtained by cyclization and trimerization of isocyanate groups of any of the above diisocyanates or triisocyanates; polyisocyanates each having a buret structure obtained by reacting any of the above diisocyanates or triisocyanates with water; polyisocyanates each having an oxadiazine trione structure obtained by reacting any of the above diisocyanates or triisocyanates with carbon dioxide; polyisocyanates each having an allophanate structure obtained by reacting any of the above diisocyanates or triisocyanates with any of various alcohols; and polyisocyanates each obtained by reacting any of the above diisocyanates or triisocyanates with an active hydrogen-containing compound like a polyhydroxy compound, a polycarboxy compound, or a polyamine compound. Examples of an isocyanate compound having an alkoxysilane moiety and/or a siloxane moiety in its molecule include 3-isocyanatepropyltriethoxysilane and/or hydrolyzed condensate (s) of 3-isocyanatepropyltriethoxysilane and/or the like. These can be used singly or as a mixture of two or more thereof.

### [Block Polyisocyanate Compound (C)]

The isocyanate compound is more preferably a block polyisocyanate compound (C) obtained by reacting an isocyanate group with a blocking agent from the viewpoint of dispersibility in a coating material. The content of the block polyisocyanate compound (C) in the adhesion layer is preferably 5 to 30% by mass, more preferably 10 to 30% by mass, further preferably 15 to 25% by mass. The blocking agent is not particularly limited, one that functions as a curing agent can be appropriately selected, and examples thereof include an oxime-based compound, an alcohol-based compound, an acid amide-based compound, an acid imide-based compound, a phenol-based compound, an amine-based compound, an active methylene-based compound, an imidazole-based compound, and a pyrazole-based compound. The oxime-based compound is not particularly limited, and examples thereof include formamide oxime, acetamide oxime, acetoxime, methyl ethyl ketoxime, and cyclohexanone oxime. The alcohol-based compound is not particularly limited, and examples thereof include methanol, ethanol, 2-propanol, n-butanol, sec-butanol, 2-ethyl-1-hexanol, 2-methoxyethanol, 2-ethoxyethanol, and 2-butoxyethanol. The acid amide-based compound is not particularly limited, and examples thereof include acetanilide, acetic amide, ε-caprolactam, δ-valerolactam, and γ-butyrolactam. The acid imide-based compound is not particularly limited, and examples thereof include succinic imide and maleic imide. The phenol-based compound is not particularly limited, and examples thereof include phenol, cresol ethylphenol, butylphenol, nonylphenol, dinonylphenol, styrenated phenol, and hydroxybenzoic acid ester. The amine-based compound is not particularly limited, and examples thereof include diphenylamine, aniline, carbazole, di-n-propylamine, diisopropylamine, and isopropylethylamine. The active methylene-based compound is not particularly limited, and examples thereof include dimethyl malonate, diethyl malonate, methyl acetoacetate, ethyl acetoacetate, and acetylacetone. The imidazole-based compound is not particularly limited, and examples thereof include imidazole and 2-methylimidazole. The pyrazole-based compound is not particularly limited, and examples thereof include pyrazole, 3-methylpyrazole, and 3,5-dimethylpyrazole.

The block polyisocyanate compound (C) is preferably obtained by reacting a water-dispersible isocyanate compound with the blocking agent, the water-dispersible isocyanate compound being obtained by reacting the polyisocyanate compound having two or more isocyanate groups in one molecule, and a hydroxyl group-containing hydrophilic compound having a nonionic and/or ionic hydrophilic group at an equivalent ratio of isocyanate group/hydroxyl group, ranging from 1.05 to 1000, from the viewpoint of water dispersibility. Such a water-dispersible block polyisocyanate compound (C) is not particularly limited, a commercially available product can also be adopted, and, for example, WT30-100 manufactured by Asahi Kasei Corporation or WM44-L70G manufactured by Asahi Kasei Corporation is preferably used as one having the above characteristics.

### [Nco/Oh Ratio]

When the polymer particle (A) in the adhesion layer of the present embodiment has a hydroxyl group, the ratio of the molar number of an isocyanate group included in the isocyanate compound to the molar number of a hydroxyl group included in the polymer particle (A) (NCO/OH ratio) is preferably 0.1 to 1.0, more preferably 0.2 to 1.0, further preferably 0.3 to 1.0, extremely preferably 0.3 to 0.8. When the NCO/OH ratio is in the above range, the formed laminate described below can exhibit excellent adhesiveness without impairing transparency.

When the adhesion layer in the present embodiment includes the composite (E) and the polymer particle (A) which is a separate component therefrom, the above “molar number of a hydroxyl group included in the polymer particle (A)” is calculated as the total amount of the polymer particle included in the composite (C) and the polymer particle (A) which is a separate component therefrom.

### [Method for Producing Adhesion Layer (Adhesion Layer-Applied Substrate)]

The method for producing the adhesion layer (adhesion layer-applied substrate) is not particularly limited, and examples thereof can include a method involving coating the substrate with the coating material composition (J) obtained by dispersing and dissolving the polymer particle (A), the inorganic oxide (B), and the light-shielding agent (D) and any other appropriate component in a solvent, and subjecting the resultant to, for example, a heat treatment, ultraviolet irradiation, and/or infrared irradiation to thereby form a coating film. The polymer particle (A) and the inorganic oxide (B), here used, may be a composite (E) thereof formed in advance. Examples of the coating method include, but not limited to the following, a spraying method, a flow coating method, a brush coating method, a dip coating method, a spin coating method, a screen printing method, a casting method, a gravure printing method, and a flexographic printing method. The coating material composition (J) subjected to coating can be preferably formed into a coating film by, for example, a heat treatment at room temperature to 250° C., more preferably 40° C. to 150° C., and/or ultraviolet or infrared irradiation. This coating can be applied for not only coating a substrate already formed, but also coating a flat plate in advance before forming and processing, like a pre-coating metal including a rust-resistant steel plate.

### [Coating Material Composition (J)]

The coating material composition (J) of the present embodiment is a coating material composition including: a mixture of a polymer particle (A) and an inorganic oxide (B), and/or a composite (E) of a polymer particle (A) (preferably an adhesive emulsion particle (A1)) and an inorganic oxide (B); and a light-shielding agent (D), in which
the inorganic oxide (B) is a silica having a linked structure, and/or a mixture of a silica having a linked structure and a silica having a spherical shape,
the average particle size of the mixture and/or the composite (E) of a polymer particle (A) and an inorganic oxide (B) is 2 nm or more and 2000 nm or less, and
the mass ratio of the polymer particle (A) and the inorganic oxide (B) (polymer particle (A):inorganic oxide (B)) is in the range of 1:0.5 to 1:2.0.

The average particle size can be measured by a method described in Examples below.

When the coating material composition (J) includes only a mixture of the polymer particle (A) and the inorganic oxide (B) (i.e., includes no composite (E)), the average particle size of the mixture can be said to be 2 nm or more and 2000 nm or less if both the average particle size of the polymer particle (A) and the primary average particle size of the inorganic oxide (B) are 2 nm or more and 2000 nm or less. When the coating material composition (J) includes the composite (E) and the polymer particle (A) and/or the inorganic oxide (B), the average particle size can be said to be 2 nm or more and 2000 nm or less if both the primary average particle size of the composite (E) and the primary average particle size of the polymer particle (A) and/or the inorganic oxide (B) are 2 nm or more and 2000 nm or less.

The coating material composition (J) can typically be used, as described above, for forming the adhesion layer in the adhesion layer-applied substrate of the present embodiment. The respective types and quantitative relationships of the components included in the coating material composition (J) typically tend to be the same as those of the components in the resulting adhesion layer except for a portion related to the content of a solvent described below. In other words, the detail of each component included in the coating material composition (J), not mentioned below, is as described above with respect to each component included in the adhesion layer. For example, the content of the polymer particle (A) is preferably 10 to 70% by mass, more preferably 20 to 60% by mass, further preferably 30 to 50% by mass based on 100% by mass in total of the polymer particle (A), the inorganic oxide (B), and the light-shielding agent (D). The content of the inorganic oxide (B) is preferably 20 to 80% by mass, more preferably 30 to 70% by mass, further preferably 40 to 60% by mass based on 100% by mass in total of the polymer particle (A), the inorganic oxide (B), and the light-shielding agent (D). The content of the light-shielding agent (D) is preferably 1 to 35% by mass, more preferably 3 to 30% by mass, further preferably 5 to 25% by mass based on 100% by mass in total of the polymer particle (A), the inorganic oxide (B), and the light-shielding agent (D). When the coating material composition (J) includes the composite (E) and the polymer particle (A) which is a separate component therefrom, the above content is calculated as the total amount of the polymer particle included in the composite (C) and the polymer particle (A) which is a separate component therefrom. Likewise, when the coating material composition (J) includes the composite (E) and the inorganic oxide (B) which is a separate component therefrom, the above content is calculated as the total amount of the inorganic oxide included in the composite (C) and the inorganic oxide (B) which is a separate component therefrom.

### [Solvent]

The coating material composition (J) of the present embodiment can contain a solvent. The solvent is not particularly limited, and a common solvent can be used. Specific examples of the solvent include, but not limited to the following, water; alcohols such as ethylene glycol, butyl cellosolve, isopropanol, n-butanol, 2-butanol, ethanol, methanol, modified ethanol, 2-methoxy-1-propanol, 1-methoxy-2-propanol, diacetone alcohol glycerin, monoalkyl monoglyceryl ether, propylene glycol monomethyl ether, diethylene glycol monobutyl ether, propylene glycol monoethyl ether, propylene glycol monobutyl ether, dipropylene glycol monoethyl ether, dipropylene glycol monobutyl ether, diethylene glycol monophenyl ether and tetraethylene glycol monophenyl ether; aromatic hydrocarbons such as toluene and xylene; aliphatic hydrocarbons such as hexane, cyclohexane and heptane; esters such as ethyl acetate and n-butyl acetate; ketones such as acetone, methyl ethyl ketone, methyl isobutyl ketone and cyclohexanone; ethers such as tetrahydrofuran and dioxane; amides such as dimethylacetamide and dimethylformamide; halogen compounds such as chloroform, methylene chloride and carbon tetrachloride; dimethylsulfoxide, and nitrobenzene; and these may be used singly or in combinations of two or more thereof. In particular, the coating material composition (J) preferably includes water and/or any alcohol from the viewpoint of a decrease in environmental load in removal of the solvent, and more preferably includes water. The content of the solvent is preferably 75% by mass or more based on 100% by mass of the coating material composition (J) from the viewpoint of dispersion stability of the coating material composition, and is preferably 95% by mass or less from the viewpoint that a film thickness is secured in film formation of the adhesion layer.

In the present embodiment, the mass ratio of the water to the entire solvent (water/solvent) is preferably 50% by mass or more, more preferably 60% by mass or more, further preferably 75% by mass or more from the viewpoint of a further decrease in global environmental burdens in removal of the solvent in forming the adhesion layer.

### <Laminate>

The laminate of the present embodiment includes the above adhesion layer-applied substrate and a hard coating layer (K) disposed on the adhesion layer-applied substrate.

The laminate of the present embodiment is configured as described above, and thus has high abrasion resistance, adhesiveness, durability, and weather resistance.

In the laminate of the present embodiment, the hard coating layer (K) preferably includes a polymer particle (F) and a matrix component (H), and the matrix component (H) preferably includes an inorganic oxide (G) and a hydrolyzable silicon compound (h).

By using such a hard coating layer (K), the laminate of the present embodiment tends to have higher abrasion resistance, adhesiveness, durability, and weather resistance.

The hard coating layer (K) preferably includes a polymer particle (F) and a matrix component (H) and contributes to abrasion resistance and durability of the laminate. The matrix component (H) in the present embodiment means a component except for the polymer particle (F) in the hard coating layer (K).

In the present embodiment, the Martens hardness HMF of the polymer particle (F) and the Martens hardness HMH of the matrix component (H) preferably satisfy a relationship of HMH/HMF>1 from the viewpoint of abrasion resistance of the laminate. Even if it is difficult to confirm the magnitude relationship between the Martens hardness HMF and the Martens hardness HMH, the magnitude relationship with respect to such Martens hardness can be estimated by comparison between the respective cohesion forces of the polymer particle (F) and the matrix component (H) described below. A lower cohesion force means a higher elasticity, and thus a lower cohesion force means that a coating film is more unlikely to be deformed and is higher in hardness. Specifically, the above preferable hard coating layer (K) can also be specified as follows. That is, the hard coating layer (K) includes the polymer particle (F) (preferably a polymer nanoparticle) and the matrix component (H), the cohesion force F_{F} of the polymer particle (F) and the cohesion force F_{H} of the matrix component (H), as measured in a cohesion force mode of a scanning probe microscope (SPM), preferably satisfy a relationship of F_{F}/F_{H}>1.

The polymer particle (F) in the hard coating layer (K) is preferably dispersed in the matrix component (H). The “dispersing” in the present embodiment means that the polymer particle (F) is dispersed in the matrix component (H) uniformly or with any structure being formed, under the assumption that the polymer particle (F) corresponds to a dispersing phase and the matrix component (H) corresponds to a continuous phase. The dispersing can be confirmed by cross-sectional SEM observation of the hard coating layer (K). The laminate tends to have high abrasion resistance due to dispersing of the polymer particle (F) in the matrix component (H) in the hard coating layer (K).

### [Martens Hardness]

The Martens hardness in the present embodiment is the hardness according to ISO14577-1, and is a value calculated from an indentation depth of 2 mN under measurement conditions (Vickers quadrangular pyramid diamond indenter, loading condition: 2 mN/20 sec, unloading condition: 2 mN/20 sec). The Martens hardness in the present embodiment can be measured by using, for example, a micro-hardness meter Fischer scope (HM2000S manufactured by Fischer Instruments K.K.), a nano indentation tester (ENT-NEXUS manufactured by Elionix Inc.), a nano indenter (iNano, G200 manufactured by Toyo Corporation), or a nano indentation system (TI980 manufactured by Bruker AXS GmbH). A lower indentation depth means higher Martens hardness and a higher indentation depth means lower Martens hardness.

### [Cohesion Force]

The cohesion force in the present embodiment can be measured with a scanning probe microscope (SPM). A lower cohesion force means a higher elasticity and thus a lower cohesion force means that a coating film is more unlikely to be deformed and is higher in hardness. Examples of the method for measuring the cohesion force include, but not limited to the following, a measurement method using SPM-970 or SPM-9700HT manufactured by Shimadzu Corporation, Dimension ICON manufactured by Bruker AXS GmbH, or AFM5000II manufactured by Hitachi High-Tech Science Corporation.

### [Other Hardness]

The Martens hardness and the magnitude relationship between the cohesion forces in the present embodiment can also be estimated by confirming a magnitude relationship between measurement values with other hardness as an index. Such other hardness is not particularly limited as long as it is an index exhibiting the difficulty of deformation of a material in application of any force to the material, and examples thereof can also include Vickers hardness and indentation hardness each measured with an indentation hardness meter typified by a micro-hardness meter or a nano indentation instrument, and an index expressed as a logarithmic decay rate measured with pendulum-type viscoelasticity tester typified by a rigid pendulum-type physical property tester. Other examples can also include indices expressed as a phase, a frictional force, viscoelasticity, an adsorptive force, hardness, and elastic modulus, as measured with a scanning probe microscope (SPM). If it is confirmed by such indices that the hardness of the matrix component (H) is higher than the hardness of the polymer particle (F), it is presumed that the matrix component (H) is harder than the polymer particle (F) also in terms of the Martens hardness and the cohesion force.

### [Martens Hardness HMF of Polymer Particle (F) and Martens Hardness HMH of Matrix Component (H)]

The Martens hardness HMF of the polymer particle (F) and the Martens hardness HMH of the matrix component (H) preferably satisfy a relationship of the following expression (1).

$$HMH / HMF > 1 \qquad expression ( 1 )$$

The expression (1) indicates that the soft polymer particle (F) is present in the hard matrix component (H), and such hardness can be expressed with a three-dimensional slope and thus the hard coating layer (K) tends to be able to exhibit abrasion resistance which has not been exhibited by any conventional coating film. The reason for this is estimated, but not intended to be limited to the following, as follows: the soft polymer particle (F) (preferably a nanoparticle) absorbs any impact and the hard matrix component (H) suppresses any deformation. The range of HMF is preferably 50 N/mm² or more, more preferably 100 N/mm² or more from the viewpoint of impact absorption, and is preferably 2000 N/mm² or less, more preferably 800 N/mm² or less, further preferably 350 N/mm² or less from the viewpoint of film formability. The range of HMH is preferably 100 N/mm² or more, more preferably 150 N/mm² or more from the viewpoint of impact absorption, and is preferably 4000 N/mm² or less, more preferably 2000 N/mm² or less from the viewpoint of film formability.

The hard coating layer (K), is not particularly limited, and, for example, can be obtained as a cured product formed by curing a coating material composition (L) described below, with hydrolytic condensation or the like. The polymer particle (F) is usually not changed in composition in the course of such curing. Accordingly, the value of the Martens hardness HMF in the hard coating layer (K) can be determined under the assumption that the value of the Martens hardness HMF of the polymer particle (F) in the coating material composition (L), as measured by a method described in Examples below, is well matched with the Martens hardness HMF of the polymer particle (F) in the hard coating layer (K). The matrix component (H) corresponds to a cured product formed by curing a matrix raw material component (H′) described below, with hydrolytic condensation or the like. Accordingly, the value of the Martens hardness HMH can be determined under the assumption that the value of the Martens hardness HMH of the matrix raw material component (H′), as measured by a method described in Examples below, is well matched with the Martens hardness HMH of the corresponding matrix component (H).

The respective values of the HMF and HMH can be adjusted by, for example, the structures of and the compositional ratio between the respective structural components of the polymer particle (F) and a matrix raw material component (H′) described below so as to satisfy the above magnitude relationship, but the adjustment is not limited thereto.

[Cohesion Force F_{F} of Polymer Particle (F) and Cohesion Force F_{H} of Matrix Component (H)]

The cohesion force F_{F} of the polymer particle (F) and the cohesion force F_{H} of the matrix component (H) preferably satisfy a relationship of the following expression (2).

$${F}_{F} / {F}_{H} > 1 \qquad expression ( 2 )$$

The expression (2), as in the expression (1), also indicates that the soft polymer particle (F) is present in the hard matrix component (H), and such hardness can be expressed with a three-dimensional slope and thus the hard coating layer (K) tends to be able to exhibit abrasion resistance which has not been exhibited by any conventional coating film. The reason for this is estimated, but not intended to be limited to the following, as follows: the soft polymer particle (F) (preferably a nanoparticle) absorbs any impact and the hard matrix component (H) suppresses any deformation.

The cohesion force F_{F} of the polymer particle (F) and the cohesion force F_{H} of the matrix component (H) correlate to the hardness of each of the components and can be adjusted by, for example, the structures of and the compositional ratio between the respective structural components of the polymer particle (F) and a matrix raw material component (H′) described below so as to satisfy the above magnitude relationship, but the adjustment is not limited thereto.

### [Martens Hardness HMK of Hard Coating Layer (K)]

The Martens hardness HMK of the hard coating layer (K) is preferably 100 N/mm² or more from the viewpoint of abrasion resistance of a laminate (K) described below, and higher Martens hardness has the advantage of less causing deformation against impact and less causing scratching associated with breakage. The Martens hardness HMK of the hard coating layer (K) is preferably 100 N/mm² or more, more preferably 150 N/mm² or more, further preferably 200 N/mm² or more, and is preferably 4000 N/mm² or less, more preferably 2000 N/mm² or less, further preferably 1500 N/mm² or less from the viewpoint of flex resistance. Examples of the method for adjusting the Martens hardness HMK of the hard coating layer (K) in the range include, but not limited to the following, a method involving coating a substrate with a coating material composition which satisfies a predetermined relationship represented by expression (3) described below and is obtained by dispersing and dissolving a composition including the polymer particle (F) and a matrix raw material component (H′) described below, mixed, in a solvent, and subjecting the resultant to heat treatment, ultraviolet irradiation, infrared irradiation, and/or the like to thereby form a coating film. In particular, an increase in content of the matrix component (H) based on the total amount of the polymer particle (F) and the matrix component (H) tends to result in an increase in Martens hardness HMK of the hard coating layer (K), and a decrease in content of the matrix component (H) tends to result in a decrease in Martens hardness HMK of the hard coating layer (K).

### [Amount of Change in Haze in Taber Abrasion Test]

In the present embodiment, the Taber abrasion test is a measurement method according to the method described in ASTM D1044, and such measurement is performed under conditions of an abrasive wheel CS-10F and a load of 500 g. Any material smaller in amount of change in haze in the Taber abrasion test is higher in abrasion resistance. Any material where the amount of change in haze after 500 rotations, relative to the haze before the Taber abrasion test, namely, the difference between a haze at a rotation number of 500 and a haze before the Taber abrasion test is 10 or less is adapted to the standards of ECE R43 rear quarter glass and any material where such a difference is 4 or less is adapted to the standards of ANSI/SAE Z.26.1 and can be suitably used in an automobile window material. Any material where the amount of change in haze after 1000 rotations, namely, the difference between a haze at a rotation number of 1000 and a haze before the Taber abrasion test is 10 or less is adapted to the standards of automobile windows and can be suitably used in an automobile window material and any material where such a difference is 2 or less is adapted to the standards of ANSI/SAE Z.26.1, ECE R43 and JIS R3211/R3212 and can be suitably used in all automobile window materials. The amount of change in haze after 1000 rotations is preferably 10 or less, more preferably 6 or less, further preferably 2 or less. Examples of the method for adjusting the amount of change in haze in the range include, but not limited to the following, a method involving coating a substrate with a coating material composition which satisfies a predetermined relationship represented by expression (3) described below and is obtained by dispersing and dissolving a composition including the polymer particle (F) and a matrix raw material component (H′) described below, mixed, in a solvent, and subjecting the resultant to heat treatment, ultraviolet irradiation, infrared irradiation, and/or the like to thereby form a coating film.

### [Volume Fraction of Polymer Particle (F) in Hard Coating Layer (K)]

The volume fraction of the polymer particle (F) in the hard coating layer (K) in the present embodiment is preferably 2% or more, more preferably 3% or more, further preferably 5% or more from the viewpoint of film formability, and is preferably 80% or less, more preferably 70% or less, further preferably 45% or less from the viewpoint of transparency. The volume fraction of the polymer particle (F) in the hard coating layer (K) can be calculated from, for example, the proportion of the polymer particle (F) in the entire coating film in a cross-sectional SEM image of the hard coating layer (K), and/or the component ratio of the polymer particle (F) to the components constituting the hard coating layer (K).

### [Structural Component of Polymer Particle (F)]

The polymer particle (F) preferably includes a hydrolyzable silicon compound (f). The hydrolyzable silicon compound (f) is not particularly limited as long as it is a silicon compound having hydrolyzability, or a hydrolyzed product or a condensate thereof.

The hydrolyzable silicon compound (f) is preferably any of a compound having an atomic group represented by the following formula (f-1) and a hydrolyzed product and a condensate thereof from the viewpoint of enhancements in abrasion resistance and weather resistance.

—R¹ₙ₁SiX¹₃₋ₙ₁ (f-1)

In the formula (f-1), R¹ represents a hydrogen atom, an alkyl group, an alkenyl group or an alkynyl group having 1 to 10 carbon atoms, or an aryl group, R¹ optionally has a substituent having halogen, a hydroxy group, a mercapto group, an amino group, a (meth)acryloyl group or an epoxy group, X¹ represents a hydrolyzable group, and n1 represents an integer of 0 to 2. The hydrolyzable group is not particularly limited as long as it is a group which generates a hydroxyl group by hydrolysis, and examples of such a group include halogen, an alkoxy group, an acyloxy group, an amino group, a phenoxy group, and an oxime group.

Specific examples of the compound having an atomic group represented by formula (f-1) include, but not limited to the following, trimethoxysilane, triethoxysilane, methyltrimethoxysilane, methyltriethoxysilane, ethyltrimethoxysilane, ethyltriethoxysilane, propyltrimethoxysilane, propyltriethoxysilane, isobutyltriethoxysilane, hexyltrimethoxysilane, hexyltriethoxysilane, octyltrimethoxysilane, octyltriethoxysilane, decyltrimethoxysilane, decyltriethoxysilane, cyclohexyltrimethoxysilane, cyclohexyltriethoxysilane, phenyltrimethoxysilane, phenyltriethoxysilane, dimethoxysilane, diethoxysilane, methyldimethoxysilane, methyldiethoxysilane, dimethyldimethoxysilane, dimethyldiethoxysilane, dimethoxydiphenylsilane, diethoxydiphenylsilane, bis(trimethoxysilyl)methane, bis(triethoxysilyl)methane, bis(triphenoxysilyl)ethane, 1,1-bis(triethoxysilyl)ethane, 1,2-bis(triethoxysilyl)ethane, 1,1-bis(triethoxysilyl)propane, 1,2-bis(triethoxysilyl)propane, 1,3-bis(triethoxysilyl)propane, 1,4-bis(triethoxysilyl)butane, 1,5-bis(triethoxysilyl)pentane, 1,1-bis(trimethoxysilyl)ethane, 1,2-bis(trimethoxysilyl)ethane, 1,1-bis(trimethoxysilyl)propane, 1,2-bis(trimethoxysilyl)propane, 1,3-bis(trimethoxysilyl)propane, 1,4-bis(trimethoxysilyl)butane, 1,5-bis(trimethoxysilyl)pentane, 1,3-bis(triphenoxysilyl)propane, 1,4-bis(trimethoxysilyl)benzene, 1,4-bis(triethoxysilyl)benzene, 1,6-bis(trimethoxysilyl)hexane, 1,6-bis(triethoxysilyl)hexane, 1,7-bis(trimethoxysilyl)heptane, 1,7-bis(triethoxysilyl)heptane, 1,8-bis(trimethoxysilyl)octane, 1,8-bis(triethoxysilyl)octane, 3-chloropropyltrimethoxysilane, 3-chiloropropyltriethoxysilane, trifluoropropyltrimethoxysilane, trifluoropropyltriethoxysilane, 3-hydroxypropyltrimethoxysilane, 3-hydroxypropyltriethoxysilane, 3-mercaptopropyltrimethoxysilane, 3-mercaptopropyltriethoxysilane, 3-mercaptopropylmethyldimethoxysilane, 3-mercaptopropylmethyldiethoxysilane, 3-glycidoxypropyltrimethoxysilane, 3-glycidoxypropyltriethoxysilane, 3-glycidoxypropylmethyldimethoxysilane, 3-glycidoxypropylmethyldiethoxysilane, 2-(3,4-epoxycyclohexyl)ethyltrimethoxysilane, 2-(3,4-epoxycyclohexyl)ethyltriethoxysilane, 3-acryloxypropyltrimethoxysilane, 3-acryloxypropyltriethoxysilane, 3-methacryloxypropyltrimethoxysilane, 3-methacryloxypropyltriethoxysilane, 3-methacryloxypropylmethyldimethoxysilane, 3-methacryloxypropylmethyldimethoxysilane, vinyltrimethoxysilane, vinyltriethoxysilane, p-styryltrimethoxysilane, p-styryltriethoxysilane, N-2-(aminoethyl)-3-aminopropylmethyldimethoxysilane, N-2-(aminoethyl)-3-aminopropylmethyldiethoxysilane, N-2-(aminoethyl)-3-aminopropyltrimethoxysilane, N-2-(aminoethyl)-3-aminopropyltriethoxysilane, 3-aminopropyltrimethoxysilane, 3-aminopropyltriethoxysilane, N-phenyl-3-aminopropyltrimethoxysilane, N-phenyl-3-aminopropyltriethoxysilane, 3-trimethoxysilyl-N-(1,3-dimethyl-butylidene)propylamine, 3-triethoxysilyl-N-(1,3-dimethyl-butylidene)propylamine, triacetoxysilane, tris(trichloroacetoxy)silane, tris(trifluoroacetoxy)silane, tris-(trimethoxysilylpropyl)isocyanurate, tris-(triethoxysilylpropyl)isocyanurate, methyltriacetoxysilane, methyltris(trichloroacetoxy)silane, trichlorosilane, tribromosilane, methyltrifluorosilane, tris(methylethylketoxime)silane, phenyltris(methylethylketoxime)silane, bis(methylethylketoxime)silane, methylbis(methylethylketoxime)silane, hexamethyldisilane, hexamethylcyclotrisilazane, bis(dimethylamino)dimethylsilane, bis(diethylamino)dimethylsilane, bis(dimethylamino)methylsilane, bis(diethylamino)methylsilane, 2-[(triethoxysilyl)propyl]dibenzylresorcinol, 2-[(trimethoxysilyl)propyl]dibenzylresorcinol, 2,2,6,6-tetramethyl-4-[3-(triethoxysilyl)propoxy]piperidine, 2,2,6,6-tetramethyl-4-[3-(trimethoxysilyl)propoxy]piperidine, 2-hydroxy-4-[3-(triethoxysilyl)propoxy]benzophenone and 2-hydroxy-4-[3-(trimethoxysilyl)propoxy]benzophenone.

The hydrolyzable silicon compound (f) preferably includes a compound represented by the following formula (f-2), a hydrolyzed product and a condensate thereof, from the viewpoints of being capable of imparting high hardness to the hard coating layer (K) and of more enhancing abrasion resistance.

SiX²₄ (f-2)

In the formula (f-2), X² represents a hydrolyzable group. The hydrolyzable group is not particularly limited as long as it is a group which generates a hydroxyl group by hydrolysis, and examples thereof include halogen, an alkoxy group, an acyloxy group, an amino group, a phenoxy group and an oxime group.

Specific examples of the compound represented by the formula (f-2) include, but not limited to the following, partially hydrolyzed condensates (for example, trade names “M Silicate 51”, “Silicate 35”, “Silicate 45”, “Silicate 40” and “FR-3” manufactured by Tama Chemicals Co., Ltd.; trade names “MS51”, “MS56”, “MS57” and “MS56S” manufactured by Mitsubishi Chemical Corporation; and trade names “Methyl Silicate 51”, “Methyl Silicate 53A”, “Ethyl Silicate 40”, “Ethyl Silicate 48”, “EMS-485”, “N-103X”, “PX”, “PS-169”, “PS-162R”, “PC-291”, “PC-301”, “PC-302R”, “PC-309” and “EMSi48” manufactured by Colcoat Co., Ltd.) of tetramethoxysilane, tetraethoxysilane, tetra(n-propoxy)silane, tetra(i-propoxy)silane, tetra(n-butoxy)silane, tetra(i-butoxy)silane, tetra-sec-butoxysilane, tetra-tert-butoxysilane, tetraacetoxysilane, tetra(trichloroacetoxy)silane, tetra(trifluoroacetoxy)silane, tetrachlorosilane, tetrabromosilane, tetrafluorosilane, tetra(methylethylketoxime)silane, tetramethoxysilane or tetraethoxysilane.

As described above, the hydrolyzable silicon compound (f) in the present embodiment preferably includes at least one or more selected from the group consisting of the compound having an atomic group represented by the formula (f-1) and the hydrolyzed product and the condensate thereof, and the compound represented by the formula (f-2) and the hydrolyzed product and the condensate thereof.

### [Content of Hydrolyzable Silicon Compound (f) in Polymer Particle (F)]

The content of the hydrolyzable silicon compound (f) in the present embodiment represents the weight proportion of the solid content of the hydrolyzable silicon compound (f) included in the polymer particle (F). The content is more preferably higher because a higher content allows for more enhancements in abrasion resistance, weather resistance and heat resistance. The content of the hydrolyzable silicon compound (f) is preferably 50% by mass or more, more preferably 60% by mass or more, The content of the hydrolyzable silicon compound (f) in the polymer particle (F) can be measured according to, but not limited to the following, for example, IR analysis, NMR analysis, and/or elemental analysis of the polymer particle (F).

[Functional Group (f-3)]

The polymer particle (F) preferably has a functional group (f-3) which interacts with the matrix component (H), from the viewpoint that dispersibility of the polymer particle (F) in the matrix component (H) can be enhanced to result in an enhancement in abrasion resistance. Whether or not the polymer particle (F) has such a functional group (f-3) can be confirmed by, for example, compositional analysis with IR, GC-MS, pyrolysis GC-MS, LC-MS, GPC, MALDI-MS, TOF-SIMS, TG-DTA and/or NMR, or analysis with a combination thereof.

Specific examples of the functional group (f-3) in the present embodiment include, but not limited to the following, functional groups such as a hydroxyl group, a carboxyl group, an amino group, an amide group and a functional group having an ether bond, a functional group having a hydrogen bond is preferable from the viewpoint of interaction, and an amide group is more preferable and a secondary amide group and/or a tertiary amide group are/is further preferable from the viewpoint of high hydrogen bondability.

The compound having the functional group (f-3) and a reaction product thereof are not particularly limited, and examples thereof include 2-hydroxyethyl (meth)acrylate, 2-hydroxypropyl (meth)acrylate, 4-hydroxybutyl (meth)acrylate, 2-hydroxyethyl vinyl ether or 4-hydroxybutyl vinyl ether, 2-hydroxyethyl allyl ether, (meth)acrylic acid, 2-carboxyethyl (meth)acrylate, 2-dimethylaminoethyl (meth)acrylate, 2-diethylaminoethyl (meth)acrylate, 2-di-n-propylaminoethyl (meth)acrylate, 3-dimethylaminopropyl (meth)acrylate, 4-dimethylaminobutyl (meth)acrylate, N-[2-(meth)acryloyloxy]ethylmorpholine, vinylpyridine, N-vinylcarbazole, N-vinylquinoline, N-methylacrylamide, N-methylmethacrylamide, N-ethylacrylamide, N,N-dimethylacrylamide, N,N-dimethylmethacrylamide, N,N-diethylacrylamide, N-ethylmethacrylamide, N-methyl-N-ethylacrylamide, N-methyl-N-ethylmethacrylamide, N-isopropylacrylamide, N-n-propylacrylamide, N-isopropylmethacrylamide, N-n-propylmethacrylamide, N-methyl-N-n-propylacrylamide, N-methyl-N-isopropylacrylamide, N-acryloylpyrrolidine, N-methacryloylpyrrolidine, N-acryloylpiperidine, N-methacryloylpiperidine, N-acryloylhexahydroazepine, N-acryloylmorpholine, N-methacryloylmorpholine, N-vinylpyrrolidone, N-vinylcaprolactam, N,N′-methylenebisacrylamide, N,N′-methylenebismethacrylamide, N-vinylacetamide, diacetone acrylamide, diacetone methacrylamide, N-methylolacrylamide, N-methylolmethacrylamide, Blemmers PE-90, PE-200, PE-350, PME-100, PME-200, PME-400 and AE-350 (trade names, manufactured by NOF Corporation), and MA-30, MA-50, MA-100, MA-150, RA-1120, RA-2614, RMA-564, RMA-568, RMA-1114 and MPG130-MA (trade names, manufactured by Nippon Nyukazai Co., Ltd.). Herein, the “(meth)acrylate” simply represents acrylate or methacrylate, and the “(meth)acrylic acid” simply represents acrylic acid or methacrylic acid.

### [Core/Shell Structure of Polymer Particle (F)]

The polymer particle (F) preferably has a core/shell structure including a core layer and one or more shell layers covering the core layer. The polymer particle (F) preferably has the functional group (f-3) from the viewpoint of interaction with the matrix component (H) on the outermost layer of the core/shell structure.

### [Other Compound Optionally Included in Polymer Particle (F)]

The polymer particle (F) optionally includes any polymer shown below from the viewpoint of an enhancement in stability of the particle due to electrostatic repulsion force of the particles. The polymer is not particularly limited, and examples thereof include a polyurethane-based, polyester-based, poly(meth)acrylate-based, poly(meth)acrylic acid, polyvinyl acetate-based, polybutadiene-based, polyvinyl chloride-based, chlorinated polypropylene-based, polyethylene-based or polystyrene-based polymer, or a poly(meth)acrylate-silicone-based, polystyrene-(meth)acrylate-based or styrene-maleic anhydride-based copolymer.

Examples of a compound particularly excellent in electrostatic repulsion, among the above polymers each optionally included in the polymer particle (F), include a (meth)acrylic acid or (meth)acrylate polymer or copolymer. Specific examples include, but not limited to the following, methyl acrylate, (meth)acrylic acid, methyl methacrylate, butyl methacrylate, cyclohexyl methacrylate, 2-ethylhexyl acrylate, n-butyl acrylate, 2-hydroxyethyl (meth)acrylate, 2-hydroxypropyl (meth)acrylate, 3-hydroxybutyl (meth)acrylate, 4-hydroxybutyl (meth)acrylate, 3-hydroxybutyl (meth)acrylate or 4-hydroxybutyl (meth)acrylate polymer or copolymer. Such (meth)acrylic acids may be each partially or fully neutralized with ammonia, an amine such as triethylamine or dimethylethanolamine, or a base such as NaOH or KOH, for a further enhancement in electrostatic repulsion force.

The polymer particle (F) optionally includes an emulsifier. The emulsifier is not particularly limited, and examples thereof include acidic emulsifiers such as alkylbenzene sulfonic acid, alkylsulfonic acid, alkylsulfosuccinic acid, polyoxyethylene alkyl sulfuric acid, polyoxyethylene alkyl aryl sulfuric acid and polyoxyethylene distyryl phenyl ether sulfonic acid; anionic surfactants such as alkali metal (Li, Na, K, and the like) salts of such acidic emulsifiers, ammonium salts of such acidic emulsifier, and fatty acid soap; quaternary ammonium salt, pyridinium salt, and imidazolinium salt type cationic surfactants such as alkyltrimethylammonium bromide, alkylpyridinium bromide and imidazolinium laurate; and nonionic surfactants and reactive emulsifiers having a radical polymerizable double bond, such as polyoxyethylene alkyl aryl ether, polyoxyethylene sorbitan fatty acid ester, a polyoxyethylene oxypropylene block copolymer and polyoxyethylene distyryl phenyl ether.

Examples of the reactive emulsifier having a radical polymerizable double bond include, but not limited to the following, Eleminol JS-2 (trade name, manufactured by Sanyo Chemical Industries, Ltd.), Latemul S-120, S-180A or S-180 (trade name, manufactured by Kao Corporation), Aqualon HS-10, KH-1025, RN-10, RN-20, RN30 or RN50 (trade name, manufactured by DKS Co., Ltd.), Adekariasoap SE1025, SR-1025, NE-20, NE-30 or NE-40 (trade name, manufactured by Adeka Corporation), an ammonium salt of p-styrene sulfonic acid, a sodium salt of p-styrene sulfonic acid, a potassium salt of p-styrene sulfonic acid, alkyl sulfonic acid (meth)acrylate such as 2-sulfoethyl acrylate, methylpropanesulfonic acid (meth)acrylamide, an ammonium salt of allyl sulfonic acid, a sodium salt of allyl sulfonic acid, or a potassium salt of allyl sulfonic acid.

### [Matrix Component (H)]

The matrix component (H) in the present embodiment can be used to thereby impart impact absorption to the hard coating layer (K) and decrease the amount of change in haze of the hard coating layer (K) in the Taber abrasion test. The hardness HMH of the matrix component (H) can be controlled in the above range by the structure and the compositional ratio of the structural component of a matrix raw material component (H′) described below, but the control is not limited thereto.

### [Structural Component of Matrix Component (H)]

The matrix component (H) is not particularly limited as long as it is any component in which the polymer particle (F) can be dispersed. The matrix component (H) in the present embodiment preferably includes a hydrolyzable silicon compound (h) from the viewpoint of high toughness. The “matrix component (H) including a hydrolyzable silicon compound (h)” herein means that the matrix component (H) includes a polymer having a structural unit derived from the hydrolyzable silicon compound (h). The hydrolyzable silicon compound (h) is not particularly limited as long as it is any of a silicon compound having hydrolyzability, and a hydrolyzed product and a condensate thereof.

The matrix component (H) may include various components except for the polymer particle (F), other than the above polymer. Such a component which can be included other than the above polymer is not particularly limited, and examples thereof include water-soluble resins such as polyvinyl alcohol, polyethylene glycol, polyvinylpyrrolidone and polyacrylic acid; acrylic resins such as PMMA, PAN and polyacrylamide; polymers such as polystyrene, polyurethane, polyamide, polyimide, polyvinylidene chloride, polyester, polycarbonate, polyether, polyethylene, polysulfone, polypropylene, polybutadiene, PTFE, PVDF and EVA; and copolymers thereof.

[Hydrolyzable Silicon Compound (h)]

The hydrolyzable silicon compound (h) preferably includes one or more selected from the group consisting of a compound having an atomic group represented by the following formula (h-1) and a hydrolyzed product and a condensate thereof, and a compound represented by the following formula (h-2) and a hydrolyzed product and a condensate thereof, from the viewpoints of further enhancements in abrasion resistance and weather resistance of the laminate described below.

—R²ₙ₂SiX³₃₋ₙ₂ (h-1)

In the formula (h-1), R² represents a hydrogen atom, an alkyl group, an alkenyl group or an alkynyl group having 1 to 10 carbon atoms, or an aryl group, R² optionally has a substituent having halogen, a hydroxy group, a mercapto group, an amino group, a (meth)acryloyl group or an epoxy group, X³ represents a hydrolyzable group, and n2 represents an integer of 0 to 2. The hydrolyzable group is not particularly limited as long as it is a group which generates a hydroxyl group by hydrolysis, and examples of such a group include a halogen atom, an alkoxy group, an acyloxy group, an amino group, a phenoxy group and an oxime group.

SiX⁴₄ (h-2)

In the formula (h-2), X⁴ represents a hydrolyzable group. The hydrolyzable group is not particularly limited as long as it is a group which generates a hydroxyl group by hydrolysis, and examples of such a group include halogen, an alkoxy group, an acyloxy group, an amino group, a phenoxy group and an oxime group.

### [Content of Hydrolyzable Silicon Compound (h) in Hard Coating Layer (K)]

The content of the hydrolyzable silicon compound (h) in the hard coating layer (K) is preferably 30 to 80% by mass, more preferably 40 to 70% by mass, further preferably 50 to 70% by mass.

Specific examples of the compound having an atomic group represented by such general formula (h-1) include, but not limited to the following, trimethoxysilane, triethoxysilane, methyltrimethoxysilane, methyltriethoxysilane, ethyltrimethoxysilane, ethyltriethoxysilane, propyltrimethoxysilane, propyltriethoxysilane, isobutyltriethoxysilane, hexyltrimethoxysilane, hexyltriethoxysilane, octyltrimethoxysilane, octyltriethoxysilane, decyltrimethoxysilane, decyltriethoxysilane, cyclohexyltrimethoxysilane, cyclohexyltriethoxysilane, phenyltrimethoxysilane, phenyltriethoxysilane, dimethoxysilane, diethoxysilane, methyldimethoxysilane, methyldiethoxysilane, dimethyldimethoxysilane, dimethyldiethoxysilane, dimethoxydiphenylsilane, diethoxydiphenylsilane, bis(trimethoxysilyl)methane, bis(triethoxysilyl)methane, bis(triphenoxysilyl)ethane, 1,1-bis(triethoxysilyl)ethane, 1,2-bis(triethoxysilyl)ethane, 1,1-bis(triethoxysilyl)propane, 1,2-bis(triethoxysilyl)propane, 1,3-bis(triethoxysilyl)propane, 1,4-bis(triethoxysilyl)butane, 1,5-bis(triethoxysilyl)pentane, 1,1-bis(trimethoxysilyl)ethane, 1,2-bis(trimethoxysilyl)ethane, 1,1-bis(trimethoxysilyl)propane, 1,2-bis(trimethoxysilyl)propane, 1,3-bis(trimethoxysilyl)propane, 1,4-bis(trimethoxysilyl)butane, 1,5-bis(trimethoxysilyl)pentane, 1,3-bis(triphenoxysilyl)propane, 1,4-bis(trimethoxysilyl)benzene, 1,4-bis(triethoxysilyl)benzene, 1,6-bis(trimethoxysilyl)hexane, 1,6-bis(triethoxysilyl)hexane, 1,7-bis(trimethoxysilyl)heptane, 1,7-bis(triethoxysilyl)heptane, 1,8-bis(trimethoxysilyl)octane, 1,8-bis(triethoxysilyl)octane, 3-chloropropyltrimethoxysilane, 3-chiloropropyltriethoxysilane, trifluoropropyltrimethoxysilane, trifluoropropyltriethoxysilane, 3-hydroxypropyltrimethoxysilane, 3-hydroxypropyltriethoxysilane, 3-mercaptopropyltrimethoxysilane, 3-mercaptopropyltriethoxysilane, 3-mercaptopropylmethyldimethoxysilane, 3-mercaptopropylmethyldiethoxysilane, 3-glycidoxypropyltrimethoxysilane, 3-glycidoxypropyltriethoxysilane, 3-glycidoxypropylmethyldimethoxysilane, 3-glycidoxypropylmethyldiethoxysilane, 2-(3,4-epoxycyclohexyl)ethyltrimethoxysilane, 2-(3,4-epoxycyclohexyl)ethyltriethoxysilane, 3-acryloxypropyltrimethoxysilane, 3-acryloxypropyltriethoxysilane, 3-methacryloxypropyltrimethoxysilane, 3-methacryloxypropyltriethoxysilane, 3-methacryloxypropylmethyldimethoxysilane, 3-methacryloxypropylmethyldimethoxysilane, vinyltrimethoxysilane, vinyltriethoxysilane, p-styryltrimethoxysilane, p-styryltriethoxysilane, N-2-(aminoethyl)-3-aminopropylmethyldimethoxysilane, N-2-(aminoethyl)-3-aminopropylmethyldiethoxysilane, N-2-(aminoethyl)-3-aminopropyltrimethoxysilane, N-2-(aminoethyl)-3-aminopropyltriethoxysilane, 3-aminopropyltrimethoxysilane, 3-aminopropyltriethoxysilane, N-phenyl-3-aminopropyltrimethoxysilane, N-phenyl-3-aminopropyltriethoxysilane, 3-trimethoxysilyl-N-(1,3-dimethyl-butylidene)propylamine, 3-triethoxysilyl-N-(1,3-dimethyl-butylidene)propylamine, triacetoxysilane, tris(trichloroacetoxy)silane, tris(trifluoroacetoxy)silane, tris-(trimethoxysilylpropyl)isocyanurate, tris-(triethoxysilylpropyl) isocyanurate, methyltriacetoxysilane, methyltris(trichloroacetoxy)silane, trichlorosilane, tribromosilane, methyltrifluorosilane, tris(methylethylketoxime)silane, phenyltris(methylethylketoxime)silane, bis(methylethylketoxime)silane, methylbis(methylethylketoxime)silane, hexamethyldisilane, hexamethylcyclotrisilazane, bis(dimethylamino)dimethylsilane, bis(diethylamino)dimethylsilane, bis(dimethylamino)methylsilane, bis(diethylamino)methylsilane, 2-[(triethoxysilyl)propyl]dibenzylresorcinol, 2-[(trimethoxysilyl)propyl]dibenzylresorcinol, 2,2,6,6-tetramethyl-4-[3-(triethoxysilyl)propoxy]piperidine, 2,2,6,6-tetramethyl-4-[3-(trimethoxysilyl)propoxy]piperidine, 2-hydroxy-4-[3-(triethoxysilyl)propoxy]benzophenone and 2-hydroxy-4-[3-(trimethoxysilyl)propoxy]benzophenone.

Specific examples of the compound represented by the formula (h-2) include, but not limited to the following, partially hydrolyzed condensates (for example, trade names “M Silicate 51”, “Silicate 35”, “Silicate 45”, “Silicate 40” and “FR-3” manufactured by Tama Chemicals Co., Ltd.; trade names “MS51”, “MS56”, “MS57” and “MS56S” manufactured by Mitsubishi Chemical Corporation; and trade names “Methyl Silicate 51”, “Methyl Silicate 53A”, “Ethyl Silicate 40”, “Ethyl Silicate 48”, “EMS-485”, “N-103X”, “PX”, “PS-169”, “PS-162R”, “PC-291”, “PC-301”, “PC-302R”, “PC-309” and “EMSi48” manufactured by Colcoat Co., Ltd.) of tetramethoxysilane, tetraethoxysilane, tetra(n-propoxy)silane, tetra(i-propoxy)silane, tetra(n-butoxy)silane, tetra(i-butoxy)silane, tetra-sec-butoxysilane, tetra-tert-butoxysilane, tetraacetoxysilane, tetra(trichloroacetoxy)silane, tetra(trifluoroacetoxy)silane, tetrachlorosilane, tetrabromosilane, tetrafluorosilane, tetra(methylethylketoxime)silane, tetramethoxysilane or tetraethoxysilane.

As described above, the hydrolyzable silicon compound (h) in the present embodiment preferably includes at least one or more selected from the group consisting of the compound having an atomic group represented by the formula (h-1) and the hydrolyzed product and the condensate thereof, and the compound represented by the formula (h-2) and the hydrolyzed product and the condensate thereof.

The “hydrolyzable silicon compound (f) included in the polymer particle (F)” in the present embodiment may be the same as or different from the “hydrolyzable silicon compound (h) included in the matrix component (H)”. Even if both compounds are the same, such compounds are distinguished from each other by defining the compound included in the polymer particle (F) as the hydrolyzable silicon compound (f) and defining the compound included in the matrix component (H) as the hydrolyzable silicon compound (h).

### [Inorganic Oxide (G)]

The matrix component (H) preferably includes an inorganic oxide (G). The inorganic oxide (G) is included to thereby tend to enhance hardness of the matrix component (H) and enhance abrasion resistance. The coating film also tends to be enhanced in contamination resistance due to hydrophilicity of a hydroxyl group on a particle surface of the inorganic oxide (G).

Specific examples of the inorganic oxide (G) include, but not limited to the following, respective oxides of silicon, aluminum, titanium, zirconium, zinc, cerium, tin, indium, gallium, germanium, antimony, molybdenum, niobium, magnesium, bismuth, cobalt, and copper. Such an oxide is not limited in terms of the shape thereof, and may be used singly or as a mixture. The inorganic oxide (G) preferably further includes a particle of silica typified by dry silica or colloidal silica from the viewpoint of interaction with the above hydrolyzable silicon compound (h), and preferably further includes colloidal silica in the form of a silica particle from the viewpoint of dispersibility. When the inorganic oxide (G) includes colloidal silica, it is preferably in the form of an aqueous dispersion liquid, and can be used even if is either acidic or basic.

The inorganic oxide (G) in the present embodiment preferably contains at least one inorganic component selected from the group consisting of Ce, Nb, Al, Zn, Ti, Zr, Sb, Mg, Sn, Bi, Co and Cu (hereinafter, also simply referred to as “inorganic component”.). The inorganic oxide (G) contains the inorganic component to result in a tendency to enhance weather resistance without any loss of abrasion resistance and durability. When a commercially available product is utilized, examples thereof include, but not limited to the following, ultrafine particle material products of cerium oxide, zinc oxide, aluminum oxide, bismuth oxide, cobalt oxide, copper oxide, tin oxide, and titanium oxide, manufactured by CIK-Nano Tek.; and titanium oxide “Tainoc” (trade name), cerium oxide “Needral” (trade name), tin oxide “Ceramace” (trade name), niobium oxide sol and zirconium oxide sol, manufactured by Taki Chemical Co., Ltd. The inorganic oxide (G) preferably contains at least one inorganic component selected from the group consisting of Ce, Nb, Zn, Ti and Zr, more preferably contains Ce, from the viewpoint of enhancement performance of weather resistance.

The inorganic oxide (G) preferably contains an inorganic oxide (G′) of at least one selected from the group consisting of Ce, Nb, Zn, Ti and Zr from the viewpoint of the balance among abrasion resistance, durability and weather resistance, and the content of the inorganic oxide (G′) in the hard coating film (hard coating layer (K)) is not particularly limited, and is preferably 1% by mass or more, more preferably 2% by mass or more from the viewpoint of the balance among abrasion resistance, durability and weather resistance. The content is preferably 50% by mass or less, more preferably 30% by mass or less from the viewpoint of transparency. The content can be here specified as the total amount of Ce, Nb, Zn, Ti and Zr under the assumption that the amount of the hard coating film (hard coating layer (K)) is 100% by mass.

### [Average Particle Size of Inorganic Oxide (G)]

The average particle size of the inorganic oxide (G) is preferably 2 nm or more from the viewpoint of an improvement in storage stability of a composition of the hard coating layer (K). The average particle size of the inorganic oxide (G) is preferably 150 nm or less, more preferably 100 nm or less, further preferably 50 nm or less from the viewpoint of an improvement in transparency of the entire laminate. Thus, the average particle size of the inorganic oxide (G) is preferably 2 nm or more and 100 nm or less, more preferably 2 nm or more and 50 nm or less. The method for measuring the average particle size of the inorganic oxide (G) can be made by, but not limited to the following, for example, observing colloidal silica dispersed in water at a magnification of 50,000 to 100,000× with a transmission micrograph, taking an image so that 100 to 200 inorganic oxides as particles are taken, and measuring a longer diameter and a shorter diameter of each of such inorganic oxide particles to thereby determine the average value.

[Colloidal Silica which can be Included in Inorganic Oxide (G)]

In the present embodiment, colloidal silica is suitably used as the inorganic oxide (G). The colloidal silica is preferably acidic colloidal silica for which water is used as a dispersing solvent. Such colloidal silica is not particularly limited, and any one prepared according to a sol-gel method can also be used and a commercially available product can also be utilized. Such preparation according to a sol-gel method can be made with reference to Werner Stober et al; J. Colloid and Interface Scf-26, 62-69 (1968), Rickey D. Badley et al; Lang muir 6, 792-801 (1990), Journal of the Japan Society of Colour Material, 61 [9] 488-493 (1988), and the like. Such a commercially available product utilized is not particularly limited, and examples thereof include Snowtex-O, Snowtex-OS, Snowtex-OXS, Snowtex-O-40, Snowtex-OL, Snowtex-OYL, Snowtex-OUP, Snowtex-PS-SO, Snowtex-PS-MO, Snowtex-AK-XS, Snowtex-AK, Snowtex-AK-L, Snowtex-AK-YL and Snowtex-AK-PS-S (trade names, manufactured by Nissan Chemical Corporation), Adelite AT-20Q (trade name, manufactured by Adeka Corporation), and Klebosol 20H12 and Klebosol 30CAL25 (trade names, manufactured by Clariant Japan K.K.).

The basic colloidal silica is not particularly limited, and examples thereof include silica stabilized by addition of an alkali metal ion, an ammonium ion or an amine. Specific examples thereof include, but not particularly limited to, Snowtex-20, Snowtex-30, Snowtex-XS, Snowtex-50, Snowtex-30L, Snowtex-XL, Snowtex-YL, Snowtex ZL, Snowtex-UP, Snowtex-ST-PS-S, Snowtex ST-PS-M, Snowtex-C, Snowtex-CXS, Snowtex-CM, Snowtex-N, Snowtex-NXS, Snowtex-NS and Snowtex-N-40 (trade names, manufactured by Nissan Chemical Corporation), Adelite AT-20, Adelite AT-30, Adelite AT-20N, Adelite AT-30N, Adelite AT-20A, Adelite AT-30A, Adelite AT-40 and Adelite AT-50 (trade names, manufactured by Adeka Corporation), Klebosol 30R9, Klebosol 30R50 and Klebosol 50R50 (trade names, manufactured by Clariant Japan K.K.), and Ludox HS-40, Ludox HS-30, Ludox LS, Ludox AS-30, Ludox SM-AS, Ludox AM, Ludox HAS and Ludox SM (trade names, manufactured by DuPont).

The colloidal silica for which a water-soluble solvent is used as a dispersing medium is not particularly limited, and examples thereof include MA-ST-M (methanol dispersion type having a particle size of 20 to 25 nm), IPA-ST (isopropyl alcohol dispersion type having a particle size of 10 to 15 nm), EG-ST (ethylene glycol dispersion type having a particle size of 10 to 15 nm), EGST-ZL (ethylene glycol dispersion type having a particle size of 70 to 100 nm), NPC-ST (ethylene glycol monopropyl ether dispersion type having a particle size of 10 to 15 nm) and TOL-ST (toluene dispersion type having a particle size of 10 to 15 nm), manufactured by Nissan Chemical Corporation.

The dry silica particle is not particularly limited, and examples thereof include AEROSIL manufactured by Nippon Aerosil Co., Ltd., and Reolosil manufactured by Tokuyama Corporation.

Such a silica particle may include an inorganic base (for example, sodium hydroxide, potassium hydroxide, lithium hydroxide, and/or ammonia) and/or an organic base (for example, tetramethylammonium and/or triethylamine) as stabilizer(s).

### [Shape of Inorganic Oxide (G)]

Examples of the shape of the inorganic oxide (G) include, but not limited to the following, spherical, horned, polyhedron, elliptical, flattened, linear, beaded, and chained shapes, and a spherical shape is particularly preferable from the viewpoints of hardness and transparency of the hard coating layer.

### [Other Component Optionally Included in Hard Coating Layer (K)]

The hard coating layer (K) optionally includes, but not particularly limited to, for example, a solvent, an emulsifier, a plasticizer, a pigment, a dye, a filler, an anti-aging agent, a conductive material, an ultraviolet absorber, a light stabilizer, a peel strength adjusting agent, a softener, a surfactant, a flame retardant, an antioxidant, and/or catalyst, as the matrix component (H), depending on the application. The hard coating layer (K) preferably includes an ultraviolet absorber and light stabilizer because high weather resistance is required particularly in an outdoor application.

Specific examples of the ultraviolet absorber and the light stabilizer include, but not limited to the following, benzophenone-based ultraviolet absorbers such as 2,4-dihydroxybenzophenone, 2-hydroxy-4-methoxybenzophenone, 2-hydroxy-4-methoxybenzophenone-5-sulfonic acid, 2-hydroxy-4-n-octoxybenzophenone, 2-hydroxy-4-n-dodecyloxybenzophenone, 2-hydroxy-4-benzyloxybenzophenone, bis(5-benzoyl-4-hydroxy-2-methoxyphenyl)methane, 2,2′-dihydroxy-4-methoxybenzophenone, 2,2′-dihydroxy-4,4′dimethoxybenzophenone (trade name “UVINUL3049” manufactured by BASF SE), 2,2′,4,4′-tetrahydroxybenzophenone (trade name “UVINUL3050” manufactured by BASF SE), 4-dodecyloxy-2-hydroxybenzophenone, 5-benzoyl-2,4-dihydroxybenzophenone, 2-hydroxy-4-methoxy-2′-carboxybenzophenone, 2-hydroxy-4-stearyloxybenzophenone and 4,6-dibenzoyl resorcinol; benzotriazole-based ultraviolet absorbers such as 2-(2′-hydroxy-5′-methylphenyl)benzotriazole, 2-(2′-hydroxy-5′-tert-butylphenyl)benzotriazole, 2-(2′-hydroxy-3′,5′-di-tert-butylphenyl)benzotriazole, 2-(2-hydroxy-5-tert-octylphenyl)benzotriazole, 2-(2-hydroxy-3,5-di-tert-octylphenyl)benzotriazole, 2-[2′-hydroxy-3′,5′-bis(α,α′-dimethylbenzyl)phenyl]benzotriazole), a condensate (trade name “TINUVIN1130” manufactured by BASF SE) of methyl-3-[3-tert-butyl-5-(2H-benzotriazol-2-yl)-4-hydroxyphenyl]propionate and polyethylene glycol (molecular weight: 300), isooctyl-3-[3-(2H-benzotriazol-2-yl)-5-tert-butyl-4-hydroxyphenyl]propionate (trade name “TINUVIN384” manufactured by BASF SE), 2-(3-dodecyl-5-methyl-2-hydroxyphenyl)benzotriazole (trade name “TINUVIN571” manufactured by BASF SE), 2-(2′-hydroxy-3′-tert-butyl-5′-methylphenyl)-5-chlorobenzotriazole, 2-(2′-hydroxy-3′,5′-di-tert-amylphenyl)benzotriazole, 2-(2′-hydroxy-4′-octoxyphenyl)benzotriazole, 2-[2′-hydroxy-3′-(3″,4″,5″,6″-tetrahydrophthalimidemethyl)-5′-methylphenyl]benzotriazole, 2,2-methylenebis[4-(1,1,3,3-tetramethylbutyl)-6-(2H-benzotriazol-2-yl)phenol], 2-(2H-benzotriazol-2-yl)-4,6-bis(1-methyl-1-phenylethyl)phenol (trade name “TINUVIN900” manufactured by BASF SE), and TINUVIN384-2, TINUVIN326, TINUVIN327, TINUVIN109, TINUVIN970, TINUVIN328, TINUVIN171, TINUVIN970, TINUVIN PS, TINUVIN P, TINUVIN99-2 and TINVIN928 (trade names, manufactured by BASF SE); triazine-based ultraviolet absorbers such as 2-[4-[(2-hydroxy-3-dodecyloxypropyl)oxy]-2-hydroxyphenyl]-4,6-bis(2,4-dimethylphenyl)-1,3,5-triazine, 2-[4-[(2-hydroxy-3-tridecyloxypropyl)oxy]-2-hydroxyphenyl]-4,6-bis(2,4-dimethylphenyl)-1,3,5-triazine, 2,4-bis (2-hydroxy-4-butyloxyphenyl)-6-(2,4-bisbutyloxyphenyl)-1,3,5-triazine (trade name “TINUVIN460” manufactured by BASF SE), 2-(2-hydroxy-4-[1-octyloxycarbonylethoxy]phenyl)-4,6-bis(4-phenylphenyl)-1,3,5-triazine (trade name “TINUVIN479” manufactured by BASF SE), and a mixture including 2-[4-[(2-hydroxy-3-dodecyloxypropyl)oxy]-2-hydroxyphenyl]-4,6-bis(2,4-dimethylphenyl)-1,3,5-triazine and 2-[4-[(2-hydroxy-3-tridecyloxypropyl)oxy]-2-hydroxyphenyl]-4,6-bis(2,4-dimethylphenyl)-1,3,5-triazine (trade name “TINUVIN400” manufactured by BASF SE), TINUVIN405, TINUVIN477 and TINUVIN1600 (trade names, manufactured by BASF SE); malonic acid ester-based ultraviolet absorbers such as HOSTAVIN PR25, HOSTAVIN B-CAP and HOSTAVIN VSU (trade names, manufactured by Clariant Japan K.K.); anilide-based ultraviolet absorbers such as HOSTAVIN 3206 LIQ, HOSTAVIN VSU P and HOSTAVIN 3212 LIQ (trade names, manufactured by Clariant Japan K.K.); salicylate-based ultraviolet absorbers such as amyl salicylate, menthyl salicylate, homomenthyl salicylate, octyl salicylate, phenyl salicylate, benzyl salicylate and p-isopropanolphenyl salicylate; cyanoacrylate-based ultraviolet absorbers such as ethyl-2-cyano-3,3-diphenyl acrylate (trade name “UVINUL3035” manufactured by BASF SE), (2-ethylhexyl)-2-cyano-3,3-diphenyl acrylate (trade name “UVINUL3039” manufactured by BASF SE and 1,3-bis((2′-cyano-3′,3′-diphenylacryloyl)oxy)-2,2-bis-(((2′-cyano-3′,3′-diphenylacryloyl)oxy)methyl)propane (trade name “UVINUL3030 manufactured by BASF SE); radical polymerizable ultraviolet absorbers each having a radical polymerizable double bond in its molecule, such as 2-hydroxy-4-acryloxybenzophenone, 2-hydroxy-4-methacryloxybenzophenone, 2-hydroxy-5-acryloxybenzophenone, 2-hydroxy-5-methacryloxybenzophenone, 2-hydroxy-4-(acryloxy-ethoxy)benzophenone, 2-hydroxy-4-(methacryloxy-ethoxy)benzophenone, 2-hydroxy-4-(methacryloxy-diethoxy)benzophenone, 2-hydroxy-4-(acryloxy-triethoxy)benzophenone, 2-(2′-hydroxy-5′-methacryloxyethylphenyl)-2H-benzotriazole (trade name “RUVA-93” manufactured by Otsuka Chemical Co., Ltd.), 2-(2′-hydroxy-5′-methacryloxyethyl-3-tert-butylphenyl)-2H-benzotriazole, 2-(2′-hydroxy-5′-methacryloxypropyl-3-tert-butylphenyl)-5-chloro-2H-benzotriazole and 3-methacryloyl-2-hydroxypropyl-3-[3′-(2″-benzotriazolyl)-4-hydroxy-5-tert-butyl]phenylpropionate (trade name “CGL-104” manufactured by Ciba-Geigy Japan Ltd.); polymers each having ultraviolet absorptivity, such as UV-G101, UV-G301, UV-G137, UV-G12 and UV-G13 (trade names, manufactured by Nippon Shokubai Co., Ltd.); hindered amine-based light stabilizers such as bis(2,2,6,6-tetramethyl-4-piperidyl)succinate, bis(2,2,6,6-tetramethylpiperidyl)sebacate, bis (1,2,2,6,6-pentamethyl-4-piperidyl)2-(3,5-di-tert-butyl-4-hydroxybenzyl)-2-butylmalonate, 1-[2-[3-(3,5-di-tert-butyl-4-hydroxyphenyl)propinyloxy]ethyl]-4-[3-(3,5-di-tert-butyl-4-hydroxyphenyl)propinyloxy]-2,2,6,6-tetramethylpiperidine, a mixture (trade name “TINUVIN292” manufactured by BASF SE) of bis(1,2,2,6,6-pentamethyl-4-piperidyl)sebacate and methyl-1,2,2,6,6-pentamethyl-4-piperidyl-sebacate, bis(1-octoxy-2,2,6,6-tetramethyl-4-piperidyl)sebacate, and TINUVIN123, TINUVIN144, TINUVIN152, TINUVIN249, TINUVIN292 and TINUVIN5100 (trade names, manufactured by BASF SE); radical polymerizable hindered amine-based light stabilizers such as 1,2,2,6,6-pentamethyl-4-piperidyl methacrylate, 1,2,2,6,6-pentamethyl-4-piperidyl acrylate, 2,2,6,6-tetramethyl-4-piperidyl methacrylate, 2,2,6,6-tetramethyl-4-piperidyl acrylate, 1,2,2,6,6-pentamethyl-4-iminopiperidyl methacrylate, 2,2,6,6,-tetramethyl-4-iminopiperidyl methacrylate, 4-cyano-2,2,6,6-tetramethyl-4-piperidyl methacrylate and 4-cyano-1,2,2,6,6-pentamethyl-4-piperidyl methacrylate; polymers each having photostability, such as U-Double E-133, U-Double E-135, U-Double S-2000, U-Double S-2834, U-Double S-2840, U-Double S-2818 and U-Double S-2860 (trade names, manufactured by Nippon Shokubai Co., Ltd.); and ultraviolet absorbers each having reactivity with a silanol group, an isocyanate group, an epoxy group, a semicarbazide group or a hydrazide group; and inorganic ultraviolet absorbers such as cerium oxide, zinc oxide, aluminum oxide, zirconium oxide, niobium oxide, bismuth oxide, cobalt oxide, copper oxide, tin oxide and titanium oxide, and these may be used singly or in combinations of two or more thereof.

### [Method for Producing Hard Coating Layer (K)]

The method for producing the hard coating layer (K) is not particularly limited, and examples thereof can include a method involving coating the substrate with a coating material composition (L) described below, and subjecting the resultant to, for example, a heat treatment, ultraviolet irradiation, and/or infrared irradiation to thereby form a coating film. Examples of the coating method include, but not limited to the following, a spraying method, a flow coating method, a brush coating method, a dip coating method, a spin coating method, a screen printing method, a casting method, a gravure printing method, and a flexographic printing method. The coating material composition (L) subjected to coating can be preferably formed into a coating film by, for example, a heat treatment at room temperature to 250° C., more preferably 40° C. to 150° C., and/or ultraviolet or infrared irradiation. This coating can be applied for not only coating a substrate already formed, but also coating a flat plate in advance before forming and processing, like a pre-coating metal including a rust-resistant steel plate.

### [Surface Treatment of Hard Coating Layer (K)]

The hard coating layer (K) may be subjected to surface treatment with silica and thus provided with a silica layer formed thereon from the viewpoint of weather resistance. The method for forming the silica layer is not particularly limited, and specific examples thereof include a silica treatment with PECVD for depositing/curing silicone or silazane and a silica treatment technique for modifying a surface by silica due to irradiation with ultraviolet light at 155 nm. In particular, such a silica treatment with PECVD is preferable because a layer through which oxygen and steam are unlikely to penetrate can be produced without degradation of any surface. Specific examples of such silicone or silazane which can be used in PECVD include, but not limited to the following, octamethylcyclotetrasiloxane, tetramethylcyclotetrasiloxane, decamethylcyclopentasiloxane, hexamethyldisiloxane, vinylmethoxysilane, vinylmethoxysilane, dimethyldimethoxysilane, TEOS, tetramethyldisiloxane, tetramethyltetravinylcyclotetrasiloxane and hexamethyldisilazane, and these may be used singly or in combinations of two or more thereof.

The hard coating layer (K) in the present embodiment may be further provided with a functional layer on at least one surface thereof. Examples of the functional layer include, but not limited to the following, an antireflective layer, an antifouling layer, a polarizing layer, and an impact-absorbing layer.

### [Coating Material Composition (L)]

The hard coating layer (K) of the present embodiment is preferably obtained by using, for example, the following coating material composition (L). The coating material composition (L) is preferably a coating material composition including an inorganic oxide (G), a polymer particle (F), and a matrix raw material component (H′), in which the elastic recovery rate η_{ITG} of the polymer particle (F), as measured by an indentation test according to ISO14577-1, is 0.30 or more and 0.90 or less, and the Martens hardness HMF of the polymer particle (F) and the Martens hardness HMH′ of the matrix raw material component (H′) satisfy a relationship of HMH′/HMF>1.

The detail of each component included in the coating material composition (L), not mentioned below, is as described above with respect to each component included in the hard coating layer (K).

### [Hardness HMG of Polymer Particle (F) and Hardness HMH′ of Matrix Raw Material Component (H′)]

The Martens hardness HMF of the polymer particle (F) and the Martens hardness HMH′ of the matrix raw material component (H′) in the coating material composition (L) preferably satisfy a relationship of the following expression (3).

$${HMH}^{′} / HMF > 1 \qquad expression ( 3 )$$

When the relationship is satisfied in the coating material composition (L) as described above, the relationship of the expression (3) is satisfied also by the Martens hardness HMF of the polymer particle (F) and the Martens hardness HMH′ of the matrix raw material component (H′) in the hard coating layer (K) obtained with the coating material composition (L). Such each Martens hardness with respect to the coating material composition (L) can be measured by, for example, separating the polymer particle (F) and the matrix raw material component (H′) by an operation such as centrifugation and/or ultrafiltration, and subjecting each component separated, to measurement based on a method described in Examples below.

The respective values of the HMF and HMH′ can be adjusted by, for example, the structures of and the compositional ratio between the respective structural components of the polymer particle (F) and the matrix raw material component (H′) so as to satisfy the above magnitude relationship, but the adjustment is not limited thereto.

### [Elastic Recovery Rate η_{ITF} of Polymer Particle (F)]

The elastic recovery rate η_{ITF} of the polymer particle (F) is obtained by measuring the parameter described as the ratio η_{IT} of Wₑₗₐₛₜ/Wₜₒₜₐₗ in ISO14577-1 with respect to a coating film formed of the polymer particle (F), and is represented as the ratio of the elastic return deformation workload Wₑₗₐₛₜ of a depression to the total mechanical workload Wₜₒₜₐₗ of a depression. As the elastic recovery rate η_{ITF} is higher, the coating film can be more returned to the original state when is subject to impact, and is higher in ability to repair itself against impact. The elastic recovery rate η_{ITF} of the polymer particle (F) is preferably 0.30 or more under measurement conditions (Vickers quadrangular pyramid diamond indenter, loading condition: 2 mN/20 sec, unloading condition: 2 mN/20 sec) from the viewpoint that the ability to repair itself is effectively expressed, and the η_{ITF} is preferably 0.90 or less from the viewpoint of being able to conform to deformation of the substrate and/or the matrix raw material component (H′) in formation of the coating film. The elastic recovery rate η_{ITF} of the polymer particle (F) is more preferably 0.50 or more, further preferably 0.60 or more. The elastic recovery rate of the polymer particle (F) can be measured by, but not limited to the following, for example, separating the polymer particle (F) and the matrix raw material component (H′) by an operation such as centrifugation and/or ultrafiltration, dispersing the polymer particle (F) separated, in a solvent, to provide a composition, performing coating with the composition and drying to form a coating film, and subjecting the coating film to measurement with, for example, a micro-hardness meter Fischer scope (HM2000S manufactured by Fischer Instruments K.K.), a nano indentation tester (ENT-NEXUS manufactured by Elionix Inc.), a nano indenter (iNano, G200 manufactured by Toyo Corporation), and/or a nano indentation system (TI980 manufactured by Bruker AXS GmbH). Examples of the method for adjusting the elastic recovery rate η_{ITF} in the range include, but not limited to the following, adjustment of the structure and the compositional ratio of the structural component of the polymer particle (F).

The hard coating layer (K) can be obtained, for example, as a cured product formed by curing a coating material composition (L) with hydrolytic condensation or the like. The polymer particle (F) is usually not changed in composition in the course of such curing. Accordingly, the value of the elastic recovery rate η_{ITF} in the hard coating layer (K) can be determined under the assumption that the value of the elastic recovery rate η_{ITF} of the polymer particle (F) in the coating material composition (L), as measured by a method described in Examples below, is well matched to the elastic recovery rate η_{ITF} of the polymer particle (F) in the hard coating layer (K).

[Elastic Recovery Rate η_{ITH′} of Matrix Raw Material Component (H′) and Elastic Recovery Rate η_{ITH} of Matrix Component (H)]

The elastic recovery rate η_{ITH′} of the matrix raw material component (H′) in the coating material composition (L) is the parameter described as the “ratio η_{IT} of Wₑₗₐₛₜ/Wₜₒₜₐₗ” in ISO14577-1, is measured with respect to a coating film formed of the matrix raw material component (H′), and is represented as the ratio of the elastic return deformation workload Wₑₗₐₛₜ of a depression to the total mechanical workload Wₜₒₜₐₗ of a depression. As the elastic recovery rate η_{ITH′} is higher, the coating film can be more returned to the original state when is subject to impact, and is higher in ability to repair itself against impact. The elastic recovery rate η_{ITH′} of the matrix raw material component (H′) is preferably 0.60 or more, more preferably 0.65 or more under measurement conditions (Vickers quadrangular pyramid diamond indenter, loading condition: 2 mN/20 sec, unloading condition: 2 mN/20 sec) from the viewpoint that the ability to repair itself is effectively expressed. The η_{ITH′} is preferably 0.95 or less from the viewpoint of being able to conform to deformation of the substrate and/or the component (G) in formation of the coating film. The elastic recovery rate of the matrix raw material component (G′) can be measured by, but not limited to the following, for example, separating the polymer particle (F) and the matrix raw material component (H′) by an operation such as centrifugation, dissolving the matrix raw material component (H′) separated, in a solvent, to provide a composition, performing coating with the composition and drying to form a coating film, and subjecting the coating film to measurement with, for example, a micro-hardness meter Fischer scope (HM2000S manufactured by Fischer Instruments K.K.), a nano indentation tester (ENT-NEXUS manufactured by Elionix Inc.), a nano indenter (iNano, G200 manufactured by Toyo Corporation), and/or a nano indentation system (TI980 manufactured by Bruker AXS GmbH).

As described above, a cured product obtained by curing the matrix raw material component (H′) with hydrolytic condensation or the like corresponds to the matrix component (H). Accordingly, the value of the elastic recovery rate η_{ITH′} of the matrix raw material component (H′) can be determined under the assumption that the value of the elastic recovery rate η_{ITH′} of the matrix raw material component (H′), as measured by a method described in Examples below, is well matched with the elastic recovery rate η_{ITH} of the corresponding matrix component (H). That is, the elastic recovery rate η_{ITH} of the matrix component (H) in the present embodiment is preferably 0.60 or more, more preferably 0.65 or more. The η_{ITH} is preferably 0.95 or less from the viewpoint of being able to conform to deformation of the substrate and/or the component (F) in formation of the coating film.

Examples of the method for adjusting the elastic recovery rate η_{ITH}′, and the elastic recovery rate η_{ITH} in the respective ranges include, but not limited to the following, adjustment of the structure and the compositional ratio of the structural component of the matrix raw material component (H′).

### [Solvent (N)]

The coating material composition (L) in the present embodiment preferably contains a solvent (N). A solvent (N) is not particularly limited, and a common solvent can be used. Examples of the solvent (N) include, but not limited to the following, water; alcohols such as ethylene glycol, butyl cellosolve, isopropanol, n-butanol, 2-butanol, ethanol, methanol, modified ethanol, 2-methoxy-1-propanol, 1-methoxy-2-propanol, diacetone alcohol glycerin, monoalkyl monoglyceryl ether, propylene glycol monomethyl ether, diethylene glycol monobutyl ether, propylene glycol monoethyl ether, propylene glycol monobutyl ether, dipropylene glycol monoethyl ether, dipropylene glycol monobutyl ether, diethylene glycol monophenyl ether and tetraethylene glycol monophenyl ether; aromatic hydrocarbons such as toluene and xylene; aliphatic hydrocarbons such as hexane, cyclohexane and heptane; esters such as ethyl acetate and n-butyl acetate; ketones such as acetone, methyl ethyl ketone, methyl isobutyl ketone and cyclohexanone; ethers such as tetrahydrofuran and dioxane; amides such as dimethylacetamide and dimethylformamide; halogen compounds such as chloroform, methylene chloride and carbon tetrachloride; dimethylsulfoxide, and nitrobenzene; and these may be used singly or in combinations of two or more thereof. In particular, such a solvent particularly preferably includes water and/or any alcohol from the viewpoint of a decrease in environmental load in removal of the solvent.

### [Properties of Coating Material Composition (L)]

The solid content concentration of the coating material composition (L) is preferably 0.01 to 60% by mass, more preferably 1 to 40% by mass from the viewpoint of coatability. The viscosity at 20° C. of the coating material composition (L) is preferably 0.1 to 100000 mPa-s, more preferably 1 to 10000 mPa-s from the viewpoint of coatability.

### [Effect of Laminate]

As described above, the laminate of the present embodiment includes the hard coating layer (K) on the adhesion layer-applied substrate. The laminate is configured as described above, and thus has excellent abrasion resistance, adhesiveness, durability and weather resistance.

### [Application of Laminate]

The laminate of the present embodiment exhibits abrasion resistance, adhesiveness, durability and optical properties at high levels, thus is useful as, but not limited to the following, a hard coating for, for example, a building material, an automobile member, electronic equipment, and an electronic product, and is particularly preferably used in an automobile member.

Particularly, the laminate of the present embodiment has excellent abrasion resistance and durability, and thus, examples of the applications of the laminate of the present embodiment include, but not particularly limited, a building material, a vehicle member, electronic equipment and an electronic product.

Examples of such a building material application include, but not limited to the following, window glass for a constructing machine, window glass for a building, a house, a greenhouse, and the like, roofs for a garage, an arcade, and the like, a light for lighting, a traffic light, and the like, a skin material for wallpaper, a signboard, sanitary products such as a bath and a washstand, an external wall building material for kitchen, and interior floor materials such as a flooring material, a cork material, tiling, a vinyl flooring, and linoleum.

Examples of such a vehicle member include, but not limited to the following, components for use in each application of an automobile, an airplane, and a train. Specific examples include each glass of front, rear, front door, rear door, rear quarter, sunroof, and the like, exterior members such as a front bumper and a rear bumper, a spoiler, a door mirror, a front grille, an emblem cover, and a body, interior members such as a center panel, a door panel, an instrumental panel, and a center console, members for lamp such as head lamp and rear lamp, a vehicle-mounted camera lens member, a lighting cover, a decorative film, and various alternative members to glass.

Examples of such electronic equipment and electronic product preferably include, but not limited to the following, a cellular phone, a portable information terminal, a personal computer, a portable gaming device, OA equipment, a solar cell, a flat panel display, a touch panel, optical discs such as DVD and Blu-ray Disc, optical components such as a polarizing plate, an optical filter, a lens, a prism, and an optical fiber, and optical films such as antireflective film, an oriented film, a polarizing film, and a phase difference film.

The laminate of the present embodiment can be applied to, in addition to the above, various fields of a mechanical component, an agricultural material, a fishing material, a transport container, a packaging container, playground equipment and sundry goods, and the like.

### Second Embodiment

Herein, a second aspect (hereinafter, also referred to as “second embodiment”.) according to the present embodiment is described in detail.

A coating material composition of the present embodiment is a coating material composition including a mixture of a polymer particle (A) having a unit (a) derived from a vinyl monomer (a) and an inorganic oxide (B), and/or a composite (C) of the polymer particle (A) and an inorganic oxide (B), in which the weight average molecular weight of the unit (a) is 10000 to 5000000, and the pH of the coating material composition is 7 to 11. The coating material composition of the present embodiment thus configured is excellent in coating material stability and is excellent in transparency, adhesiveness and weather resistance of the formed coating film.

### [Polymer Particle (A)]

The polymer particle (A) in the present embodiment mainly serves to enhance adhesiveness to the substrate, and includes a vinyl monomer (a) as a structural unit. In other words, the polymer particle (A) has a unit (a) derived from a vinyl monomer (a). The polymer particle (A) is not particularly limited as long as it is a particulate polymer including the vinyl monomer (a) as a structural unit, and preferably includes an emulsion particle having the unit (a) derived from a vinyl monomer (a).

The unit (a) in the present embodiment preferably has a unit (a-1) derived from an ultraviolet-absorptive vinyl monomer (a-1). The unit (a-1) can be contained to thereby enhance coating material stability and prevent a decrease in adhesiveness or weather resistance of the formed adhesion layer (I) and laminate (K) described below, because an ultraviolet absorber, even if contained in the coating material composition, is easily taken up into the inside of an emulsion.

The ultraviolet-absorptive vinyl monomer (a-1) in the present embodiment is the same as the ultraviolet-absorptive vinyl monomer (a-1) in <<First embodiment>>, and can be exemplified in the same manner as in <<First embodiment>>.

The content of the unit (a-1) is preferably 1 to 20% by mass, more preferably 1 to 10% by mass based on the total mass of the unit (a) constituting the polymer particle (A) from the viewpoints of weather resistance and adhesiveness of the adhesion layer (I) and the laminate (K) described below.

When the coating material composition in the present embodiment includes the composite (C) and the polymer particle (A) which is a separate component therefrom, the above content is calculated as the total amount of the polymer particle included in the composite (C) and the polymer particle (A) which is a separate component therefrom.

The polymer particle (A) in the present embodiment is a monomer that does not correspond to the unit (a-1), and preferably has a unit (a-2) derived from a hydroxyl group-containing vinyl monomer (a-2) having a hydroxyl group. The hydroxyl group-containing vinyl monomer (a-2) in the present embodiment is the same as the hydroxyl group-containing vinyl monomer (a-2) in <<First embodiment>>, and can be exemplified in the same manner as in <<First embodiment>>.

The content of the unit (a-2) is preferably 10% to 40% by mass, more preferably 20 to 40% by mass based on the total mass of the vinyl monomer (a) constituting the polymer particle (A). When the content is in the above range, the reaction of the ultraviolet-absorptive vinyl monomer and other vinyl monomers tends to progress preferably. Furthermore, a decrease in transparency of the formed adhesion layer (I) or laminate (K) described below can be prevented due to ensured hydrophilicity of the polymer particle (A).

When the coating material composition in the present embodiment includes the composite (C) and the polymer particle (A) which is a separate component therefrom, the above content is calculated as the total amount of the polymer particle included in the composite (C) and the polymer particle (A) which is a separate component therefrom.

The polymer particle (A) in the present embodiment may have a unit derived from any other vinyl monomer, in addition to the units (a-1) and (a-2). Any other vinyl monomer is not particularly limited, and, for example, a vinyl monomer other than those described above, among those exemplified as the vinyl monomer (a) in <<First embodiment>> can be appropriately adopted.

The polymer particle (A) may have a structure derived from an emulsifier. The emulsifier is the same as the emulsifier in <<First embodiment>>, and can be exemplified in the same manner as in <<First embodiment>>.

The polymer particle (A) in the present embodiment preferably includes a chain transfer agent. In other words, the coating material composition of the present embodiment preferably includes a chain transfer agent. The chain transfer agent is the same as the chain transfer agent in <<First embodiment>>, and can be exemplified in the same manner as in <<First embodiment>>.

The content of the chain transfer agent in the coating material composition of the present embodiment is not particularly limited and is preferably 0.1% by mass to 2% by mass, more preferably 0.25% by mass to 1% by mass based on 100% by mass of the unit (a) from the viewpoints of coating material stability and adhesiveness of the adhesion layer (I).

When the coating material composition in the present embodiment includes the composite (C) and the polymer particle (A) which is a separate component therefrom, the above content is calculated as the total amount of the polymer particle included in the composite (C) and the polymer particle (A) which is a separate component therefrom.

The method for preparing the polymer particle (A) used in the present embodiment is not particularly limited, and various preparation methods, for example, emulsion polymerization or solution polymerization, can be selected. Such a particle is preferably prepared by emulsion polymerization of a vinyl monomer in the presence of water and an emulsifier. That is, the polymer particle (A) is preferably a polymer particle (emulsion particle having the unit (a) derived from a vinyl monomer (a)) obtained by a preparation method involving polymerizing a vinyl monomer (a) in the presence of water and an emulsifier. In other words, the polymer particle (A) is preferably a polymer particle (emulsion particle having the unit (a) derived from a vinyl monomer (a)) derived from an emulsifier and a vinyl monomer (a). The polymer particle (A) thus obtained, when included in the adhesion layer, tends to better maintain adhesiveness to the substrate. Since the polymer particle (A) obtained as described above typically entrains water, a coating material composition used in the present embodiment is preferably a water-based coating material composition. Herein, “water-based” means that the most abundant component among components included in a solvent (M) described below is water.

The polymerization initiator is not particularly limited, and examples thereof include organic polymerization initiators including hydrogen peroxide, hydroperoxides such as cumene hydroperoxide, diisopropylbenzene hydroperoxide, and p-menthane hydroperoxide, peroxides such as benzoyl peroxide and lauroyl peroxide, and azo compounds such as 2,2′-azobis{2-methyl-N-[2-(1-hydroxybutyl)propionamide]}, 2,2′-azobis[(2-methylpropionamidine) dihydrochloride], 2,2′-azobis[N-(2-carboxyethyl)-2-methyl-propionediamine]tetrahydrate, 2,2′-azobis(2,4-dimethylvaleronitrile), and azobisisobutyronitrile, and inorganic polymerization initiators including persulfates such as potassium persulfate, sodium persulfate, and ammonium persulfates. Alternatively, a so-called redox polymerization initiator may be used which employs a reducing agent such as sodium bisulfite, ascorbic acid or a salt thereof in combination with the polymerization initiator.

[Weight Average Molecular Weight of Unit (a)]

In the present embodiment, the weight average molecular weight of the unit (a) is 10000 or more and 5000000 or less. When the weight average molecular weight is in the above range, the coating material composition, even if containing an ultraviolet absorber, is excellent in coating material stability and is excellent in transparency, adhesiveness, and weather resistance of the formed adhesion layer (I) and laminate (K) described below. The weight average molecular weight of the unit (a) is more preferably 1000000 or less from the viewpoints of a further enhancement in coating material stability, and adhesiveness of the adhesion layer (I) described below, and the weight average molecular weight of the unit (a) is more preferably 100000 or more from the viewpoint of stability in synthesis of the polymer particle (A).

When the coating material composition in the present embodiment includes the composite (C) and the polymer particle (A) which is a separate component therefrom, the weight average molecular weight Mw of the unit (a) in the coating material composition is calculated by the following expression from the content W1 and the weight average molecular weight Mw1 of the unit (a) in the polymer particle (A) and the content W2 and the weight average molecular weight Mw2 of the unit (a) in the composite (C). Mw={Mw1×(W1/(W1+W2))+Mw2×(W2/(W1+W2))}/2 The weight average molecular weight of the unit (a) can be measured based on a method described in Examples below. The weight average molecular weight of the unit (a) can be adjusted to the above range, for example, by use of the above chain transfer agent.

### [Average Particle Size of Polymer Particle (A)]

The average particle size of the polymer particle (A) in the present embodiment is determined from the size of such any particle observed according to a dynamic light scattering method. The average particle size of the polymer particle (A) is not particularly limited, and is preferably 200 nm or less. The average particle size of the polymer particle (A) is adjusted in the range, and thus an adhesion layer still higher in adhesiveness can be likely formed due to an enhancement in contact area with the substrate. The average particle size is more preferably 100 nm or less from the viewpoint of an enhancement in transparency of the adhesion layer (I) described below, and is preferably 10 nm or more, more preferably 50 nm or more from the viewpoint of an improvement in storage stability. The average particle size of the polymer particle (A) can be measured based on a method described in Examples below. The average particle size of the polymer particle (A) can be adjusted to the above range, for example, by polymerization conditions.

The content of the polymer particle (A) in the present embodiment is preferably 1% to 40%, more preferably 2% to 20%, further preferably 4% to 10% based on 100% by mass of the coating material composition from the viewpoint that a coating film having better transparency, adhesiveness and weather resistance is obtained.

When the adhesion layer (I) is formed, the content of the polymer particle (A) based on 100% by mass of the adhesion layer is preferably 20% to 60%, more preferably 25% to 50% from the same viewpoints as above.

When the coating material composition in the present embodiment includes the composite (C) and the polymer particle (A) which is a separate component therefrom, the above content is calculated as the total amount of the polymer particle included in the composite (C) and the polymer particle (A) which is a separate component therefrom.

### [Inorganic Oxide (B)]

The coating material composition of the present embodiment includes an inorganic oxide (B) as an essential component. The coating material composition includes the inorganic oxide (B) and is thereby excellent in transparency, adhesiveness, and heat resistance of the formed laminate (K) described below due to interaction between the adhesion layer (I) and a hard coating layer (J) described below.

The inorganic oxide (B) in the present embodiment is the same as the inorganic oxide (B) in <<First embodiment>>, and can be exemplified in the same manner as in <<First embodiment>>.

### [Shape of Inorganic Oxide (B)]

Examples of the shape of the inorganic oxide (B) in the present embodiment include, but not limited to the following, one of or a mixture of two or more of spherical, horned, polyhedron, elliptical, flattened, linear, beaded, and chained shapes. The inorganic oxide (B) in the present embodiment preferably has a spherical shape and/or a linked structure such as a beaded or chained shape from the viewpoints of transparency and abrasion resistance of the laminate (K). The inorganic oxide (B) more preferably has a linked structure such as a beaded or chained shape from the viewpoint of adhesiveness of the adhesion layer (I) to the hard coating layer (J) described below. The beaded shape is a structure where a spherical primary particle is linked in a beaded manner, and the chained shape is a structure where a spherical primary particle is linked in a chained shape. In the present embodiment, the inorganic oxide (B) is extremely preferably a silica having a spherical shape and/or a linked structure, most preferably a silica having a linked structure.

The average particle size of the inorganic oxide (B) in the present embodiment is preferably 2 nm or more from the viewpoint of an improvement in storage stability of a water-based raw material composition. The average particle size is preferably 150 nm or less, more preferably 100 nm or less from the viewpoint of an improvement in transparency of the entire laminate. Thus, the primary average particle size is preferably 2 nm or more and 100 nm or less, more preferably 2 nm or more and 50 nm or less, further preferably 4 nm or more and 50 nm or less. The average particle size can be measured based on, but not limited to the following, for example, a method (dynamic light scattering method) described in Examples below.

### [Colloidal Silica Suitably Used as Inorganic Oxide (B)]

The colloidal silica suitably used in the present embodiment is the same as the colloidal silica in <<First embodiment>>, and can be exemplified in the same manner as in <<First embodiment>>.

### [Composite (C) of Polymer Particle (A) and Inorganic Oxide (B)]

In the coating material composition of the present embodiment, the polymer particle (A) and the inorganic oxide (B) may be contained as a mixture obtained by mixing both the components, or may be contained as a composite (C) of the polymer particle (A) and the inorganic oxide (B), obtained in advance. The coating material composition of the present embodiment preferably includes the composite (C) from the viewpoints of coating material stability, and transparency of the adhesion layer (I) or the laminate (K) described below. The composite (C) of the polymer particle (A) and the inorganic oxide (B) is obtained by, for example, polymerization of a vinyl monomer constituting the above polymer particle (A), in the presence of the inorganic oxide (B). The vinyl monomer preferably includes the above hydroxyl group-containing vinyl monomer and/or vinyl monomer having secondary and/or tertiary amide group(s) from the viewpoint of interaction with the inorganic oxide (B), and thereby tends to preferably form the composite (C) from a hydrogen bond to a hydroxyl group of the inorganic oxide (B).

In the present embodiment, the average particle size of the mixture and/or the composite (C) of the polymer particle (A) and the inorganic oxide (B) is preferably 2 nm or more and 200 nm or less, more preferably 50 nm or more and 150 nm or less from the same viewpoint of transparency of the adhesion layer (I) and the laminate (K) described below. The average particle size is determined from the size of such any particle observed according to a dynamic light scattering method.

### [Mass Ratio of Inorganic Oxide (B) to Total Solid Content of Coating Material Composition]

In the present embodiment, the mass ratio of the inorganic oxide (B) to the total solid content of the coating material composition is preferably 25% to 60%, more preferably 35% to 50% from the viewpoints of transparency, adhesiveness, and heat resistance of the adhesion layer (I) or the laminate (K) described below. Herein, the total solid content of the coating material composition represents the total weight of components other than a volatile component included in the coating material composition. The volatile component in the coating material mainly corresponds to the solvent (M) described below. When the coating material composition in the present embodiment includes the composite (C) and the inorganic oxide (B) which is a separate component therefrom, the above mass ratio is calculated as the total amount of the inorganic oxide included in the composite (C) and the inorganic oxide (B) which is a separate component therefrom.

### [Organic Ultraviolet Absorber (D)]

The coating material composition of the present embodiment preferably includes an organic ultraviolet absorber (D) from the viewpoint of an enhancement in weather resistance. The organic ultraviolet absorber (D) is the same as the ultraviolet absorber in <<First embodiment>>, and can be exemplified in the same manner as in <<First embodiment>>.

[Mass Ratio of Unit (a-1) and Organic Ultraviolet Absorber (D)]

In the present embodiment, the mass ratio of the ultraviolet-absorptive vinyl monomer (a-1) and the organic ultraviolet absorber (D) is preferably in the range of 1:0.5 to 1:40, more preferably in the range of 1:1 to 1:10, further preferably in the range of 1:2 to 1:6. When the mass ratio of the unit (a-1) and the organic ultraviolet absorber (D) is in the above range, dispersibility of the ultraviolet absorber in a coating material is improved and the formed adhesion layer (I) and/or laminate (K) described below tend(s) to be excellent in transparency, adhesiveness, and weather resistance. When the coating material composition in the present embodiment includes the composite (C) and the polymer particle (A) which is a separate component therefrom, the above mass ratio is calculated as the total amount of the emulsion particle included in the composite (C) and the polymer particle (A) which is a separate component therefrom.

### [Isocyanate Compound]

The coating material composition according to the present embodiment preferably contains an isocyanate compound and/or a urethane compound as a curing agent from the viewpoint of an enhancement in adhesiveness and heat resistance of the adhesion layer (I) or the laminate (K) described below. The isocyanate compound is the same as the isocyanate compound in <<First embodiment>>, and can be exemplified in the same manner as in <<First embodiment>>.

### [Block Polyisocyanate Compound (E)]

The isocyanate compound is more preferably a block polyisocyanate compound (E) obtained by reacting an isocyanate group with a blocking agent from the viewpoint of dispersibility in a coating material. The block polyisocyanate compound (E) is the same as the block polyisocyanate compound (E) in <<First embodiment>>, and can be exemplified in the same manner as in <<First embodiment>>.

### [NCO/OH Ratio]

The content of the isocyanate compound in the coating material composition of the present embodiment, relative to the polymer particle (A) obtained by polymerization of the monomer including the hydroxyl group-containing vinyl monomer (a-2), is preferably 0.1 to 1.0, more preferably 0.3 to 0.8 as the ratio (NCO/OH ratio) of the molar number of an isocyanate group included in the isocyanate compound to the molar number of a hydroxyl group included in the polymer particle (A). When the NCO/OH ratio is in the above range, the formed adhesion layer (I) and laminate (K) described below can exhibit excellent adhesiveness and heat resistance without impairing transparency.

When the coating material composition in the present embodiment includes the composite (C) and the polymer particle (A) which is a separate component therefrom, the above content is calculated as the total amount of the polymer particle included in the composite (C) and the polymer particle (A) which is a separate component therefrom.

### [Solvent (M)]

The coating material composition of the present embodiment preferably contains a solvent (M). The solvent (M) contains preferably 50% by mass or more, more preferably 60% by mass or more, further preferably 75% by mass or more of water from the viewpoint of sanitary conditions in workplaces and a decrease in global environmental burdens. A usable solvent other than water is not particularly limited, and a common solvent can be used. The solvent is the same as the solvent in <<First embodiment>>, and can be exemplified in the same manner as in <<First embodiment>>. The content of the solvent (M) is preferably 75% by mass or more based on 100% by mass of the coating material composition from the viewpoint of dispersion stability of the coating material composition, and is preferably 95% by mass or less from the viewpoint that a film thickness is secured in film formation of the adhesion layer.

### [Component Optionally Included in Coating Material Composition]

The coating material composition of the present embodiment optionally includes an emulsifier, a plasticizer, a pigment, a dye, a filler, an anti-aging agent, a conductive material, a light stabilizer, a peel strength adjusting agent, a softener, a surfactant, a flame retardant, an antioxidant, and/or a catalyst, depending on the application. Particularly, the coating material composition preferably includes a light stabilizer from the viewpoint of an enhancement in weather resistance. The light stabilizer is the same as the light stabilizer in <<First embodiment>>, and can be exemplified in the same manner as in <<First embodiment>>.

### [Concentration and Viscosity of Coating Material Composition]

The solid content concentration of the coating material composition of the present embodiment is preferably 0.01 to 60% by mass, more preferably 1 to 40% by mass from the viewpoint of coatability. The viscosity at 20° C. of the coating material composition of the present embodiment is preferably 0.1 to 100000 mPa·s, more preferably 1 to 10000 mPa·s from the viewpoint of coatability.

### [pH of Coating Material Composition]

The pH of the coating material composition in the present embodiment is 7 to 11. When the pH is in the above range, dispersibility of the polymer particle (A) is enhanced to result in an enhancement in coating material stability. The pH is more preferably in the range of 8 to 11 from the viewpoint of transparency of the adhesion layer (I) described below. The pH can be measured based on a method described in Examples below. The pH can be adjusted to the above range, for example, by addition of ammonia.

### [Adhesion Layer (I)-Applied Substrate]

An adhesion layer (I)-applied substrate of the present embodiment is an adhesion layer-applied substrate including a substrate and an adhesion layer (I) disposed on the substrate, wherein the adhesion layer (I) includes the coating material composition of the present embodiment. The “adhesion layer (I) including the coating material composition of the present embodiment” is intended to encompass obtainment of the adhesion layer (I) from the coating material composition of the present embodiment. That is, the adhesion layer (I) can be obtained, for example, by coating the substrate with the coating material composition of the present embodiment, and subjecting the resultant to, for example, a heat treatment, ultraviolet irradiation, and/or infrared irradiation to thereby form a coating film. Examples of the coating method include, but not limited to the following, a spraying method, a flow coating method, a brush coating method, a dip coating method, a spin coating method, a screen printing method, a casting method, a gravure printing method, and a flexographic printing method. The coating material composition of the present embodiment subjected to coating can be preferably formed into a coating film by, for example, a heat treatment at room temperature to 250° C., more preferably 40° C. to 150° C., and/or ultraviolet or infrared irradiation. This coating can be applied for not only coating a substrate already formed, but also coating a flat plate in advance before forming and processing, like a pre-coating metal including a rust-resistant steel plate.

The thickness of the adhesion layer (I) is preferably 0.1 μm or more, more preferably 0.3 μm or more from the viewpoint of adhesiveness described below, and is preferably 100.0 μm or less, more preferably 50.0 μm or less from the viewpoint of transparency.

The substrate is the same as the substrate in <<First embodiment>>, and can be exemplified in the same manner as in <<First embodiment>>.

### [Laminate (K)]

The laminate (K) according to the present embodiment is a laminate including the adhesion layer-applied substrate of the present embodiment and a hard coating layer disposed on the adhesion layer-applied substrate, wherein the hard coating layer includes a matrix component (H) containing an inorganic oxide (F) and a polymer nanoparticle (G), and the Martens hardness HMG of the polymer nanoparticle (G) and the Martens hardness HMH of the matrix component (H) satisfy a relationship of HMH/HMG>1. The laminate (K) according to the present embodiment includes the hard coating layer (J) on the adhesion layer (I)-applied substrate, and thus has excellent abrasion resistance, adhesiveness, durability and optical properties. The laminate (K) of the present embodiment exhibits abrasion resistance, adhesiveness, durability and optical properties at high levels, thus is useful as, but not limited to the following, a hard coating for, for example, a building material, an automobile member, electronic equipment, and an electronic product, and is particularly preferably used in an automobile member.

### [Hard Coating Layer (J)]

The hard coating layer (J) in the present embodiment is the same as the hard coating layer (K) in <<First embodiment>>, and can be exemplified in the same manner as in <<First embodiment>>.

### [Application of Laminate]

The laminate (K) of the present embodiment is the same as the laminate in <<First embodiment>>, and can be exemplified in the same manner as in <<First embodiment>>.

### EXAMPLES

Hereinafter, the present embodiment will be described with reference to specific Examples and Comparative Examples, but the present embodiment is not limited thereto.

### <<Examples Corresponding to First Embodiment>>

Various physical properties in Examples and Comparative Examples described below (hereinafter, “Examples” and “Comparative Examples” in the section <<Examples corresponding to first embodiment>> respectively meaning “Examples corresponding to the first embodiment” and “Comparative Examples corresponding to the first embodiment”, unless particularly noted.) were measured according to the following methods.

### (1) Average Particle Sizes of Polymer Particle (A), Inorganic Oxide (B), Mixture of Polymer Particle (A) and Inorganic Oxide (B), Composite (C), and Polymer Particle (F)

The average particle size of the mixture of a polymer particle (A) and an inorganic oxide (B), the composite (E), or the polymer particle (F) was obtained by using the mixture of a polymer particle (A) and an inorganic oxide (B), the composite (E), or the polymer particle (F) obtained by a method described below and measuring the cumulant particle sizes with a dynamic light scattering type particle size distribution measuring apparatus manufactured by Otsuka Electronics Co., Ltd. (item number: ELSZ-1000).

### (2) Evaluation of Transparency of Adhesion Layer-Applied Substrate and Laminate

The transparency of the adhesion layer-applied substrate or the laminate was evaluated from a haze value measured with a turbidimeter (item number: NDH5000SP) manufactured by Nippon Denshoku Industries Co., Ltd., according to the method prescribed in JIS K7136. The haze value H1 was measured by the method with, as a target, the adhesion layer-applied substrate. The haze value H2 was measured by the method with, as a target, the laminate (adhesion layer-applied substrate and hard coating layer (K)).

### (3) Measurements of Martens Hardness HMF and Elastic Recovery Rate η_{ITF} of Polymer Particle (F)

The Martens hardness HMF of the polymer particle (F) was measured by coating a glass substrate (material: white plate glass, thickness: 2 mm) with an aqueous polymer particle (F) dispersion by use of a bar coater so that the film thickness was 3 μm, and drying the resultant at 130° C. over 2 hours to thereby provide a coating film, and subjecting the coating film to measurement with, as a target, a surface on which the coating film was to be formed. The microhardness was measured by an indentation test (test conditions; indenter: Vickers quadrangular pyramid diamond indenter, loading condition: 2 mN/20 sec, unloading condition: 2 mN/20 sec) with a Fischer scope manufactured by Fischer Instruments K.K. (item number: HM2000S), and the Martens hardness HMF of the polymer particle (F) was measured based on an indentation test according to ISO14577-1. The microhardness was measured by an indentation test (test conditions; indenter: Vickers quadrangular pyramid diamond indenter, loading condition: 2 mN/20 sec, unloading condition: 2 mN/20 sec) with a Fischer scope manufactured by Fischer Instruments K.K. (item number: HM2000S), and the ratio of the elastic return deformation workload Wₑₗₐₛₜ of a depression to the total mechanical workload Wₜₒₜₐₗ of a depression, namely, the value of Wₑₗₐₛₜ/Wₜₒₜₐₗ was determined as the elastic recovery rate η_{ITF} of the polymer particle (F), based on an indentation test method according to ISO14577-1.

### (4) Measurements of Martens Hardness HMH′ and Elastic Recovery Rate η_{ITH′} of Matrix Raw Material Component (H′)

The Martens hardness HMH′ of the matrix raw material component (H′) was measured as described below. The matrix raw material component (H′) was dissolved or dispersed in water/ethanol/acetic acid (compositional ratio: 77% by mass/20% by mass/3% by mass) so that the solid content concentration was 8% by mass to obtain a solution. The Martens hardness was obtained by coating a glass substrate (material: white plate glass, thickness: 2 mm) with the resulting solution by use of a bar coater so that the film thickness was 3 μm, drying the resultant at 130° C. over 2 hours to thereby provide a coating film, and subjecting the coating film to measurement. The microhardness was measured by an indentation test (test conditions; indenter: Vickers quadrangular pyramid diamond indenter, loading condition: 2 mN/20 sec, unloading condition: 2 mN/20 sec) with a Fischer scope manufactured by Fischer Instruments K.K. (item number: HM2000S), and the HMH′ and η_{ITH′} (Wₑₗₐₛₜ/Wₜₒₜₐₗ) were measured based on an indentation test method according to ISO14577-1. The matrix component (H) corresponded to the hydrolyzed condensate of the corresponding matrix raw material component (H′), as described below, and thus the respective values of the Martens hardness HMH and the elastic recovery rate η_{ITH} were determined under the assumption that the respective values of the Martens hardness HM_{B′} and the elastic recovery rate η_{ITH′} of the matrix raw material component (H′), measured as described above, were well matched with the values of the Martens hardness HMH and the elastic recovery rate η_{ITH} of the matrix component (H).

### (5) Evaluation of Abrasion Resistance of Laminate

Evaluation of the abrasion resistance of the laminate was performed with a Taber type abrasion tester (No. 101) manufactured by Yasuda Seiki Company, according to the standard of ASTM D1044. In other words, the Taber abrasion test was performed under conditions of an abrasive wheel CS-10F and a load of 500 g. The haze before the test and the haze at a rotation number of 500 were each measured with a turbidimeter (item number: NDH5000SP) manufactured by Nippon Denshoku Industries Co., Ltd., according to the method prescribed in JIS R3212. The difference (ΔHaze) from the haze before the test was determined to thereby evaluate the abrasion resistance of the laminate as follows.
Rotation number: 500
S: ΔHaze of 4 or less
A: ΔHaze of more than 4 and 10 or less
B: ΔHaze of more than 10

### (6) Evaluation of Adhesiveness of Hard Coating Layer (K) (Initial Adhesiveness Evaluation of Laminate)

### <Cross-Scoring Test>

The hard coating layer (K) of the laminate was cut into 25 cells at 1-mm intervals by a cutter blade according to a cross-cut method prescribed in JIS K5600-5-6, a tape (tape according to the cross-cut test/cross-scoring test, manufactured by Nichiban Co., Ltd.) was applied to and peeled from the cells, and the initial adhesiveness of the laminate was evaluated as described below from the number of cells in which the coating film remained. Classes 0 and 1 have no problem in practical use as adhesiveness.
Class 0: No peel-off.
Class 1: Only small peel-off of the coating film at points where cutting lines cross.
Class 2: The coating film was peeled off along the cutting lines in portions where the cutting lines crossed. A peel area of 5% or more and less than 15%.
Class 3: The coating film was partially or wholly peeled off along the cutting lines. A peel area of 15% or more and less than 35%.
Class 4: The coating film was wholly peeled off along the cutting lines. A peel area of 35% or more and less than 65%.
Class 5: The coating film was peeled off beyond Class 4.

### (7) Evaluation of Arithmetic Mean Height Sa

The arithmetic mean height Sa of the adhesion layer surface in the adhesion layer-applied substrate was measured according to the method prescribed in ISO 25178 with a laser microscope “OLS5100” (trade name, manufactured by Olympus Corporation). Specifically, the arithmetic mean height of 100 μm square was calculated at arbitrary five sites of the adhesion layer surface, and the average value thereof was determined as the arithmetic mean height Sa of the adhesion layer surface.

### (8) Elemental Analysis by XPS

The relative element concentration of the adhesion layer surface in the adhesion layer-applied substrate was measured by XPS (Thermo Fisher ESCALAB 250). The measurement was performed with monochromatic AlKα (15 kV×10 mA) as an excitation source, an analysis size of about 1 mm (elliptic shape), and a photoelectron extraction angle of 0° (the test surface was perpendicular to the axis of a spectroscope).

### For the Measurement, Extraction Region

Survey scan: 0 to 1, 100 eV
Narrow scan: C1s, O1s, Si2p, N1s

### Pass Energy

Survey scan: 100 eV
Narrow scan: 20 eV

### Energy Step

Survey scan: 1 eV
Narrow scan: 0.1 eV

### Data Capture Time

Survey scan: 50 ms/step
Narrow scan: 100 ms/step

### Charge Neutralization Conditions

Unit: E401
Filament current: 3.2 A
Emission current: in the course of events

After the observed peak position was corrected with reference to C1s=284.6 eV, the relative element concentration of a metal element (M element concentration) (atomic %) obtained from the spectrum of a metal (M) derived from the inorganic oxide was determined by the following expression.

$${C}_{j} ( \% ) = 100 \times ( {I}_{j} / {RSF}_{j} ) / \sum ( {I}_{j} / {RSF}_{j} )$$

Herein, each parameter is as described below.
Cⱼ: relative element concentration (atomic %)
Iⱼ: area intensity of C1s, O1s, Si2p, and N1s spectra determined from a linearized background (unit: cps·eV)
RSFⱼ: coefficient of relative sensitivity of C1s, O1s, Si2p, and N1s
The above measurement was performed at arbitrary five sites (a small piece of about 1 cm square was cut out, covered with a Mo mask of 2 mmϕ, and used in the measurement) of the adhesion layer surface, and the average value of the obtained M element concentrations was determined as the M element concentration of the adhesion layer surface.

### (9) Evaluation of Weather Resistance

In a weather resistance test of the laminate, the weather resistance of the laminate was determined by performing ultraviolet irradiation from a xenon arc (product name SX-75 manufactured by Suga Test Instruments Co., Ltd.) according to the conditions of the standards of ANSI/SAE Z26.1, to provide the Δb before and after irradiation at 2000 MJ/m², and was evaluated as follows.

$$S : Δ b < 1$$

$$A : 1 \leq Δ b \leq 4$$

$$B : Δ b > 4$$

### (10) Chemical Resistance Evaluation

Evaluation of the chemical resistance of the laminate was performed by an immersion test on five chemicals according to ECE UN R43, and the evaluation was made as described below from the number of chemicals that caused change in outer appearance of the laminate after the immersion test among the five chemicals.
S: 0 out of the chemicals
A: 1 or 2 out of the chemicals
B: 3 to 5 out of the chemicals

### (11) Moisture Resistance Evaluation

The prepared laminate was exposed to an environment at 50° C. and 90% RH for 240 hours and then left to still stand overnight under an environment at 23° C. and 50% RH. The obtained laminate was subjected to adhesiveness evaluation by a cross-scoring test, and the moisture resistance of the laminate was evaluated according to the following criteria.
Class 0: No peel-off.
Class 1: Only small peel-off of the coating film at points where cutting lines cross.
Class 2: The coating film was peeled off along the cutting lines in portions where the cutting lines crossed. A peel area of 5% or more and less than 15%.
Class 3: The coating film was partially or wholly peeled off along the cutting lines. A peel area of 15% or more and less than 35%.
Class 4: The coating film was wholly peeled off along the cutting lines. A peel area of 35% or more and less than 65%.
Class 5: The coating film was peeled off beyond Class 4.

### (12) Hot Water Resistance Evaluation

In order to confirm adhesiveness after a durability test, the following evaluation was performed. Specifically, the prepared laminate was immersed under an environment of water at 40° C. for 240 hours and then left to still stand overnight under an environment at 23° C. and 50% RH. The obtained laminate was subjected to adhesiveness evaluation by a cross-scoring test, and the hot water resistance of the laminate was evaluated according to the following criteria.
Class 0: No peel-off.
Class 1: Only small peel-off of the coating film at points where cutting lines cross.
Class 2: The coating film was peeled off along the cutting lines in portions where the cutting lines crossed. A peel area of 5% or more and less than 15%.
Class 3: The coating film was partially or wholly peeled off along the cutting lines. A peel area of 15% or more and less than 35%.
Class 4: The coating film was wholly peeled off along the cutting lines. A peel area of 35% or more and less than 65%.
Class 5: The coating film was peeled off beyond Class 4.

### [Preparation of Aqueous Polymer Particle (A) Dispersion]

An aqueous polymer particle (A) dispersion was synthesized as follows.

### <Aqueous Polymer Particle (A-1) Dispersion>

Polymerization according to a common emulsion polymerization method was performed with a monomer mixture liquid in which 500 g of ion-exchange water, 33 g of an aqueous 10% dodecylbenzene sulfonic acid solution, 43 g of an aqueous 2% ammonium persulfate solution, and 8.6 g of ultraviolet-absorptive vinyl monomer “RUVA-93” (trade name, manufactured by Otsuka Chemical Co., Ltd.) were dissolved in a mixture of 93.2 g of butyl acrylate, 60.4 g of 2-hydroxyethyl methacrylate, 8.6 g of 2-hydroxyethylacrylamide, and 1.7 g of acrylic acid in a reactor having a reflux condenser, a driptank, a thermometer and a stirring apparatus in an environment at 80° C. After the polymerization, the obtained polymer liquid was filtered with a 100-mesh wire gauze, and the solid content concentration was adjusted to 20% by mass with purified water, thereby providing an aqueous polymer particle (A-1) dispersion. The resulting polymer particle (A-1) had a particle size of 50 nm.

### [Preparation of Composite (E) of Polymer Particle (A) and Inorganic Oxide (B)]

An aqueous composite (E-1) dispersion was synthesized as follows.

### <Aqueous Composite (E-1) Dispersion>

Polymerization according to a common emulsion polymerization method was performed with a monomer mixture liquid in which 150 g of ion-exchange water, 1150 g of colloidal silica “Snowtex PS-SO” (trade name, manufactured by Nissan Chemical Corporation, silica having a linked structure, solid content: 15% by mass, primary average particle size: 15 nm) dispersed in water, serving as the inorganic oxide (B), 22 g of an aqueous 10% dodecylbenzene sulfonic acid solution, 28 g of an aqueous 2% ammonium persulfate solution, and 5.8 g of ultraviolet-absorptive vinyl monomer “RUVA-93” (trade name, manufactured by Otsuka Chemical Co., Ltd.) were dissolved in a mixture of 62.1 g of butyl acrylate, 46.0 g of 2-hydroxyethyl methacrylate, and 1.2 g of acrylic acid in a reactor having a reflux condenser, a driptank, a thermometer and a stirring apparatus in an environment at 80° C. After the polymerization, the obtained polymer liquid was pH-adjusted to 9 with an aqueous 25% ammonia solution and filtered with a 100-mesh wire gauze, and the solid content concentration was adjusted to 15% by mass with purified water, thereby providing an aqueous composite (E-1) dispersion. The resulting composite (E-1) had an average particle size of 76 nm. The mass ratio of the polymer particle (A) and the inorganic oxide (B) (polymer particle (A):inorganic oxide (B)) in the composite (E-1) was 40:60.

### [Preparation of Aqueous Polymer Particle (F) Dispersion]

An aqueous polymer particle (F) dispersion was synthesized as follows.

### <Aqueous Polymer Particle (F-1) Dispersion>

Polymerization according to a common emulsion polymerization method was performed with 1500 g of ion-exchange water, 45 g of an aqueous 10% dodecylbenzene sulfonic acid solution, 105 g of methyltrimethoxysilane, 23 g of phenyltrimethoxysilane and 27 g of tetraethoxysilane in a reactor having a reflux condenser, a driptank, a thermometer and a stirring apparatus in an environment at 50° C. After the polymerization, the temperature of the obtained polymer liquid was set to 80° C., thereafter polymerization according to a common emulsion polymerization method was further performed with 43 g of an aqueous 2% ammonium persulfate solution, 11 g of butyl acrylate, 12 g of diethylacrylamide, 1 g of acrylic acid and 1 g of 3-methacryloxypropyltrimethoxysilane. The obtained polymer liquid was filtered with a 100-mesh wire gauze, and the solid content concentration was adjusted to 5% with purified water, thereby providing an aqueous polymer particle (F-1) dispersion. The resulting polymer particle (F-1) had a core/shell structure and the average particle size thereof was 60 nm. The polymer particle (F-1) had a Martens hardness HMF of 150 N/mm³ and an elastic recovery rate η_{ITF} of 0.70, as measured according to the above measurement methods.

### [Preparation of Coating Composition Liquid of Matrix Raw Material Component (H′)]

A coating composition liquid of each matrix raw material component (H′) was prepared as follows.

### <Coating Composition Liquid of Matrix Raw Material Component (H′-1)>

A coating composition liquid of matrix raw material component (H′-1) was obtained by mixing 35 g of 1,2-bis(triethoxysilyl)ethane and 81 g of tris-(trimethoxysilylpropyl)isocyanurate each serving as the hydrolyzable silicon compound (h), and 333 g of colloidal silica “Snowtex OXS” (trade name, manufactured by Nissan Chemical Corporation, solid content: 10% by mass) dispersed in water, serving as the inorganic oxide (G), under a room temperature condition. The matrix raw material component (H′-1) had a Martens hardness HMH′ of 420 N/mm³ and an elastic recovery rate η_{ITH′} of 0.71, as measured according to the above measurement methods.

### <Coating Composition Liquid of Matrix Raw Material Component (H′-2)>

A coating composition liquid of matrix raw material component (H′-2) was obtained by mixing 66 g of methyltrimethoxysilane and 63 g of tetraethoxysilane each serving as the hydrolyzable silicon compound (h), and 333 g of colloidal silica “Snowtex OXS” (trade name, manufactured by Nissan Chemical Corporation, solid content: 10% by mass) dispersed in water, serving as the inorganic oxide (G), under a room temperature condition. The matrix raw material component (H′-2) had a Martens hardness HMH′ of 350 N/mm³ and an elastic recovery rate η_{ITH′} of 0.69, as measured according to the above measurement methods.

### [Preparation of Composition Liquid of Hard Coating Layer (K)]

### <Composition Liquid of Hard Coating Layer (K-1)>

The aqueous polymer particle (F-1) dispersion prepared above and matrix raw material component (H′-1) prepared above were mixed so that the mass ratio of the respective solid contents of the polymer particle (F) and the matrix component (H) satisfied (F-1):(H-1)=100:200, thereby providing a mixture. An aqueous solution having an ethanol concentration of 20% by mass was used as a solvent, and the mixture was added thereto so that the solid content concentration was 10% by mass, thereby providing a composition liquid of hard coating layer (K-1). The hard coating layer (K-1) had a Martens hardness HMK′ of 380 N/mm³ and an elastic recovery rate η_{ITK} of 0.70, as measured according to the above measurement methods.

### <Composition Liquid of Hard Coating Layer (K-2)>

The aqueous polymer particle (F-1) dispersion prepared above and matrix raw material component (H′-2) prepared above were mixed so that the mass ratio of the respective solid contents of the polymer particle (F) and the matrix component (H) satisfied (F-1):(H-2)=100:200, thereby providing a mixture. An aqueous solution having an ethanol concentration of 20% by mass was used as a solvent, and the mixture was added thereto so that the solid content concentration was 10% by mass, thereby providing a composition liquid of hard coating layer (K-2). The hard coating layer (K-2) had a Martens hardness HMK′ of 900 N/mm³ and an elastic recovery rate η_{ITK} of 0.69, as measured according to the above measurement methods.

### Example 1

23.7 g of the aqueous polymer particle (A-1) dispersion, 22.1 g of Snowtex PS-SO (trade name, manufactured by Nissan Chemical Corporation, silica having a linked structure, primary average particle size: 15 nm, solid content concentration: 15% by mass) as the inorganic oxide (B), 1.1 g of Tinuvin400 (trade name, manufactured by BASF Japan Ltd., solid content concentration: 85% by mass) as an ultraviolet absorber, 35.1 g of water, and 18.0 g of ethanol were mixed under a room temperature condition, thereby providing a coating material composition of Example 1. In the coating material composition of Example 1, the mass ratio of the polymer particle (A) and the inorganic oxide (B) (polymer particle (A):inorganic oxide (B)) was 1:0.7. The content of the polymer particle based on 100% by mass in total of the polymer particle, the inorganic oxide and the light-shielding agent was 52.6% by mass, the content of the inorganic oxide was 36.8% by mass, and the content of the light-shielding agent was 10.5% by mass.

Next, a polycarbonate substrate was coated with the coating material composition of Example 1 by use of a bar coater, and the resultant was dried at 130° C. for 2 hours, thereby forming an adhesion layer having a film thickness of about 5.0 μm on the polycarbonate substrate. In this way, an adhesion layer-applied substrate of Example 1 was obtained.

Further, the adhesion layer-applied substrate of Example 1 was coated with the composition liquid of hard coating layer (K-1) by use of a bar coater, and thereafter the resultant was dried at 130° C. for 2 hours, thereby providing a laminate having a hard coating layer having a film thickness of about 3.0 μm.

The properties of the obtained adhesion layer-applied substrate and laminate were measured by the above methods. The measurement results are shown in Table 1.

### Example 2

24.3 g of the aqueous polymer particle (A-1) dispersion, 21.1 g of Snowtex OUP (trade name, manufactured by Nissan Chemical Corporation, silica having a linked structure, primary average particle size: 12 nm, solid content concentration: 15% by mass) as the inorganic oxide (B), 1.1 g of Tinuvin400 (trade name, manufactured by BASF Japan Ltd.,) as an ultraviolet absorber, 35.4 g of water, and 18.0 g of ethanol were mixed under a room temperature condition, thereby providing a coating material composition of Example 2. In the coating material composition of Example 2, the mass ratio of the polymer particle (A) and the inorganic oxide (B) (polymer particle (A):inorganic oxide (B)) was 1:0.65. The content of the polymer particle based on 100% by mass in total of the polymer particle, the inorganic oxide and the light-shielding agent was 54.1% by mass, the content of the inorganic oxide was 35.1% by mass, and the content of the light-shielding agent was 10.8% by mass.

Next, a polycarbonate substrate was coated with the coating material composition of Example 2 by use of a bar coater, and the resultant was dried at 130° C. for 2 hours, thereby forming an adhesion layer having a film thickness of about 5.0 μm on the polycarbonate substrate. In this way, an adhesion layer-applied substrate of Example 2 was obtained.

Further, the adhesion layer-applied substrate of Example 2 was coated with the composition liquid of hard coating layer (K-1) by use of a bar coater, and thereafter the resultant was dried at 130° C. for 2 hours, thereby providing a laminate having a hard coating layer having a film thickness of about 3.0 μm.

The properties of the obtained adhesion layer-applied substrate and laminate were measured by the above methods. The measurement results are shown in Table 1.

### Example 3

40.0 g of the aqueous composite (E-1) dispersion, 3.5 g of Tinuvin400 (trade name, manufactured by BASF Japan Ltd.) as an ultraviolet absorber, 38.8 g of water, and 17.7 g of ethanol were mixed under a room temperature condition, thereby providing a coating material composition of Example 3. The content of the polymer particle based on 100% by mass in total of the polymer particle, the inorganic oxide and the light-shielding agent was 26.7% by mass, the content of the inorganic oxide was 40.0% by mass, and the content of the light-shielding agent was 33.3% by mass.

Next, a polycarbonate substrate was coated with the coating material composition of Example 3 by use of a bar coater, and the resultant was dried at 130° C. for 2 hours, thereby forming an adhesion layer having a film thickness of about 5.0 μm on the polycarbonate substrate. In this way, an adhesion layer-applied substrate of Example 3 was obtained.

Further, the adhesion layer-applied substrate of Example 3 was coated with the composition liquid of hard coating layer (K-1) by use of a bar coater, and thereafter the resultant was dried at 130° C. for 2 hours, thereby providing a laminate having a hard coating layer having a film thickness of about 3.0 μm.

The properties of the obtained adhesion layer-applied substrate and laminate were measured by the above methods. The measurement results are shown in Table 1.

### Example 4

41.4 g of the aqueous composite (E-1) dispersion, 2.2 g of WM44-L70G (trade name, manufactured by Asahi Kasei Corporation, solid content concentration: 70% by mass) as the block polyisocyanate compound (C), 1.5 g of Tinuvin400 (trade name, manufactured by BASF Japan Ltd.) as an ultraviolet absorber, 37.0 g of water, and 18.0 g of ethanol were mixed under a room temperature condition, thereby providing a coating material composition of Example 4. The content of the polymer particle based on 100% by mass in total of the polymer particle, the inorganic oxide and the light-shielding agent was 33.3% by mass, the content of the inorganic oxide was 50.0% by mass, and the content of the light-shielding agent was 16.7% by mass.

Next, a polycarbonate substrate was coated with the coating material composition of Example 4 by use of a bar coater, and the resultant was dried at 130° C. for 2 hours, thereby forming an adhesion layer having a film thickness of about 5.0 μm on the polycarbonate substrate. In this way, an adhesion layer-applied substrate of Example 4 was obtained.

Further, the adhesion layer-applied substrate of Example 4 was coated with the composition liquid of hard coating layer (K-1) by use of a bar coater, and thereafter the resultant was dried at 130° C. for 2 hours, thereby providing a laminate having a hard coating layer having a film thickness of about 3.0 μm.

The properties of the obtained adhesion layer-applied substrate and laminate were measured by the above methods. The measurement results are shown in Table 1.

### Example 5

41.4 g of the aqueous composite (E-1) dispersion, 1.8 g of WM44-L70G (trade name, manufactured by Asahi Kasei Corporation, solid content concentration: 70% by mass) as the block polyisocyanate compound (C), 1.5 g of Tinuvin400 (trade name, manufactured by BASF Japan Ltd.) as an ultraviolet absorber, 0.3 g of Tinuvin123 (trade name, manufactured by BASF Japan Ltd., solid content concentration: 100% by mass) as a light stabilizer, 37.1 g of water, and 18.0 g of ethanol were mixed under a room temperature condition, thereby providing a coating material composition of Example 5. The content of the polymer particle based on 100% by mass in total of the polymer particle, the inorganic oxide and the light-shielding agent was 32.0% by mass, the content of the inorganic oxide was 48.0% by mass, and the content of the light-shielding agent was 20.0% by mass.

Next, a polycarbonate substrate was coated with the coating material composition of Example 5 by use of a bar coater, and the resultant was dried at 130° C. for 2 hours, thereby forming an adhesion layer having a film thickness of about 5.0 μm on the polycarbonate substrate. In this way, an adhesion layer-applied substrate of Example 5 was obtained.

Further, the adhesion layer-applied substrate of Example 5 was coated with the composition liquid of hard coating layer (K-1) by use of a bar coater, and thereafter the resultant was dried at 130° C. for 2 hours, thereby providing a laminate having a hard coating layer having a film thickness of about 3.0 μm.

The properties of the obtained adhesion layer-applied substrate and laminate were measured by the above methods. The measurement results are shown in Table 1.

### Example 6

35.3 g of the aqueous composite (E-1) dispersion, 3.4 g of WM44-L70G (trade name, manufactured by Asahi Kasei Corporation, solid content concentration: 70% by mass) as the block polyisocyanate compound (C), 1.2 g of Tinuvin400 (trade name, manufactured by BASF Japan Ltd.) as an ultraviolet absorber, 0.3 g of Tinuvin123 (trade name, manufactured by BASF Japan Ltd., solid content concentration: 100% by mass) as a light stabilizer, 41.8 g of water, and 18.0 g of ethanol were mixed under a room temperature condition, thereby providing a coating material composition of Example 6. The content of the polymer particle based on 100% by mass in total of the polymer particle, the inorganic oxide and the light-shielding agent was 32.0% by mass, the content of the inorganic oxide was 48.0% by mass, and the content of the light-shielding agent was 20.0% by mass.

Next, a polycarbonate substrate was coated with the coating material composition of Example 6 by use of a bar coater, and the resultant was dried at 130° C. for 2 hours, thereby forming an adhesion layer having a film thickness of about 5.0 μm on the polycarbonate substrate. In this way, an adhesion layer-applied substrate of Example 6 was obtained.

Further, the adhesion layer-applied substrate of Example 6 was coated with the composition liquid of hard coating layer (K-1) by use of a bar coater, and thereafter the resultant was dried at 130° C. for 2 hours, thereby providing a laminate having a hard coating layer having a film thickness of about 3.0 μm.

The properties of the obtained adhesion layer-applied substrate and laminate were measured by the above methods. The measurement results are shown in Table 1.

### Example 7

33.3 g of the aqueous composite (E-1) dispersion, 3.2 g of WM44-L70G (trade name, manufactured by Asahi Kasei Corporation, solid content concentration: 70% by mass) as the block polyisocyanate compound (C), 1.8 g of Tinuvin400 (trade name, manufactured by BASF Japan Ltd.) as an ultraviolet absorber, 0.3 g of Tinuvin123 (trade name, manufactured by BASF Japan Ltd., solid content concentration: 100% by mass) as a light stabilizer, 43.5 g of water, and 17.9 g of ethanol were mixed under a room temperature condition, thereby providing a coating material composition of Example 7. The content of the polymer particle based on 100% by mass in total of the polymer particle, the inorganic oxide and the light-shielding agent was 29.6% by mass, the content of the inorganic oxide was 44.4% by mass, and the content of the light-shielding agent was 25.9% by mass.

Next, a polycarbonate substrate was coated with the coating material composition of Example 7 by use of a bar coater, and the resultant was dried at 130° C. for 2 hours, thereby forming an adhesion layer having a film thickness of about 5.0 μm on the polycarbonate substrate. In this way, an adhesion layer-applied substrate of Example 7 was obtained.

Further, the adhesion layer-applied substrate of Example 7 was coated with the composition liquid of hard coating layer (K-1) by use of a bar coater, and thereafter the resultant was dried at 130° C. for 2 hours, thereby providing a laminate having a hard coating layer having a film thickness of about 3.0 μm.

The properties of the obtained adhesion layer-applied substrate and laminate were measured by the above methods. The measurement results are shown in Table 1.

### Comparative Example 1

11.4 g of an aqueous E2050S dispersion liquid (manufactured by Asahi Kasei Corporation, solid content concentration: 46% by mass, average particle size: 140 nm) as the polymer particle (A), 10.5 g of Snowtex-C (trade name, manufactured by Nissan Chemical Corporation, silica having a spherical shape, primary average particle size: 12 nm) as the inorganic oxide (B), 1.8 g of Tinuvin400 (trade name, manufactured by BASF Japan Ltd.) as an ultraviolet absorber, 0.1 g of Tinuvin123 (trade name, manufactured by BASF Japan Ltd.) as a light stabilizer, 58.3 g of water, and 17.9 g of ethanol were mixed under a room temperature condition, thereby providing a coating material composition of Comparative Example 1. In the coating material composition of Comparative Example 1, the mass ratio of the polymer particle (A) and the inorganic oxide (B) (polymer particle (A):inorganic oxide (B)) was 1:0.4.

Next, a polycarbonate substrate was coated with the coating material composition of Comparative Example 1 by use of a bar coater, and the resultant was dried at 130° C. for 2 hours, thereby forming an adhesion layer having a film thickness of about 5.0 μm on the polycarbonate substrate. In this way, an adhesion layer-applied substrate of Comparative Example 1 was obtained.

Further, the adhesion layer-applied substrate of Comparative Example 1 was coated with the composition liquid of hard coating layer (K-2) by use of a bar coater, and thereafter the resultant was dried at 130° C. for 2 hours, thereby providing a laminate having a hard coating layer having a film thickness of about 3.0 μm.

The properties of the obtained adhesion layer-applied substrate and laminate were measured by the above methods. The measurement results are shown in Table 2.

### Comparative Example 2

14.0 g of an aqueous E2050S dispersion liquid (manufactured by Asahi Kasei Corporation, solid content concentration: 46% by mass, average particle size: 140 nm) as the polymer particle (A), 12.9 g of Snowtex-C (trade name, manufactured by Nissan Chemical Corporation, silica having a spherical shape, primary average particle size: 12 nm) as the inorganic oxide (B), 55.0 g of water, and 18.2 g of ethanol were mixed under a room temperature condition, thereby providing a coating material composition of Comparative Example 2. In the coating material composition of Comparative Example 2, the mass ratio of the polymer particle (A) and the inorganic oxide (B) (polymer particle (A):inorganic oxide (B)) was 1:0.4.

Next, a polycarbonate substrate was coated with the coating material composition of Comparative Example 2 by use of a bar coater, and the resultant was dried at 130° C. for 2 hours, thereby forming an adhesion layer having a film thickness of about 5.0 μm on the polycarbonate substrate. In this way, an adhesion layer-applied substrate of Comparative Example 2 was obtained.

Further, the adhesion layer-applied substrate of Comparative Example 2 was coated with the composition liquid of hard coating layer (K-1) by use of a bar coater, and thereafter the resultant was dried at 130° C. for 2 hours, thereby providing a laminate having a hard coating layer having a film thickness of about 3.0 μm.

The properties of the obtained adhesion layer-applied substrate and laminate were measured by the above methods. The measurement results are shown in Table 2.

### Comparative Example 3

71.9 g of the aqueous polymer particle (F-1) dispersion, 9.0 g of Snowtex-OXS (trade name, manufactured by Nissan Chemical Corporation, silica having a spherical shape, primary average particle size: 5 nm) as the inorganic oxide (B), and 19.1 g of ethanol were mixed under a room temperature condition, thereby providing a coating material composition of Comparative Example 3. In the coating material composition of Comparative Example 3, the mass ratio of the polymer particle (A) and the inorganic oxide (B) (polymer particle (A):inorganic oxide (B)) was 1:0.25.

Next, a polycarbonate substrate was coated with the coating material composition of Comparative Example 3 by use of a bar coater, and the resultant was dried at 130° C. for 2 hours, thereby forming an adhesion layer having a film thickness of about 3.0 μm on the polycarbonate substrate. In this way, an adhesion layer-applied substrate of Comparative Example 3 was obtained.

Further, the adhesion layer-applied substrate of Comparative Example 3 was coated with the composition liquid of hard coating layer (K-1) by use of a bar coater, and thereafter the resultant was dried at 130° C. for 2 hours, thereby providing a laminate having a hard coating layer having a film thickness of about 3.0 μm.

The properties of the obtained adhesion layer-applied substrate and laminate were measured by the above methods. The measurement results are shown in Table 2.

### Comparative Example 4

32.1 g of the aqueous polymer particle (A-1) dispersion, 6.4 g of Snowtex-O (trade name, manufactured by Nissan Chemical Corporation, silica having a spherical shape, primary average particle size: 12 nm) as the inorganic oxide (B), 0.9 g of WM44-L70G (trade name, manufactured by Asahi Kasei Corporation, solid content concentration: 70% by mass) as the block polyisocyanate compound (C), 0.8 g of Tinuvin400 (trade name, manufactured by BASF Japan Ltd.) as an ultraviolet absorber, 41.7 g of water, and 18.1 g of ethanol were mixed under a room temperature condition, thereby providing a coating material composition of Comparative Example 4. In the coating material composition of Comparative Example 4, the mass ratio of the polymer particle (A) and the inorganic oxide (B) (polymer particle (A):inorganic oxide (B)) was 1:0.2.

Next, a polycarbonate substrate was coated with the coating material composition of Comparative Example 4 by use of a bar coater, and the resultant was dried at 130° C. for 2 hours, thereby forming an adhesion layer having a film thickness of about 5.0 μm on the polycarbonate substrate. In this way, an adhesion layer-applied substrate of Comparative Example 4 was obtained.

Further, the adhesion layer-applied substrate of Comparative Example 4 was coated with the composition liquid of hard coating layer (K-1) by use of a bar coater, and thereafter the resultant was dried at 130° C. for 2 hours, thereby providing a laminate having a hard coating layer having a film thickness of about 3.0 μm.

The properties of the obtained adhesion layer-applied substrate and laminate were measured by the above methods. The measurement results are shown in Table 2.

### Comparative Example 5

25.6 g of the aqueous polymer particle (A-1) dispersion, 13.6 g of Snowtex PS-SO (trade name, manufactured by Nissan Chemical Corporation, silica having a linked shape, primary average particle size: 15 nm) as the inorganic oxide (B), 1.5 g of WM44-L70G (trade name, manufactured by Asahi Kasei Corporation, solid content concentration: 70% by mass) as the block polyisocyanate compound (C), 1.0 g of Tinuvin400 (trade name, manufactured by BASF Japan Ltd.) as an ultraviolet absorber, 40.3 g of water, and 18.1 g of ethanol were mixed under a room temperature condition, thereby providing a coating material composition of Comparative Example 6. In the coating material composition of Comparative Example 6, the mass ratio of the polymer particle (A) and the inorganic oxide (B) (polymer particle (A):inorganic oxide (B)) was 1:0.4.

Next, a polycarbonate substrate was coated with the coating material composition of Comparative Example 6 by use of a bar coater, and the resultant was dried at 130° C. for 2 hours, thereby forming an adhesion layer having a film thickness of about 5.0 μm on the polycarbonate substrate. In this way, an adhesion layer-applied substrate of Comparative Example 6 was obtained.

Further, the adhesion layer-applied substrate of Comparative Example 6 was coated with the composition liquid of hard coating layer (K-1) by use of a bar coater, and thereafter the resultant was dried at 130° C. for 2 hours, thereby providing a laminate having a hard coating layer having a film thickness of about 3.0 μm.

The properties of the obtained adhesion layer-applied substrate and laminate were measured by the above methods. The measurement results are shown in Table 2.

### Comparative Example 6

30.2 g of the aqueous polymer particle (A-1) dispersion, 8.2 g of Snowtex-C (trade name, manufactured by Nissan Chemical Corporation, silica having a spherical shape, primary average particle size: 12 nm) as the inorganic oxide (B), 0.4 g of WM44-L70G (trade name, manufactured by Asahi Kasei Corporation, solid content concentration: 70% by mass) as the block polyisocyanate compound (C), 1.2 g of Tinuvin400 (trade name, manufactured by BASF Japan Ltd.) as an ultraviolet absorber, 41.9 g of water, and 18.0 g of ethanol were mixed under a room temperature condition, thereby providing a coating material composition of Comparative Example 8. In the coating material composition of Comparative Example 8, the mass ratio of the polymer particle (A) and the inorganic oxide (B) (polymer particle (A):inorganic oxide (B)) was 1:0.27.

Next, a polycarbonate substrate was coated with the coating material composition of Comparative Example 8 by use of a bar coater, and the resultant was dried at 130° C. for 2 hours, thereby forming an adhesion layer having a film thickness of about 5.0 μm on the polycarbonate substrate. In this way, an adhesion layer-applied substrate of Comparative Example 8 was obtained.

Further, the adhesion layer-applied substrate of Comparative Example 8 was coated with the composition liquid of hard coating layer (K-1) by use of a bar coater, and thereafter the resultant was dried at 130° C. for 2 hours, thereby providing a laminate having a hard coating layer having a film thickness of about 3.0 μm.

The properties of the obtained adhesion layer-applied substrate and laminate were measured by the above methods. The measurement results are shown in Table 2.

TABLE 1

| | | | Exam- | Exam- | Exam- | Exam- | Exam- | Exam- | Exam- |
|---|---|---|---|---|---|---|---|---|---|
| | | | ple 1 | ple 2 | ple 3 | ple 4 | ple 5 | ple 6 | ple 7 |
| Adhesion | Polymer particle (A) | | A-1 | A-1 | — | — | — | — | — |
| layer- | Inorganic oxide (B) | | Snowtex | Snowtex | — | — | — | — | — |
| applied | | | PS-SO | OUP | | | | | |
| substrate | Composite (E) | | — | — | E-1 | E-1 | E-1 | E-1 | E-1 |
| | Light- | Ultra- | Tinuvin400 | Tinuvin400 | Tinuvin400 | Tinuvin400 | Tinuvin400 | Tinuvin400 | Tinuvin400 |
| | shielding | violet | | | | | | | |
| | agent (D) | absorber | | | | | | | |
| | | Hindered | — | — | — | — | Tinuvin123 | Tinuvin123 | Tinuvin123 |
| | | amine- | | | | | | | |
| | | based | | | | | | | |
| | | light | | | | | | | |
| | | stabilizer | | | | | | | |
| | Block polyisocyanate | | — | — | — | WM44- | WM44- | WM44- | WM44- |
| | compound (C) | | | | | L70G | L70G | L70G | L70G |
| | Arithmetic mean | | 76 | 58 | 60 | 87 | 90 | 32 | 80 |
| | height (Sa)/nm | | | | | | | | |
| | Metal (M) element | | 10.5 | 9.6 | 11.4 | 15.2 | 15.6 | 9.1 | 6.5 |
| | concentration/atomic % | | | | | | | | |
| | Transparency | | 24 | 22 | 20 | 14 | 19 | 16 | 19 |
| | (haze value H1) | | | | | | | | |
| | Average particle size (nm) | | 59 | 54 | 76 | 76 | 76 | 76 | 76 |
| | of mixture and/or composite | | | | | | | | |
| | (E) of polymer particle | | | | | | | | |
| | (A) and inorganic oxide (B) | | | | | | | | |
| | Mass ratio (polymer particle | | 1:0.7 | 1:0.65 | 1:1.5 | 1:1.5 | 1:1.5 | 1:1.5 | 1:1.5 |
| | (A):inorganic oxide (B)) | | | | | | | | |
| Hard | Polymer particle (F) | | F-1 | F-1 | F-1 | F-1 | F-1 | F-1 | F-1 |
| coating | Inorganic oxide (G) | | Snowtex | Snowtex | Snowtex | Snowtex | Snowtex | Snowtex | Snowtex |
| layer | | | OXS | OXS | OXS | OXS | OXS | OXS | OXS |
| | Hydrolyzable silicon | | h1 and | h1 and | h1 and | h1 and | h1 and | h1 and | h1 and |
| | compound (h) | | h2 | h2 | h2 | h2 | h2 | h2 | h2 |
| Laminate | Transparency | | 1 | 1 | 0.4 | 0.6 | 0.7 | 0.7 | 0.7 |
| | (haze value H2) | | | | | | | | |
| | Abrasion resistance | | S | S | S | S | S | S | S |
| | Initial adhesiveness | | Class 1 | Class 1 | Class 1 | Class 0 | Class 0 | Class 0 | Class 0 |
| | Chemical resistance | | S | S | S | S | S | S | S |
| | Durability | Moisture | Class 1 | Class 1 | Class 1 | Class 0 | Class 0 | Class 0 | Class 1 |
| | | resistance | | | | | | | |
| | | evaluation | | | | | | | |
| | | Hot water | Class 1 | Class 1 | Class 1 | Class 0 | Class 0 | Class 1 | Class 1 |
| | | resistance | | | | | | | |
| | | evaluation | | | | | | | |

| | | | | | | | |
|---|---|---|---|---|---|---|---|
| Weather resistance evaluation | A | A | A | A | S | S | S |

h1: 1,2-bis(triethoxysilyl)ethane,
h2: tris-(trimethoxysilylpropyl)isocyanurate

TABLE 2

| | | | Comparative | Comparative | Comparative | Comparative | Comparative | Comparative |
|---|---|---|---|---|---|---|---|---|
| | | | Exam- | Exam- | Exam- | Exam- | Exam- | Exam- |
| | | | ple 1 | ple 2 | ple 3 | ple 4 | ple 5 | ple 6 |
| Adhesion | Polymer particle (A) | | E2050S | E2050S | F-1 | A-1 | A-1 | A-1 |
| layer- | Inorganic oxide (B) | | Snowtex | Snowtex | Snowtex | Snowtex | Snowtex | Snowtex |
| applied | | | C | C | OXS | O | PS-SO | C |
| substrate | Composite (E) | | — | — | — | — | — | — |
| | Light- | Ultra- | Tinuvin400 | — | — | Tinuvin400 | Tinuvin400 | Tinuvin400 |
| | shielding | violet | | | | | | |
| | agent (D) | absorber | | | | | | |
| | | Hindered | Tinuvin123 | — | — | — | — | — |
| | | amine- | | | | | | |
| | | based | | | | | | |
| | | light | | | | | | |
| | | stabilizer | | | | | | |
| | Block polyisocyanate | | — | — | — | WM44- | WM44- | WM44- |
| | compound (C) | | | | | L70G | L70G | L70G |
| | Arithmetic mean | | 15 | 15 | 13 | 15 | 55 | 14 |
| | height (Sa)/nm | | | | | | | |
| | Metal (M) element | | 1.8 | 4.2 | 1.2 | 4.6 | 5.5 | 1.3 |
| | concentration/atomic % | | | | | | | |
| | Transparency | | 42 | 36 | 8 | 10 | 12 | 9 |
| | (haze value H1) | | | | | | | |
| | Average particle size (nm) | | 152 | 152 | 45 | 48 | 62 | 42 |
| | of mixture and/or composite | | | | | | | |
| | (E) of polymer particle | | | | | | | |
| | (A) and inorganic oxide (B) | | | | | | | |
| | Mass ratio (polymer particle | | 1:0.4 | 1:0.4 | 1:0.25 | 1:0.2 | 1:0.4 | 1:0.27 |
| | (A):inorganic oxide (B)) | | | | | | | |
| Hard | Polymer particle (F) | | F-1 | F-1 | F-1 | F-1 | F-1 | F-1 |
| coating | Inorganic oxide (G) | | Snowtex | Snowtex | Snowtex | Snowtex | Snowtex | Snowtex |
| layer | | | OXS | OXS | OXS | OXS | OXS | OXS |
| | Hydrolyzable silicon | | h′1 and | h1 and | h1 and | h1 and | h1 and | h1 and |
| | compound (h) | | h′2 | h2 | h2 | h2 | h2 | h2 |
| Laminate | Transparency | | 0.4 | 0.5 | 0.5 | 0.3 | 0.6 | 0.4 |
| | (haze value H2) | | | | | | | |
| | Abrasion resistance | | S | S | S | S | S | S |
| | Initial adhesiveness | | Class 2 | Class 2 | Class 5 | Class 3 | Class 0 | Class 5 |
| | Chemical resistance | | S | S | S | S | S | S |
| | Durability | Moisture | Class 4 | Class 4 | Class 5 | Class 5 | Class 3 | Class 5 |
| | | resistance | | | | | | |
| | | evaluation | | | | | | |
| | | Hot water | Class 4 | Class 4 | Class 5 | Class 5 | Class 3 | Class 5 |
| | | resistance | | | | | | |
| | | evaluation | | | | | | |

| | | | | | | |
|---|---|---|---|---|---|---|
| Weather resistance evaluation | A | B | B | A | A | A |

h1: 1,2-bis(triethoxysilyl)ethane,
h2: tris-(trimethoxysilylpropyl)isocyanurate
h′1: methyltrimethoxysilane,
h′2: tetraethoxysilane

### [Evaluation Results]

It was found from Table 1 that each of the laminates of Examples was excellent in abrasion resistance, adhesiveness, durability (moisture resistance and hot water resistance) and weather resistance and further excellent in transparency and chemical resistance.

### <<Examples Corresponding to Second Embodiment>>

Various physical properties in Examples and Comparative Examples described below (hereinafter, “Examples” and “Comparative Examples” in the section <<Examples corresponding to second embodiment>> respectively meaning “Examples corresponding to the second embodiment” and “Comparative Examples corresponding to the second embodiment”, unless particularly noted.) were measured according to the following methods.

### (1) Weight Average Molecular Weight of Unit (a) Included in Polymer Particle (A) and Composite (C)

The unit (a) extracted by diluting the polymer particle (A) obtained by a method described below to 0.5% by mass with dimethylformamide, and passing the dilution through a membrane filter having a pore diameter of 0.45 μm was measured by gel permeation chromatography, and the weight average molecular weight of the unit (a) included in the polymer particle (A) was calculated from the resulting chromatograph with reference to the molecular weight of standard polystyrene. “HLC-8420GPC” (manufactured by Tosoh Corporation) was used in the gel permeation chromatography. A total of four columns, “TSKgel guardcolumn SuperAW-H”, two columns of “TSKgel SuperAWM-H”, and “TSKgel SuperH-RC” (trade names, all manufactured by Tosoh Corporation), were used, and the measurement was performed under conditions of mobile phase: dimethylformamide, measurement temperature: 40° C., flow rate: 0.6 mL/min, and detector: RI.

The weight average molecular weight of the unit (a) included in the composite (C) obtained by a method described below was calculated in the same manner as above.

When the coating material composition included both the polymer particle (A) and the composite (C), the weight average molecular weight Mw of the units (a) in the coating material composition was calculated by the following expression in consideration of a mass ratio from the content W1 and the weight average molecular weight Mw1 of the unit (a) in the polymer particle (A) and the content W2 and the weight average molecular weight Mw2 of the unit (a) in the composite (C) (in which the contents W1 and W2 were determined from a loading ratio).

$$Mw = \{ Mw 1 \times ( W 1 / ( W 1 + W 2 ) ) + Mw 2 \times ( W 2 / ( W 1 + W 2 ) ) \} / 2$$

### (2) Average Particle Sizes of Polymer Particle (A), Inorganic Oxide (B), Mixture of Polymer Particle (A) and Inorganic Oxide (B), Composite (C), and Polymer Particle (F)

The average particle size of the polymer particle (A), the inorganic oxide (B), the mixture of a polymer particle (A) and an inorganic oxide (B), the composite (C), or the polymer particle (F) was obtained by using the polymer particle (A), the inorganic oxide (B), the mixture of a polymer particle (A) and an inorganic oxide (B), the composite (C), or the polymer particle (F) and measuring the cumulant particle sizes with a dynamic light scattering type particle size distribution measuring apparatus manufactured by Otsuka Electronics Co., Ltd. (item number: ELSZ-1000).

### (3) Coating Material Stability Evaluation of Coating Material Composition

The coating material composition was left to still stand under a room temperature environment for 1 hour in a container for preparation of the coating material composition from immediately after preparation, and the coating material stability was visually evaluated as follows from a coating material state after the still standing.
S: No aggregate occurred.
A: A small amount of an aggregate occurred (a state where attachment of an aggregate to the wall surface of the container was seen).
B: A large amount of an aggregate occurred (state where precipitation of an aggregate on the bottom of the container was seen).

### (4) pH of Coating Material Composition

The pH of the coating material composition was measured with a pH meter (HM-25R model) manufactured by DKK-TOA Corporation.

### (5) Evaluation of Transparency of Adhesion Layer (I)-Applied Substrate and Laminate (K)

The transparency of the adhesion layer (I)-applied substrate or the laminate (K) was evaluated from a haze value measured with a turbidimeter (item number: NDH5000SP) manufactured by Nippon Denshoku Industries Co., Ltd., according to the method prescribed in JIS K7136. The haze value H1 was measured by the method with, as a target, the adhesion layer-applied substrate. The haze value H2 was measured by the method with, as a target, the laminate (adhesion layer (I)-applied substrate and hard coating layer (J)).

### (6) Measurements of Martens Hardness HMG and Elastic Recovery Rate η_{ITG} of Polymer Nanoparticle (G)

The Martens hardness HMG of the polymer nanoparticle (G) was measured by coating a glass substrate (material: white plate glass, thickness: 2 mm) with an aqueous polymer nanoparticle (G) dispersion by use of a bar coater so that the film thickness was 3 μm, and drying the resultant at 130° C. over 2 hours to thereby provide a coating film, and subjecting the coating film to measurement with, as a target, a surface on which the coating film was to be formed. The microhardness was measured by an indentation test (test conditions; indenter: Vickers quadrangular pyramid diamond indenter, loading condition: 2 mN/20 sec, unloading condition: 2 mN/20 sec) with a Fischer scope manufactured by Fischer Instruments K.K. (item number: HM2000S), and the Martens hardness HMG of the polymer nanoparticle (G) was measured based on an indentation test according to ISO14577-1. The microhardness of the coating film obtained as described above was measured by an indentation test (test conditions; indenter: Vickers quadrangular pyramid diamond indenter, loading condition: 2 mN/20 sec, unloading condition: 2 mN/20 sec) with a Fischer scope manufactured by Fischer Instruments K.K. (item number: HM2000S), and the ratio of the elastic return deformation workload Wₑₗₐₛₜ of a depression to the total mechanical workload Wₜₒₜₐₗ of a depression, namely, the value of Wₑₗₐₛₜ/Wₜₒₜₐₗ was determined as the elastic recovery rate η_{ITG} of the polymer nanoparticle (G), based on an indentation test method according to ISO14577-1.

### (7) Measurements of Martens Hardness HMH′ and Elastic Recovery Rate η_{ITH′} of Component (H′)

The Martens hardness HMH′ of the component (H′) was determined by dissolving or dispersing the component (H′) in water/ethanol/acetic acid (compositional ratio: 77% by mass/20% by mass/3% by mass) so that the solid content concentration was 8% by mass, coating a glass substrate (material: white plate glass, thickness: 2 mm) with the resulting solution by use of a bar coater so that the film thickness was 3 μm, drying the resultant at 130° C. over 2 hours to thereby provide a coating film, and subjecting the coating film to measurement. The microhardness was measured by an indentation test (test conditions; indenter: Vickers quadrangular pyramid diamond indenter, loading condition: 2 mN/20 sec, unloading condition: 2 mN/20 sec) with a Fischer scope manufactured by Fischer Instruments K.K. (item number: HM2000S), and the HMH′ and η_{ITH′} (Wₑₗₐₛₜ/Wₜₒₜₐₗ) were measured based on an indentation test method according to ISO14577-1. The component (H) corresponded to the hydrolyzed condensate of the corresponding component (H′), as described below, and thus the respective values of the Martens hardness HMH and the elastic recovery rate η_{ITH} were determined under the assumption that the respective values of the Martens hardness HM_{B′} and the elastic recovery rate η_{ITH′} of the component (H′), measured as described above, were well matched with the values of the Martens hardness HMH and the elastic recovery rate η_{ITH} of the matrix component (H).

### (8) Evaluation of Abrasion Resistance of Laminate (K)

Evaluation of the abrasion resistance of the laminate (K) was performed with a Taber type abrasion tester (No. 101) manufactured by Yasuda Seiki Company, according to the standard of ASTM D1044. In other words, the Taber abrasion test was performed under conditions of an abrasive wheel CS-10F and a load of 500 g, the haze before the test and the haze at rotation number of 500 were each measured with a turbidimeter (item number: NDH5000SP) manufactured by Nippon Denshoku Industries Co., Ltd., according to the method prescribed in JIS R3212, and the difference (ΔHaze) from the haze before the test was determined to thereby evaluate the abrasion resistance as follows.
Rotation number: 500
   S: ΔHaze of 4 or less
   A: ΔHaze of more than 4 and 10 or less
   B: ΔHaze of more than 10

### (9) Adhesiveness Evaluation of Adhesion Layer (I) and Hard Coating Layer (J)

### <Cross-Scoring Test>

The hard coating layer of the laminate was cut into 25 cells at 1-mm intervals by a cutter blade according to a cross-cut method prescribed in JIS K5600-5-6, a tape (tape according to the cross-cut test/cross-scoring test, manufactured by Nichiban Co., Ltd.) was applied to and peeled from the cells, and the adhesiveness was evaluated as described below from the number of cells in which the coating film remained. The adhesion layer (I) of the adhesion layer (I)-applied substrate was subjected to the same operation as above, and the adhesiveness of the adhesion layer (I) was evaluated as described below.
S: 25 cells
A: 20 to 24 cells
B: 10 to 19 cells
C: Less than 10 cells

### (10) Evaluation of Weather Resistance

The weather resistance of the laminate (K) was determined by performing ultraviolet irradiation of the hard coating layer of the laminate from a xenon arc (product name SX-75 manufactured by Suga Test Instruments Co., Ltd.) according to the conditions of the standards of ANSI/SAE Z26.1, to provide the Δb before and after irradiation at 2000 MJ/m², and was evaluated as follows.

$$S : Δ b < 1$$

$$A : Δ b = 1 to 4$$

$$B : Δ b > 4$$

### (11) Evaluation of Heat Resistance

In evaluation of the heat resistance of the laminate (K), the laminate was left to still stand for 24 hours in a dryer of 120° C., and thereafter, change in outer appearance was visually evaluated as described below.
S: No crack
A: Partial cracks
B: Whole cracks
C: Cracks during film formation

### (12) Evaluation of Chemical Resistance

Evaluation of the chemical resistance of the laminate (K) was performed by an immersion test on five chemicals according to ECE UN R43, and the evaluation was made as described below from the number of chemicals that caused change in outer appearance of the laminate (K) after the immersion test among the five chemicals.
S: 0 out of the chemicals
A: 1 or 2 out of the chemicals
B: 3 to 5 out of the chemicals

### (13) Mass Ratio (Content) of Each Component

The content of the unit (a-2) in the unit (a) was determined by a loading ratio from the amount of loading of 2-hydroxyethyl methacrylate.

The mass ratio of the unit (a-1) and the organic ultraviolet absorber (D) was determined as a loading ratio of the monomer (a) and the component D.

### (14) NCO/OH Molar Ratio

The NCO/OH molar ratio was calculated from the amounts of 2-hydroxyethyl methacrylate and 2-hydroxyethylacrylamide used and the amount of the block polyisocyanate compound (E) used. Herein, the molar number of NCO was calculated from the amount of loading and effective NCO %.

### (15) Ratio of Inorganic Oxide (B) to Solid Content of Coating Material Composition

The ratio of the inorganic oxide (B) to the solid content of the coating material composition was calculated by a loading ratio from the mass ratio of the component B to the total mass of the coating material composition in loading except for the mass of the solvent (M) (solid content mass of the coating material composition).

### [Preparation of Aqueous Polymer Particle (A-1) Dispersion]

An aqueous polymer particle (A-1) dispersion was synthesized as follows.

### <Aqueous Polymer Particle (A-1) Dispersion>

Polymerization according to a common emulsion polymerization method was performed with a monomer mixture liquid in which 500 g of ion-exchange water, 22 g of an aqueous 10% dodecylbenzene sulfonic acid solution, 28 g of an aqueous 2% ammonium persulfate solution, and 5.8 g of ultraviolet-absorptive vinyl monomer “RUVA-93” (trade name, manufactured by Otsuka Chemical Co., Ltd.) were dissolved in a mixture of 62.1 g of butyl acrylate, 46.0 g of 2-hydroxyethyl methacrylate, 1.2 g of acrylic acid, and 0.58 g of 1-dodecanethiol in a reactor having a reflux condenser, a driptank, a thermometer and a stirring apparatus in an environment at 80° C. After the polymerization, the resultant was filtered with a 100-mesh wire gauze, and the solid content concentration was adjusted to 15% by mass with purified water, thereby providing an aqueous polymer particle (A-1) dispersion. The resulting polymer particle (A-1) had a particle size of 39 nm and the weight average molecular weight of the unit (a) was 600000.

### [Preparation of Composite (C) of Polymer Particle (A) and Inorganic Oxide (B)]

An aqueous composite (C) dispersion for use in Examples described below was synthesized as follows.

### <Aqueous Composite (C-1) Dispersion>

Polymerization according to a common emulsion polymerization method was performed with a monomer mixture liquid in which 150 g of ion-exchange water, 1150 g of colloidal silica “Snowtex PS-SO” (trade name, manufactured by Nissan Chemical Corporation, solid content: 15% by mass, average particle size based on the dynamic light scattering method: 80 nm) dispersed in water, serving as the inorganic oxide (B), 33 g of an aqueous 10% dodecylbenzene sulfonic acid solution, 42 g of an aqueous 2% ammonium persulfate solution, and 8.6 g of ultraviolet-absorptive vinyl monomer “RUVA-93” (trade name, manufactured by Otsuka Chemical Co., Ltd.) were dissolved in a mixture of 162.2 g of butyl acrylate, 1.7 g of acrylic acid, and 0.86 g of 1-dodecanethiol in a reactor having a reflux condenser, a driptank, a thermometer and a stirring apparatus in an environment at 80° C. After the polymerization, the resultant was pH-adjusted to 8 with an aqueous 25% ammonia solution and filtered with a 100-mesh wire gauze, and the solid content concentration was adjusted to 15% with purified water, thereby providing an aqueous composite (C-1) dispersion. The resulting composite (C-1) had an average particle size of 40 nm and the weight average molecular weight of the unit (a) was 1600000.

### <Aqueous Composite (C-2) Dispersion>

Polymerization according to a common emulsion polymerization method was performed with a monomer mixture liquid in which 150 g of ion-exchange water, 1150 g of colloidal silica “Snowtex PS-SO” (trade name, manufactured by Nissan Chemical Corporation, solid content: 15% by mass) dispersed in water, serving as the inorganic oxide (B), 33 g of an aqueous 10% dodecylbenzene sulfonic acid solution, 42 g of an aqueous 2% ammonium persulfate solution, and 8.6 g of ultraviolet-absorptive vinyl monomer “RUVA-93” (trade name, manufactured by Otsuka Chemical Co., Ltd.) were dissolved in a mixture of 144.9 g of butyl acrylate, 17.3 g of 2-hydroxyethyl methacrylate, 1.7 g of acrylic acid, and 1.73 g of 1-dodecanethiol in a reactor having a reflux condenser, a driptank, a thermometer and a stirring apparatus in an environment at 80° C. After the polymerization, the resultant was pH-adjusted to 9 with an aqueous 25% ammonia solution and filtered with a 100-mesh wire gauze, and the solid content concentration was adjusted to 15% with purified water, thereby providing an aqueous composite (C-2) dispersion. The resulting composite (C-2) had an average particle size of 48 nm and the weight average molecular weight of the unit (a) was 200000.

### <Aqueous Composite (C-3) Dispersion>

Polymerization according to a common emulsion polymerization method was performed with a monomer mixture liquid in which 150 g of ion-exchange water, 1150 g of colloidal silica “Snowtex PS-SO” (trade name, manufactured by Nissan Chemical Corporation, solid content: 15% by mass) dispersed in water, serving as the inorganic oxide (B), 33 g of an aqueous 10% dodecylbenzene sulfonic acid solution, 42 g of an aqueous 2% ammonium persulfate solution, and 8.6 g of ultraviolet-absorptive vinyl monomer “RUVA-93” (trade name, manufactured by Otsuka Chemical Co., Ltd.) were dissolved in a mixture of 127.7 g of butyl acrylate, 34.5 g of 2-hydroxyethyl methacrylate, 1.7 g of acrylic acid, and 0.43 g of 1-dodecanethiol in a reactor having a reflux condenser, a driptank, a thermometer and a stirring apparatus in an environment at 80° C. After the polymerization, the resultant was pH-adjusted to 9 with an aqueous 25% ammonia solution and filtered with a 100-mesh wire gauze, and the solid content concentration was adjusted to 15% with purified water, thereby providing an aqueous composite (C-3) dispersion. The resulting composite (C-3) had an average particle size of 56 nm and the weight average molecular weight of the unit (a) was 900000.

### <Aqueous Composite (C-4) Dispersion>

Polymerization according to a common emulsion polymerization method was performed with a monomer mixture liquid in which 150 g of ion-exchange water, 1150 g of colloidal silica “Snowtex PS-SO” (trade name, manufactured by Nissan Chemical Corporation, solid content: 15% by mass) dispersed in water, serving as the inorganic oxide (B), 33 g of an aqueous 10% dodecylbenzene sulfonic acid solution, 42 g of an aqueous 2% ammonium persulfate solution, and 8.6 g of ultraviolet-absorptive vinyl monomer “RUVA-93” (trade name, manufactured by Otsuka Chemical Co., Ltd.) were dissolved in a mixture of 127.7 g of butyl acrylate, 34.5 g of 2-hydroxyethyl methacrylate, 1.7 g of acrylic acid, and 0.17 g of 1-dodecanethiol in a reactor having a reflux condenser, a driptank, a thermometer and a stirring apparatus in an environment at 80° C. After the polymerization, the resultant was pH-adjusted to 10 with an aqueous 25% ammonia solution and filtered with a 100-mesh wire gauze, and the solid content concentration was adjusted to 15% with purified water, thereby providing an aqueous composite (C-4) dispersion. The resulting composite (C-4) had an average particle size of 54 nm and the weight average molecular weight of the unit (a) was 4400000.

### <Aqueous Composite (C-5) Dispersion>

Polymerization according to a common emulsion polymerization method was performed with a monomer mixture liquid in which 150 g of ion-exchange water, 1150 g of colloidal silica “Snowtex PS-SO” (trade name, manufactured by Nissan Chemical Corporation, solid content: 15% by mass) dispersed in water, serving as the inorganic oxide (B), 22 g of an aqueous 10% dodecylbenzene sulfonic acid solution, 28 g of an aqueous 2% ammonium persulfate solution, and 5.8 g of ultraviolet-absorptive vinyl monomer “RUVA-93” (trade name, manufactured by Otsuka Chemical Co., Ltd.) were dissolved in a mixture of 62.1 g of butyl acrylate, 46.0 g of 2-hydroxyethyl methacrylate, 1.2 g of acrylic acid, and 0.58 g of 1-dodecanethiol in a reactor having a reflux condenser, a driptank, a thermometer and a stirring apparatus in an environment at 80° C. After the polymerization, the resultant was pH-adjusted to 9 with an aqueous 25% ammonia solution and filtered with a 100-mesh wire gauze, and the solid content concentration was adjusted to 15% with purified water, thereby providing an aqueous composite (C-5) dispersion. The resulting composite (C-5) had an average particle size of 68 nm and the weight average molecular weight of the unit (a) was 600000.

### <Aqueous Composite (C-6) Dispersion>

Polymerization according to a common emulsion polymerization method was performed with a monomer mixture liquid in which 150 g of ion-exchange water, 1150 g of colloidal silica “Snowtex PS-SO” (trade name, manufactured by Nissan Chemical Corporation, solid content: 15% by mass) dispersed in water, serving as the inorganic oxide (B), 22 g of an aqueous 10% dodecylbenzene sulfonic acid solution, 28 g of an aqueous 2% ammonium persulfate solution, and 5.8 g of ultraviolet-absorptive vinyl monomer “RUVA-93” (trade name, manufactured by Otsuka Chemical Co., Ltd.) were dissolved in a mixture of 50.6 g of butyl acrylate, 57.5 g of 2-hydroxyethyl methacrylate, 1.2 g of acrylic acid, and 0.58 g of 1-dodecanethiol in a reactor having a reflux condenser, a driptank, a thermometer and a stirring apparatus in an environment at 80° C. After the polymerization, the resultant was pH-adjusted to 7.5 with an aqueous 25% ammonia solution and filtered with a 100-mesh wire gauze, and the solid content concentration was adjusted to 15% with purified water, thereby providing an aqueous composite (C-6) dispersion. The resulting composite (C-6) had an average particle size of 79 nm and the weight average molecular weight of the unit (a) was 400000.

### <Aqueous Composite (C-7) Dispersion>

Polymerization according to a common emulsion polymerization method was performed with a monomer mixture liquid of 150 g of ion-exchange water, 1150 g of colloidal silica “Snowtex PS-SO” (trade name, manufactured by Nissan Chemical Corporation, solid content: 15% by mass) dispersed in water, serving as the inorganic oxide (B), 22 g of an aqueous 10% dodecylbenzene sulfonic acid solution, 28 g of an aqueous 2% ammonium persulfate solution, 67.9 g of butyl acrylate, 46.0 g of 2-hydroxyethyl methacrylate, and 1.2 g of acrylic acid in a reactor having a reflux condenser, a driptank, a thermometer and a stirring apparatus in an environment at 80° C. After the polymerization, the resultant was pH-adjusted to 9.0 with an aqueous 25% ammonia solution and filtered with a 100-mesh wire gauze, and the solid content concentration was adjusted to 15% with purified water, thereby providing an aqueous composite (C-7) dispersion. The resulting composite (C-7) had an average particle size of 65 nm and the weight average molecular weight of the unit (a) was 7200000.

### [Preparation of Aqueous Polymer Nanoparticle (G) Dispersion]

An aqueous polymer nanoparticle (G) dispersion for use in Examples described below was synthesized as follows.

### <Aqueous Polymer Nanoparticle (G-1) Dispersion>

Polymerization according to a common emulsion polymerization method was performed with 1500 g of ion-exchange water, 45 g of an aqueous 10% dodecylbenzene sulfonic acid solution, 105 g of methyltrimethoxysilane, 23 g of phenyltrimethoxysilane and 27 g of tetraethoxysilane in a reactor having a reflux condenser, a driptank, a thermometer and a stirring apparatus in an environment at 50° C. After the polymerization, the temperature was set to 80° C., thereafter polymerization according to a common emulsion polymerization method was further performed with 43 g of an aqueous 2% ammonium persulfate solution, 11 g of butyl acrylate, 12 g of diethylacrylamide, 1 g of acrylic acid and 1 g of 3-methacryloxypropyltrimethoxysilane, and the resultant was filtered with a 100-mesh wire gauze, and the solid content concentration was adjusted to 5% with purified water, thereby providing an aqueous polymer nanoparticle (G-1) dispersion. The resulting polymer nanoparticle (G-1) had a core/shell structure and the average particle size thereof was 60 nm. The polymer particle (G-1) had a Martens hardness HMG of 150 N/mm³ and an elastic recovery rate η_{ITG} of 0.70, as measured according to the above measurement methods.

### [Preparation of Coating Composition Liquid of Matrix Raw Material Component (H′)]

A coating composition liquid of each matrix raw material component (H′) for use in Examples described below was prepared as follows.

### <Coating Composition Liquid of Matrix Raw Material Component (H′-1)>

A coating composition liquid of matrix raw material component (H′-1) was obtained by mixing 35 g of 1,2-bis(triethoxysilyl)ethane and 81 g of tris-(trimethoxysilylpropyl)isocyanurate each serving as the hydrolyzable silicon compound (h), and 333 g of colloidal silica “Snowtex OXS” (trade name, manufactured by Nissan Chemical Corporation, solid content: 10% by mass, average particle size based on the TEM observation method: 5 nm) dispersed in water, serving as the inorganic oxide (F), under a room temperature condition. The matrix raw material component (H′-1) had a Martens hardness HMH′ of 420 N/mm³ and an elastic recovery rate η_{ITH′} of 0.71, as measured according to the above measurement methods.

### [Preparation of Composition Liquid of Hard Coating Layer]

### <Composition Liquid of Hard Coating Layer (J-1)>

The aqueous polymer nanoparticle (G-1) dispersion prepared above and matrix raw material component (H′-1) prepared above were mixed so that the mass ratio of the respective solid contents of the polymer nanoparticle (G) and the matrix component (H) satisfied (G-1):(H-1)=100:200, thereby providing a mixture. An aqueous solution having an ethanol concentration of 20% by mass was used as a solvent, and the mixture was added thereto so that the solid content concentration was 10% by mass, thereby providing a hard coating composition liquid (J-1). The hard coating layer (J-1) had a Martens hardness HMJ′ of 380 N/mm³ and an elastic recovery rate η_{ITJ} of 0.70, as measured according to the above measurement methods.

### Example 1

15 g of the polymer particle (A-1), 19 g of colloidal silica “Snowtex PS-SO” (trade name, manufactured by Nissan Chemical Corporation, solid content: 15% by mass) dispersed in water as the inorganic oxide (B), 0.52 g of Tinuvin400 (trade name, manufactured by BASF Japan Ltd., solid content concentration: 85%) as an organic ultraviolet absorber, 0.07 g of Tinuvin123 (trade name, manufactured by BASF Japan Ltd.) as a light stabilizer, 2.15 g of WM44-L70G (trade name, manufactured by Asahi Kasei Corporation, solid content concentration: 70% by mass, effective NCO: 5.3% by mass) as a curing agent, 12.86 g of water, and 10 g of ethanol were mixed under a room temperature condition, and the pH was adjusted to 10.0 with an aqueous 25% ammonia solution, thereby providing a coating material composition of Example 1. The coating material composition had a solid content concentration of 12% by mass.

Next, a polycarbonate substrate was coated with the coating material composition of Example 1 by use of a bar coater, and the resultant was dried at 130° C. for 1 hour, thereby forming an adhesion layer having a film thickness of 5.0 μm on the polycarbonate substrate. In this way, an adhesion layer-applied substrate of Example 1 was obtained.

Further, the adhesion layer-applied substrate of Example 1 was coated with the composition liquid of hard coating layer (J-1) by use of a bar coater, and thereafter the resultant was dried at 130° C. for 1.5 hours, thereby providing a laminate having a hard coating layer having a film thickness of 3.0 μm.

Results of subjecting the coating material composition, the adhesion layer-applied substrate, and the laminate of Example 1 to various evaluations are shown in Table 3.

### Example 2

30 g of the aqueous composite (C-1) dispersion, 0.51 g of Tinuvin400 (trade name, manufactured by BASF Japan Ltd., solid content concentration: 85%) as an organic ultraviolet absorber, 0.07 g of Tinuvin123 (trade name, manufactured by BASF Japan Ltd.) as a light stabilizer, 3.90 g of water, and 6.91 g of ethanol were mixed under a room temperature condition, thereby providing a coating material composition of Example 2. The coating material composition had a solid content concentration of 12% by mass and a pH of 7.5.

Next, a polycarbonate substrate was coated with the coating material composition of Example 2 by use of a bar coater, and the resultant was dried at 130° C. for 1 hour, thereby forming an adhesion layer having a film thickness of 5.0 μm on the polycarbonate substrate. In this way, an adhesion layer-applied substrate of Example 2 was obtained.

Further, the adhesion layer-applied substrate of Example 2 was coated with the composition liquid of hard coating layer (J-1) by use of a bar coater, and thereafter the resultant was dried at 130° C. for 1.5 hours, thereby providing a laminate having a hard coating layer having a film thickness of 3.0 μm.

Results of subjecting the coating material composition, the adhesion layer-applied substrate, and the laminate of Example 2 to various evaluations are shown in Table 3.

### Example 3

30 g of the aqueous composite (C-2) dispersion, 0.51 g of Tinuvin400 (trade name, manufactured by BASF Japan Ltd., solid content concentration: 85%) as an organic ultraviolet absorber, 0.07 g of Tinuvin123 (trade name, manufactured by BASF Japan Ltd.) as a light stabilizer, 0.53 g of WM44-L70G (trade name, manufactured by Asahi Kasei Corporation, solid content concentration: 70% by mass, effective NCO: 5.3% by mass) as a curing agent, 6.06 g of water, and 7.45 g of ethanol were mixed under a room temperature condition, thereby providing a coating material composition of Example 3. The coating material composition had a solid content concentration of 12% by mass and a pH of 8.5.

Next, a polycarbonate substrate was coated with the coating material composition of Example 3 by use of a bar coater, and the resultant was dried at 130° C. for 1 hour, thereby forming an adhesion layer having a film thickness of 5.0 μm on the polycarbonate substrate. In this way, an adhesion layer-applied substrate of Example 3 was obtained.

Further, the adhesion layer-applied substrate of Example 3 was coated with the composition liquid of hard coating layer (J-1) by use of a bar coater, and thereafter the resultant was dried at 130° C. for 1.5 hours, thereby providing a laminate having a hard coating layer having a film thickness of 3.0 μm.

Results of subjecting the coating material composition, the adhesion layer-applied substrate, and the laminate of Example 3 to various evaluations are shown in Table 3.

### Example 4

30 g of the aqueous composite (C-3) dispersion, 0.52 g of Tinuvin400 (trade name, manufactured by BASF Japan Ltd., solid content concentration: 85%) as an organic ultraviolet absorber, 0.07 g of Tinuvin123 (trade name, manufactured by BASF Japan Ltd.) as a light stabilizer, 1.07 g of WM44-L70G (trade name, manufactured by Asahi Kasei Corporation, solid content concentration: 70% by mass, effective NCO: 5.3% by mass) as a curing agent, 8.29 g of water, and 8.01 g of ethanol were mixed under a room temperature condition, thereby providing a coating material composition of Example 4. The coating material composition had a solid content concentration of 12% by mass and a pH of 8.3.

Next, a polycarbonate substrate was coated with the coating material composition of Example 4 by use of a bar coater, and the resultant was dried at 130° C. for 1 hour, thereby forming an adhesion layer having a film thickness of 5.0 μm on the polycarbonate substrate. In this way, an adhesion layer-applied substrate of Example 4 was obtained.

Further, the adhesion layer-applied substrate of Example 4 was coated with the composition liquid of hard coating layer (J-1) by use of a bar coater, and thereafter the resultant was dried at 130° C. for 1.5 hours, thereby providing a laminate having a hard coating layer having a film thickness of 3.0 μm.

Results of subjecting the coating material composition, the adhesion layer-applied substrate, and the laminate of Example 4 to various evaluations are shown in Table 3.

### Example 5

30 g of the aqueous composite (C-4) dispersion, 0.52 g of Tinuvin400 (trade name, manufactured by BASF Japan Ltd., solid content concentration: 85%) as an organic ultraviolet absorber, 0.07 g of Tinuvin123 (trade name, manufactured by BASF Japan Ltd.) as a light stabilizer, 1.07 g of WM44-L70G (trade name, manufactured by Asahi Kasei Corporation, solid content concentration: 70% by mass, effective NCO: 5.3% by mass) as a curing agent, 8.30 g of water, and 8.01 g of ethanol were mixed under a room temperature condition, thereby providing a coating material composition of Example 5. The coating material composition had a solid content concentration of 12% by mass and a pH of 9.4.

Next, a polycarbonate substrate was coated with the coating material composition of Example 5 by use of a bar coater, and the resultant was dried at 130° C. for 1 hour, thereby forming an adhesion layer having a film thickness of 5.0 μm on the polycarbonate substrate. In this way, an adhesion layer-applied substrate of Example 5 was obtained.

Further, the adhesion layer-applied substrate of Example 5 was coated with the composition liquid of hard coating layer (J-1) by use of a bar coater, and thereafter the resultant was dried at 130° C. for 1.5 hours, thereby providing a laminate having a hard coating layer having a film thickness of 3.0 μm.

Results of subjecting the coating material composition, the adhesion layer-applied substrate, and the laminate of Example 5 to various evaluations are shown in Table 3.

### Example 6

30 g of the aqueous composite (C-5) dispersion, 0.41 g of Tinuvin400 (trade name, manufactured by BASF Japan Ltd., solid content concentration: 85%) as an organic ultraviolet absorber, 0.06 g of Tinuvin123 (trade name, manufactured by BASF Japan Ltd.) as a light stabilizer, 1.71 g of WM44-L70G (trade name, manufactured by Asahi Kasei Corporation, solid content concentration: 70% by mass, effective NCO: 5.3% by mass) as a curing agent, 10.30 g of water, and 8.60 g of ethanol were mixed under a room temperature condition, thereby providing a coating material composition of Example 6. The coating material composition had a solid content concentration of 12% by mass and a pH of 8.1.

Next, a polycarbonate substrate was coated with the coating material composition of Example 6 by use of a bar coater, and the resultant was dried at 130° C. for 1 hour, thereby forming an adhesion layer having a film thickness of 5.0 μm on the polycarbonate substrate. In this way, an adhesion layer-applied substrate of Example 6 was obtained.

Further, the adhesion layer-applied substrate of Example 6 was coated with the composition liquid of hard coating layer (J-1) by use of a bar coater, and thereafter the resultant was dried at 130° C. for 1.5 hours, thereby providing a laminate having a hard coating layer having a film thickness of 3.0 μm.

Results of subjecting the coating material composition, the adhesion layer-applied substrate, and the laminate of Example 6 to various evaluations are shown in Table 3.

### Example 7

30 g of the aqueous composite (C-5) dispersion, 0.40 g of a mixture (“U1” in Table 3, solid content ratio: 85/15, solid content concentration: 87.0%) of Tinuvin400 (trade name, manufactured by BASF Japan Ltd., solid content concentration: 85%) and Tinuvin479 (trade name, manufactured by BASF Japan Ltd., solid content concentration: 100%) as an ultraviolet absorber, 0.06 g of Tinuvin123 (trade name, manufactured by BASF Japan Ltd.) as a light stabilizer, 1.71 g of WM44-L70G (trade name, manufactured by Asahi Kasei Corporation, solid content concentration: 70% by mass, effective NCO: 5.3% by mass) as a curing agent, 10.24 g of water, and 8.59 g of ethanol were mixed under a room temperature condition, thereby providing a coating material composition of Example 7. The coating material composition had a solid content concentration of 12% by mass and a pH of 8.3.

Next, a polycarbonate substrate was coated with the coating material composition of Example 7 by use of a bar coater, and the resultant was dried at 130° C. for 1 hour, thereby forming an adhesion layer having a film thickness of 5.0 μm on the polycarbonate substrate. In this way, an adhesion layer-applied substrate of Example 7 was obtained.

Further, the adhesion layer-applied substrate of Example 7 was coated with the composition liquid of hard coating layer (J-1) by use of a bar coater, and thereafter the resultant was dried at 130° C. for 1.5 hours, thereby providing a laminate having a hard coating layer having a film thickness of 3.0 μm.

Results of subjecting the coating material composition, the adhesion layer-applied substrate, and the laminate of Example 7 to various evaluations are shown in Table 3.

### Example 8

30 g of the aqueous composite (C-6) dispersion, 0.41 g of Tinuvin400 (trade name, manufactured by BASF Japan Ltd., solid content concentration: 85%) as an organic ultraviolet absorber, 0.06 g of Tinuvin123 (trade name, manufactured by BASF Japan Ltd.) as a light stabilizer, 2.13 g of WM44-L70G (trade name, manufactured by Asahi Kasei Corporation, solid content concentration: 70% by mass, effective NCO: 5.3% by mass) as a curing agent, 12.05 g of water, and 9.04 g of ethanol were mixed under a room temperature condition, thereby providing a coating material composition of Example 8. The coating material composition had a solid content concentration of 12% by mass and a pH of 7.1.

Next, a polycarbonate substrate was coated with the coating material composition of Example 8 by use of a bar coater, and the resultant was dried at 130° C. for 1 hour, thereby forming an adhesion layer having a film thickness of 5.0 μm on the polycarbonate substrate. In this way, an adhesion layer-applied substrate of Example 8 was obtained.

Further, the adhesion layer-applied substrate of Example 8 was coated with the composition liquid of hard coating layer (J-1) by use of a bar coater, and thereafter the resultant was dried at 130° C. for 1.5 hours, thereby providing a laminate having a hard coating layer having a film thickness of 3.0 μm.

Results of subjecting the coating material composition, the adhesion layer-applied substrate, and the laminate of Example 8 to various evaluations are shown in Table 3.

### Example 9

30 g of the aqueous composite (C-5) dispersion, 0.10 g of Tinuvin400 (trade name, manufactured by BASF Japan Ltd., solid content concentration: 85%) as an organic ultraviolet absorber, 0.01 g of Tinuvin123 (trade name, manufactured by BASF Japan Ltd.) as a light stabilizer, 3.41 g of WM44-L70G (trade name, manufactured by Asahi Kasei Corporation, solid content concentration: 70% by mass, effective NCO: 5.3% by mass) as a curing agent, 15.50 g of water, and 10.16 g of ethanol were mixed under a room temperature condition, thereby providing a coating material composition of Example 9. The coating material composition had a solid content concentration of 12% by mass and a pH of 8.2.

Next, a polycarbonate substrate was coated with the coating material composition of Example 9 by use of a bar coater, and the resultant was dried at 130° C. for 1 hour, thereby forming an adhesion layer having a film thickness of 5.0 μm on the polycarbonate substrate. In this way, an adhesion layer-applied substrate of Example 9 was obtained.

Further, the adhesion layer-applied substrate of Example 9 was coated with the composition liquid of hard coating layer (J-1) by use of a bar coater, and thereafter the resultant was dried at 130° C. for 1.5 hours, thereby providing a laminate having a hard coating layer having a film thickness of 3.0 μm.

Results of subjecting the coating material composition, the adhesion layer-applied substrate, and the laminate of Example 9 to various evaluations are shown in Table 4.

### Example 10

30 g of the aqueous composite (C-5) dispersion, 0.21 g of Tinuvin400 (trade name, manufactured by BASF Japan Ltd., solid content concentration: 85%) as an organic ultraviolet absorber, 0.03 g of Tinuvin123 (trade name, manufactured by BASF Japan Ltd.) as a light stabilizer, 3.41 g of WM44-L70G (trade name, manufactured by Asahi Kasei Corporation, solid content concentration: 70% by mass, effective NCO: 5.3% by mass) as a curing agent, 16.10 g of water, and 10.23 g of ethanol were mixed under a room temperature condition, thereby providing a coating material composition of Example 10. The coating material composition had a solid content concentration of 12% by mass and a pH of 8.3.

Next, a polycarbonate substrate was coated with the coating material composition of Example 10 by use of a bar coater, and the resultant was dried at 130° C. for 1 hour, thereby forming an adhesion layer having a film thickness of 5.0 μm on the polycarbonate substrate. In this way, an adhesion layer-applied substrate of Example 10 was obtained.

Further, the adhesion layer-applied substrate of Example 10 was coated with the composition liquid of hard coating layer (J-1) by use of a bar coater, and thereafter the resultant was dried at 130° C. for 1.5 hours, thereby providing a laminate having a hard coating layer having a film thickness of 3.0 μm.

Results of subjecting the coating material composition, the adhesion layer-applied substrate, and the laminate of Example 10 to various evaluations are shown in Table 4.

### Example 11

30 g of the aqueous composite (C-5) dispersion, 0.62 g of Tinuvin400 (trade name, manufactured by BASF Japan Ltd., solid content concentration: 85%) as an organic ultraviolet absorber, 0.09 g of Tinuvin123 (trade name, manufactured by BASF Japan Ltd.) as a light stabilizer, 1.28 g of WM44-L70G (trade name, manufactured by Asahi Kasei Corporation, solid content concentration: 70% by mass, effective NCO: 5.3% by mass) as a curing agent, 9.75 g of water, and 8.29 g of ethanol were mixed under a room temperature condition, thereby providing a coating material composition of Example 11. The coating material composition had a solid content concentration of 12% by mass and a pH of 8.6.

Next, a polycarbonate substrate was coated with the coating material composition of Example 11 by use of a bar coater, and the resultant was dried at 130° C. for 1 hour, thereby forming an adhesion layer having a film thickness of 5.0 μm on the polycarbonate substrate. In this way, an adhesion layer-applied substrate of Example 11 was obtained.

Further, the adhesion layer-applied substrate of Example 11 was coated with the composition liquid of hard coating layer (J-1) by use of a bar coater, and thereafter the resultant was dried at 130° C. for 1.5 hours, thereby providing a laminate having a hard coating layer having a film thickness of 3.0 μm.

Results of subjecting the coating material composition, the adhesion layer-applied substrate, and the laminate of Example 11 to various evaluations are shown in Table 4.

### Example 12

30 g of the aqueous composite (C-5) dispersion, 1.03 g of Tinuvin400 (trade name, manufactured by BASF Japan Ltd., solid content concentration: 85%) as an organic ultraviolet absorber, 0.15 g of Tinuvin123 (trade name, manufactured by BASF Japan Ltd.) as a light stabilizer, 1.28 g of WM44-L70G (trade name, manufactured by Asahi Kasei Corporation, solid content concentration: 70% by mass, effective NCO: 5.3% by mass) as a curing agent, 12.15 g of water, and 8.54 g of ethanol were mixed under a room temperature condition, thereby providing a coating material composition of Example 12. The coating material composition had a solid content concentration of 12% by mass and a pH of 8.4.

Next, a polycarbonate substrate was coated with the coating material composition of Example 12 by use of a bar coater, and the resultant was dried at 130° C. for 1 hour, thereby forming an adhesion layer having a film thickness of 5.0 μm on the polycarbonate substrate. In this way, an adhesion layer-applied substrate of Example 12 was obtained.

Further, the adhesion layer-applied substrate of Example 12 was coated with the composition liquid of hard coating layer (J-1) by use of a bar coater, and thereafter the resultant was dried at 130° C. for 1.5 hours, thereby providing a laminate having a hard coating layer having a film thickness of 3.0 μm.

Results of subjecting the coating material composition, the adhesion layer-applied substrate, and the laminate of Example 12 to various evaluations are shown in Table 4.

### Example 13

16 g of the polymer particle (A-1), 30 g of the aqueous composite (C-5) dispersion, 0.96 g of Tinuvin400 (trade name, manufactured by BASF Japan Ltd., solid content concentration: 85%) as an organic ultraviolet absorber, 0.14 g of Tinuvin123 (trade name, manufactured by BASF Japan Ltd.) as a light stabilizer, 3.98 g of WM44-L70G (trade name, manufactured by Asahi Kasei Corporation, solid content concentration: 70% by mass, effective NCO: 5.3% by mass) as a curing agent, 23.31 g of water, and 14.79 g of ethanol were mixed under a room temperature condition, thereby providing a coating material composition of Example 13. The coating material composition had a solid content concentration of 12% by mass and a pH of 7.2.

Next, a polycarbonate substrate was coated with the coating material composition of Example 13 by use of a bar coater, and the resultant was dried at 130° C. for 1 hour, thereby forming an adhesion layer having a film thickness of 5.0 μm on the polycarbonate substrate. In this way, an adhesion layer-applied substrate of Example 13 was obtained.

Further, the adhesion layer-applied substrate of Example 13 was coated with the composition liquid of hard coating layer (J-1) by use of a bar coater, and thereafter the resultant was dried at 130° C. for 1.5 hours, thereby providing a laminate having a hard coating layer having a film thickness of 3.0 μm.

Results of subjecting the coating material composition, the adhesion layer-applied substrate, and the laminate of Example 13 to various evaluations are shown in Table 4.

### Example 14

6 g of the polymer particle (A-1), 30 g of the aqueous composite (C-5) dispersion, 0.62 g of Tinuvin400 (trade name, manufactured by BASF Japan Ltd., solid content concentration: 85%) as an organic ultraviolet absorber, 0.09 g of Tinuvin123 (trade name, manufactured by BASF Japan Ltd.) as a light stabilizer, 2.56 g of WM44-L70G (trade name, manufactured by Asahi Kasei Corporation, solid content concentration: 70% by mass, effective NCO: 5.3% by mass) as a curing agent, 15.18 g of water, and 10.92 g of ethanol were mixed under a room temperature condition, thereby providing a coating material composition of Example 14. The coating material composition had a solid content concentration of 12% by mass and a pH of 8.0.

Next, a polycarbonate substrate was coated with the coating material composition of Example 14 by use of a bar coater, and the resultant was dried at 130° C. for 1 hour, thereby forming an adhesion layer having a film thickness of 5.0 μm on the polycarbonate substrate. In this way, an adhesion layer-applied substrate of Example 14 was obtained.

Further, the adhesion layer-applied substrate of Example 14 was coated with the composition liquid of hard coating layer (J-1) by use of a bar coater, and thereafter the resultant was dried at 130° C. for 1.5 hours, thereby providing a laminate having a hard coating layer having a film thickness of 3.0 μm.

Results of subjecting the coating material composition, the adhesion layer-applied substrate, and the laminate of Example 14 to various evaluations are shown in Table 4.

### Example 15

30 g of the aqueous composite (C-5) dispersion, 5 g of colloidal silica “Snowtex PS-SO” (trade name, manufactured by Nissan Chemical Corporation, solid content: 15% by mass) dispersed in water as the inorganic oxide (B), 0.41 g of Tinuvin400 (trade name, manufactured by BASF Japan Ltd., solid content concentration: 85%) as an organic ultraviolet absorber, 0.06 g of Tinuvin123 (trade name, manufactured by BASF Japan Ltd.) as a light stabilizer, 1.71 g of WM44-L70G (trade name, manufactured by Asahi Kasei Corporation, solid content concentration: 70% by mass, effective NCO: 5.3% by mass) as a curing agent, 10.45 g of water, and 9.70 g of ethanol were mixed under a room temperature condition, thereby providing a coating material composition of Example 15. The coating material composition had a solid content concentration of 12% by mass and a pH of 8.4.

Next, a polycarbonate substrate was coated with the coating material composition of Example 15 by use of a bar coater, and the resultant was dried at 130° C. for 1 hour, thereby forming an adhesion layer having a film thickness of 5.0 μm on the polycarbonate substrate. In this way, an adhesion layer-applied substrate of Example 15 was obtained.

Further, the adhesion layer-applied substrate of Example 15 was coated with the composition liquid of hard coating layer (J-1) by use of a bar coater, and thereafter the resultant was dried at 130° C. for 1.5 hours, thereby providing a laminate having a hard coating layer having a film thickness of 3.0 μm.

Results of subjecting the coating material composition, the adhesion layer-applied substrate, and the laminate of Example 15 to various evaluations are shown in Table 4.

### Example 16

30 g of the aqueous composite (C-5) dispersion, 16 g of colloidal silica “Snowtex PS-SO” (trade name, manufactured by Nissan Chemical Corporation, solid content: 15% by mass) dispersed in water as the inorganic oxide (B), 0.41 g of Tinuvin400 (trade name, manufactured by BASF Japan Ltd., solid content concentration: 85%) as an organic ultraviolet absorber, 0.06 g of Tinuvin123 (trade name, manufactured by BASF Japan Ltd.) as a light stabilizer, 1.71 g of WM44-L70G (trade name, manufactured by Asahi Kasei Corporation, solid content concentration: 70% by mass, effective NCO: 5.3% by mass) as a curing agent, 10.78 g of water, and 12.12 g of ethanol were mixed under a room temperature condition, thereby providing a coating material composition of Example 16. The coating material composition had a solid content concentration of 12% by mass and a pH of 7.6.

Next, a polycarbonate substrate was coated with the coating material composition of Example 16 by use of a bar coater, and the resultant was dried at 130° C. for 1 hour, thereby forming an adhesion layer having a film thickness of 5.0 μm on the polycarbonate substrate. In this way, an adhesion layer-applied substrate of Example 16 was obtained.

Further, the adhesion layer-applied substrate of Example 16 was coated with the composition liquid of hard coating layer (J-1) by use of a bar coater, and thereafter the resultant was dried at 130° C. for 1.5 hours, thereby providing a laminate having a hard coating layer having a film thickness of 3.0 μm.

Results of subjecting the coating material composition, the adhesion layer-applied substrate, and the laminate of Example 16 to various evaluations are shown in Table 4.

### Comparative Example 1

30 g of colloidal silica “Snowtex PS-SO” (trade name, manufactured by Nissan Chemical Corporation, solid content: 15% by mass) dispersed in water as the inorganic oxide (B), 0.62 g of Tinuvin400 (trade name, manufactured by BASF Japan Ltd., solid content concentration: 85%) as an organic ultraviolet absorber, 0.09 g of Tinuvin123 (trade name, manufactured by BASF Japan Ltd.) as a light stabilizer, 1.28 g of WM44-L70G (trade name, manufactured by Asahi Kasei Corporation, solid content concentration: 70% by mass, effective NCO: 5.3% by mass) as a curing agent, 9.75 g of water, and 8.29 g of ethanol were mixed under a room temperature condition, and the pH was adjusted to 9.0 with an aqueous 25% ammonia solution, thereby providing a coating material composition of Comparative Example 1. The coating material composition had a solid content concentration of 12% by mass.

Next, a polycarbonate substrate was coated with the coating material composition of Comparative Example 1 by use of a bar coater, and the resultant was dried at 130° C. for 1 hour, thereby traying to form an adhesion layer having a film thickness of 5.0 μm, though no evaluable film was able to be formed. Results of subjecting the coating material composition of Comparative Example 1 to various evaluations are shown in Table 5.

### Comparative Example 2

30 g of the polymer particle (A-1), 1.54 g of Tinuvin400 (trade name, manufactured by BASF Japan Ltd., solid content concentration: 85%) as an organic ultraviolet absorber, 0.22 g of Tinuvin123 (trade name, manufactured by BASF Japan Ltd.) as a light stabilizer, 3.20 g of WM44-L70G (trade name, manufactured by Asahi Kasei Corporation, solid content concentration: 70% by mass, effective NCO: 5.3% by mass) as a curing agent, 23.02 g of water, and 10.82 g of ethanol were mixed under a room temperature condition, and the pH was adjusted to 9.0 with an aqueous 25% ammonia solution, thereby providing a coating material composition of Comparative Example 2. The coating material composition had a solid content concentration of 12% by mass.

Next, a polycarbonate substrate was coated with the coating material composition of Comparative Example 2 by use of a bar coater, and the resultant was dried at 130° C. for 1 hour, thereby forming an adhesion layer having a film thickness of 5.0 μm on the polycarbonate substrate. In this way, an adhesion layer-applied substrate of Comparative Example 2 was obtained.

Further, the adhesion layer-applied substrate of Comparative Example 2 was coated with the composition liquid of hard coating layer (J-1) by use of a bar coater, and thereafter the resultant was dried at 130° C. for 1.5 hours, thereby providing a laminate having a hard coating layer having a film thickness of 3.0 μm.

Results of subjecting the coating material composition, the adhesion layer-applied substrate, and the laminate of Comparative Example 2 to various evaluations are shown in Table 5.

### Comparative Example 3

15 g of the polymer particle (A-1), 19 g of colloidal silica “Snowtex PS-SO” (trade name, manufactured by Nissan Chemical Corporation, solid content: 15% by mass) dispersed in water as the inorganic oxide (B), 0.77 g of Tinuvin400 (trade name, manufactured by BASF Japan Ltd., solid content concentration: 85%) as an organic ultraviolet absorber, 0.11 g of Tinuvin123 (trade name, manufactured by BASF Japan Ltd.) as a light stabilizer, 1.60 g of WM44-L70G (trade name, manufactured by Asahi Kasei Corporation, solid content concentration: 70% by mass, effective NCO: 5.3% by mass) as a curing agent, 12.08 g of water, and 9.59 g of ethanol were mixed under a room temperature condition, and the pH was adjusted to 6.0 with an aqueous 25% ammonia solution, thereby providing a coating material composition of Comparative Example 3. The coating material composition had a solid content concentration of 12% by mass.

Next, a polycarbonate substrate was coated with the coating material composition of Comparative Example 3 by use of a bar coater, and the resultant was dried at 130° C. for 1 hour, thereby forming an adhesion layer having a film thickness of 5.0 μm on the polycarbonate substrate. In this way, an adhesion layer-applied substrate of Comparative Example 3 was obtained.

Further, the adhesion layer-applied substrate of Comparative Example 3 was coated with the composition liquid of hard coating layer (J-1) by use of a bar coater, and thereafter the resultant was dried at 130° C. for 1.5 hours, thereby providing a laminate having a hard coating layer having a film thickness of 3.0 μm.

Results of subjecting the coating material composition, the adhesion layer-applied substrate, and the laminate of Comparative Example 3 to various evaluations are shown in Table 5.

### Comparative Example 4

30 g of the composite (C-7), 0.62 g of Tinuvin400 (trade name, manufactured by BASF Japan Ltd., solid content concentration: 85%) as an organic ultraviolet absorber, 0.09 g of Tinuvin123 (trade name, manufactured by BASF Japan Ltd.) as a light stabilizer, 1.29 g of WM44-L70G (trade name, manufactured by Asahi Kasei Corporation, solid content concentration: 70% by mass, effective NCO: 5.3% by mass) as a curing agent, 9.79 g of water, and 8.30 g of ethanol were mixed under a room temperature condition, thereby providing a coating material composition of Comparative Example 4. The coating material composition had a solid content concentration of 12% by mass and a pH of 8.4.

Next, a polycarbonate substrate was coated with the coating material composition of Comparative Example 4 by use of a bar coater, and the resultant was dried at 130° C. for 1 hour, thereby forming an adhesion layer having a film thickness of 5.0 μm on the polycarbonate substrate. In this way, an adhesion layer-applied substrate of Comparative Example 4 was obtained.

Further, the adhesion layer-applied substrate of Comparative Example 4 was coated with the composition liquid of hard coating layer (J-1) by use of a bar coater, and thereafter the resultant was dried at 130° C. for 1.5 hours, thereby providing a laminate having a hard coating layer having a film thickness of 3.0 μm.

Results of subjecting the coating material composition, the adhesion layer-applied substrate, and the laminate of Comparative Example 4 to various evaluations are shown in Table 5.

The results of various evaluations of Examples 1 to 16 and Comparative Examples 1 to 4 are shown in Tables 3 to 5.

TABLE 3

| | | Exam- | Exam- | Exam- | Exam- | Exam- | Exam- | Exam- | Exam- |
|---|---|---|---|---|---|---|---|---|---|
| | | ple 1 | ple 2 | ple 3 | ple 4 | ple 5 | ple 6 | ple 7 | ple 8 |
| [symbol] | Polymer | A-1 | — | — | — | — | — | — | — |
| coating | particle (A) | | | | | | | | |
| material | Inorganic | Snowtex | — | — | — | — | — | — | — |
| composition | oxide (B) | PS-SO | | | | | | | |
| | Composite (C) | — | C-1 | C-2 | C-3 | C-4 | C-5 | C-5 | C-6 |
| | Ultraviolet | Tinuvin400 | Tinuvin400 | Tinuvin400 | Tinuvin400 | Tinuvin400 | Tinuvin400 | U1 | Tinuvin400 |
| | absorber (D) | | | | | | | | |
| | Light | Tinuvin123 | Tinuvin123 | Tinuvin123 | Tinuvin123 | Tinuvin123 | Tinuvin123 | Tinuvin123 | Tinuvin123 |
| | stabilizer | | | | | | | | |
| | Block | WM44- | — | WM44- | WM44- | WM44- | WM44- | WM44- | WM44- |
| | polyisocyanate | L70G | | L70G | L70G | L70G | L70G | L70G | L70G |
| | compound (E) | | | | | | | | |
| | Ratio of (B) | 40% | 45% | 42% | 39% | 39% | 44% | 44% | 42% |
| | to total | | | | | | | | |
| | solid content | | | | | | | | |
| | NCO/OH | 0.4 | — | 0.4 | 0.4 | 0.4 | 0.4 | 0.4 | 0.4 |
| | (molar ratio) | | | | | | | | |
| | Organic | 4.0 | 4.0 | 4.0 | 4.0 | 4.0 | 4.0 | 4.0 | 4.0 |
| | ultraviolet | | | | | | | | |
| | absorber (D)/ | | | | | | | | |
| | ultraviolet- | | | | | | | | |
| | absorptive | | | | | | | | |
| | vinyl | | | | | | | | |
| | monomer (a-1) | | | | | | | | |
| | pH | 10.0 | 7.5 | 8.5 | 8.3 | 9.4 | 8.1 | 8.3 | 7.1 |
| | Coating | A | A | S | S | A | S | S | A |
| | material | | | | | | | | |
| | stability | | | | | | | | |
| Adhesion | Adhesiveness | S | B | S | S | A | S | S | A |
| layer- | Transparency | 31 | 40 | 33 | 19 | 16 | 12 | 15 | 26 |
| applied | (haze value H1) | | | | | | | | |
| substrate | | | | | | | | | |
| Hard | Polymer | F-1 | F-1 | F-1 | F-1 | F-1 | F-1 | F-1 | F-1 |
| coating | particle (F) | | | | | | | | |
| layer | Inorganic | Snowtex | Snowtex | Snowtex | Snowtex | Snowtex | Snowtex | Snowtex | Snowtex |
| | oxide (G) | OXS | OXS | OXS | OXS | OXS | OXS | OXS | OXS |
| | Hydrolyzable | h1 and | h1 and | h1 and | h1 and | h1 and | h1 and | h1 and | h1 and |
| | silicon | h2 | h2 | h2 | h2 | h2 | h2 | h2 | h2 |
| | compound (h) | | | | | | | | |
| Laminate | Transparency | 1.9 | 2.5 | 1.7 | 0.9 | 1.0 | 0.6 | 0.7 | 1.7 |
| | (haze value H2) | | | | | | | | |
| | Adhesiveness | S | A | S | S | A | S | S | A |
| | Heat | S | S | S | S | S | S | S | S |
| | resistance | | | | | | | | |
| | Abrasion | S | S | S | S | S | S | S | S |
| | resistance | | | | | | | | |
| | Chemical | S | S | S | S | S | S | S | S |
| | resistance | | | | | | | | |
| | Weather | S | S | S | S | S | S | S | S |
| | resistance | | | | | | | | |

TABLE 4

| | | Exam- | Exam- | Exam- | Exam- | Exam- | Exam- | Exam- | Exam- |
|---|---|---|---|---|---|---|---|---|---|
| | | ple 9 | ple 10 | ple 11 | ple 12 | ple 13 | ple 14 | ple 15 | ple 16 |
| Coating | Polymer | — | — | — | — | A-1 | A-1 | — | — |
| material | particle (A) | | | | | | | | |
| composition | Inorganic | — | — | — | — | — | — | Snowtex | Snowtex |
| | oxide (B) | | | | | | | PS-SO | PS-SO |
| | Composite (C) | C-5 | C-5 | C-5 | C-5 | C-5 | C-5 | C-5 | C-5 |
| | Ultraviolet | Tinuvin400 | Tinuvin400 | Tinuvin400 | Tinuvin400 | Tinuvin400 | Tinuvin400 | Tinuvin400 | Tinuvin400 |
| | absorber (D) | | | | | | | | |
| | Light | Tinuvin123 | Tinuvin123 | Tinuvin123 | Tinuvin123 | Tinuvin123 | Tinuvin123 | Tinuvin123 | Tinuvin123 |
| | stabilizer | | | | | | | | |
| | Block | WM44- | WM44- | WM44- | WM44- | WM44- | WM44- | WM44- | WM44- |
| | polyisocyanate | L70G | L70G | L70G | L70G | L70G | L70G | L70G | L70G |
| | compound (E) | | | | | | | | |
| | Ratio of (B) | 39% | 38% | 45% | 42% | 25% | 35% | 50% | 60% |
| | to total | | | | | | | | |
| | solid content | | | | | | | | |
| | NCO/OH | 0.4 | 0.8 | 0.3 | 0.3 | 0.4 | 0.4 | 0.4 | 0.4 |
| | (molar ratio) | | | | | | | | |
| | Organic | 1.0 | 2.0 | 6.0 | 10.0 | 4.0 | 4.0 | 4.0 | 4.0 |
| | ultraviolet | | | | | | | | |
| | absorber (D)/ | | | | | | | | |
| | ultraviolet- | | | | | | | | |
| | absorptive | | | | | | | | |
| | vinyl | | | | | | | | |
| | monomer (a-1) | | | | | | | | |
| | pH | 8.2 | 8.3 | 8.6 | 8.4 | 7.2 | 8.0 | 8.4 | 7.6 |
| | Coating | S | S | S | A | S | S | S | A |
| | material | | | | | | | | |
| | stability | | | | | | | | |
| Adhesion | Adhesiveness | S | S | S | S | S | S | S | A |
| layer- | Transparency | 10 | 14 | 17 | 41 | 31 | 20 | 25 | 42 |
| applied | (haze value H1) | | | | | | | | |
| substrate | | | | | | | | | |
| Hard | Polymer | F-1 | F-1 | F-1 | F-1 | F-1 | F-1 | F-1 | F-1 |
| coating | particle (F) | | | | | | | | |
| layer | Inorganic | Snowtex | Snowtex | Snowtex | Snowtex | Snowtex | Snowtex | Snowtex | Snowtex |
| | oxide (G) | OXS | OXS | OXS | OXS | OXS | OXS | OXS | OXS |
| | Hydrolyzable | h1 and | h1 and | h1 and | h1 and | h1 and | h1 and | h1 and | h1 and |
| | silicon | h2 | h2 | h2 | h2 | h2 | h2 | h2 | h2 |
| | compound (h) | | | | | | | | |
| Laminate | Transparency | 0.5 | 0.7 | 0.9 | 2.9 | 1.3 | 0.9 | 1.0 | 2.9 |
| | (haze value H2) | | | | | | | | |
| | Adhesiveness | S | S | S | A | A | S | S | A |
| | Heat | S | S | S | A | A | S | S | S |
| | resistance | | | | | | | | |
| | Abrasion | S | S | S | A | S | S | S | A |
| | resistance | | | | | | | | |
| | Chemical | S | S | S | S | S | S | S | S |
| | resistance | | | | | | | | |
| | Weather | A | S | S | S | S | S | S | S |
| | resistance | | | | | | | | |

h1: 1,2-bis(triethoxysilyl)ethane,
h2: tris-(trimethoxysilylpropyl)isocyanurate

TABLE 5

| | | Comparative | Comparative | Comparative | Comparative |
|---|---|---|---|---|---|
| | | Example 1 | Example 2 | Example 3 | Example 4 |
| Coating material | Polymer particle (A) | — | A-1 | A-1 | — |
| composition | Inorganic oxide (B) | Snowtex PS-SO | — | Snowtex PS-SO | — |
| | Composite (C) | — | — | — | C-7 |
| | Ultraviolet | Tinuvin400 | Tinuvin400 | Tinuvin400 | Tinuvin400 |
| | absorber (D) | | | | |
| | Light stabilizer | Tinuvin123 | Tinuvin123 | Tinuvin123 | Tinuvin123 |
| | Block polyisocyanate | WM44-L70G | WM44-L70G | WM44-L70G | WM44-L70G |
| | compound (E) | | | | |
| | Ratio of (B) to total | 75% | 0% | 41% | 45% |
| | solid content | | | | |
| | NCO/OH (molar ratio) | — | 0.3 | 0.3 | 0.3 |
| | Organic ultraviolet | — | 6.0 | 6.0 | — |
| | absorber (D)/ultraviolet- | | | | |
| | absorptive vinyl | | | | |
| | monomer (a-1) | | | | |
| | pH | 9.0 | 9.0 | 6.0 | 8.4 |
| | Coating material stability | B | S | B | B |
| Adhesion layer- | Adhesiveness | Impossible | S | S | B |
| applied substrate | Transparency (haze value H1) | to evaluate | 18 | 56 | 41 |
| Hard coating | Polymer particle (F) | — | F-1 | F-1 | F-1 |
| layer | Inorganic oxide (G) | — | Snowtex OXS | Snowtex OXS | Snowtex OXS |
| | Hydrolyzable silicon | — | h1 and h2 | h1 and h2 | h1 and h2 |
| | compound (h) | | | | |
| Laminate | Transparency (haze value H2) | Impossible | 0.9 | 4.2 | 2.5 |
| | Adhesiveness | to evaluate | C | S | B |
| | Heat resistance | | C | S | S |
| | Abrasion resistance | | B | A | A |
| | Chemical resistance | | S | S | S |
| | Weather resistance | | S | B | B |

### [Evaluation Results]

It was found from Tables 3 to 5 that the coating material composition of the present embodiment was able to form a film excellent in transparency, adhesiveness and weather resistance. Each of the laminates of Examples 1 to 16 exhibited transparency and abrasion resistance at high levels and furthermore, weather resistance at a high level, as descried above, and thus was evaluated as being preferably applicable as a window material for automobile.

The present application claims priority to Japanese Patent Applications (Japanese Patent Application Nos. 2021-146683 and 2021-146657) filed on Sep. 9, 2021, the contents of which are herein incorporated as reference.

### INDUSTRIAL APPLICABILITY

The adhesion layer-applied substrate and the laminate, provided by the first embodiment, are useful in hard coatings for building materials, automobile members, electronic equipment, electronic products, and the like.

The coating material composition, the adhesion layer-applied substrate and the laminate, provided by the second embodiment, are useful in hard coatings for building materials, automobile members, electronic equipment, electronic products, and the like.

1.-12. (canceled)

13. A coating material composition comprising:
a mixture of a polymer particle (A) and an inorganic oxide (B), and/or a composite (E) of a polymer particle (A) and an inorganic oxide (B); and
a light-shielding agent (D), wherein
the inorganic oxide (B) is a silica having a linked structure, and/or a mixture of a silica having a linked structure and a silica having a spherical shape,
an average particle size of the mixture and/or the composite (E) of a polymer particle (A) and an inorganic oxide (B) is 2 nm or more and 2000 nm or less, and
a mass ratio of the polymer particle (A) and the inorganic oxide (B) (polymer particle (A):inorganic oxide (B)) is in a range of 1:0.5 to 1:2.0.

14. The coating material composition according to claim 13, wherein the polymer particle (A) comprises an emulsion particle.

15. The coating material composition according to claim 13, wherein the polymer particle (A) is a polymer particle derived from an emulsifier and a vinyl monomer (a).

16. The coating material composition according to claim 13, wherein
the polymer particle (A) has a unit (a) derived from a vinyl monomer (a), and
the unit (a) comprises a unit (a-1) derived from an ultraviolet-absorptive vinyl monomer (a-1).

17. The coating material composition according to claim 13, wherein the inorganic oxide (B) is a silica having a spherical shape and/or a linked structure.

18. The coating material composition according to claim 13, further comprising water.

19. An adhesion layer-applied substrate comprising
a substrate and
an adhesion layer disposed on the substrate, wherein
the adhesion layer comprises the coating material composition according to claim 13.

20. A laminate comprising
the adhesion layer-applied substrate according to claim 19, and
a hard coating layer (K) disposed on the adhesion layer-applied substrate.

21. The laminate according to claim 20, wherein
the hard coating layer (K) comprises a polymer particle (F) and a matrix component (H), and
the matrix component (H) comprises an inorganic oxide (G) and a hydrolyzable silicon compound (h).

22. The laminate according to claim 21, wherein the hydrolyzable silicon compound (h) comprises one or more selected from the group consisting of a compound having an atomic group represented by the following formula (h-1) and a hydrolyzed product and a condensate thereof, and a compound represented by the following formula (h-2) and a hydrolyzed product and a condensate thereof:
—R²ₙ₂SiX³₃₋ₙ₂ (h-1)
wherein R² represents a hydrogen atom, an alkyl group, an alkenyl group or an alkynyl group having 1 to 10 carbon atoms, or an aryl group, R² optionally has a substituent having halogen, a hydroxy group, a mercapto group, an amino group, a (meth)acryloyl group or an epoxy group, X³ represents a hydrolyzable group, and n2 represents an integer of 0 to 2;
SiX⁴₄ (h-2)
wherein X⁴ represents a hydrolyzable group.

23. The laminate according to claim 21, wherein a Martens hardness HMF of the polymer particle (F) and a Martens hardness HMG of the matrix component (H) satisfy a relationship of HMH/HMF>1.

24. The laminate according to claim 20, wherein a haze value H1 of the adhesion layer-applied substrate is larger than a haze value H2 of the laminate.

25. The laminate according to claim 20, wherein the laminate is an automobile member.

26. (canceled)

27. The coating material composition according to claim 13, comprising a mixture of a polymer particle (A) having a unit (a) derived from a vinyl monomer (a) and an inorganic oxide (B), and/or a composite (C) of the polymer particle (A) and an inorganic oxide (B), wherein
a weight average molecular weight of the unit (a) is 10000 to 5000000, and
a pH of the coating material composition is 7 to 11.

28. (canceled)

29. The coating material composition according to claim 27, wherein
the unit (a) comprises a unit (a-2) derived from a hydroxyl group-containing vinyl monomer (a-2), and
a content of the unit (a-2) in the unit (a) is 10 to 40% by mass.

30. The coating material composition according to claim 27, further comprising an organic ultraviolet absorber (D).

31. The coating material composition according to claim 27, further comprising a block polyisocyanate compound (E).

32. The coating material composition according to claim 27, wherein a weight average molecular weight of the unit (a) is 100000 to 1000000.

33.-41. (canceled)

42. The adhesion layer-applied substrate according to claim 19, wherein the light-shielding agent (D) comprises an ultraviolet absorber, and
in elemental analysis by XPS on an adhesion layer surface in the adhesion layer-applied substrate, an M element concentration obtained from a spectrum of a metal (M) derived from the inorganic oxide is 6 atomic % or more.

43. The adhesion layer-applied substrate according to claim 42, wherein an arithmetic mean height Sa of the adhesion layer surface is 30 nm or more and 300 nm or less.
